(19) United States
(12) Patent Application Publication
(10) Pub. No.: US 2008/0218598 A1
(43) Pub. Date: Sep. 11, 2008

(54) Imaging method, imaging apparatus, and driving device

(75) Inventors: Kouichi Harada, Kanagawa (JP); Atsushi Kobayashi, Kanagawa (JP); Seiji Kobayashi, Tokyo (JP); Tomoo Mitsunaga, Kanagawa (JP); Hiroaki Ono, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/073,402

(22) Filed: Mar. 5, 2008

(30) Foreign Application Priority Data
Mar. 8, 2007 (JP) 2007-058594

(51) Int. Cl. H04N 5/228

(52) U.S. Cl. 348/222.1; 348/E03.018

(57) ABSTRACT

A driving device includes a driving control unit that reads out the signal charge generated by at least the charge generating section for a low-sensitivity pixel signal to the charge transfer section, after the predetermined timing, continues incidence of the electromagnetic wave and, after continuing the incidence of the electromagnetic wave, reads out the signal charge generated by at least the charge generating section for a high-sensitivity pixel signal to the charge transfer section, transfers the signal charge read out to the charge transfer section through the charge transfer section, and, concerning at least one of the signal charges for the high-sensitivity pixel signal and the low-sensitivity pixel signal, every time the signal charge is read out to the charge transfer section, transfers the signal charge read out to the charge transfer section through the charge transfer section without retaining the signal charge in the charge transfer section.

### CROSS-REFERENCES TO RELATED APPLICATIONS

The present invention contains subject matter related to Japanese Patent Application JP 2007-058594 filed in the Japanese Patent Office on Mar. 8, 2007, the entire contents of which being incorporated herein by reference.

### BACKGROUND OF THE INVENTION

1. Field of the Invention

The present invention relates to an imaging method employing a solid-state imaging device (an image sensor) that images a subject and outputs an image signal corresponding to an image of the subject, a driving device that drives the solid-state imaging device, and a solid-state imaging apparatus and an imaging apparatus (camera systems) that carries out the imaging method such as an electronic still camera and an imaging apparatus module including the solid-state imaging device and the driving device. More specifically, the present invention relates to a technique for improving a dynamic range of an imaged subject image.

2. Description of the Related Art

Solid-state imaging devices such as a CCD (Charge Coupled Device) imaging device and a CMOS (Complementary Metal-Oxide Semiconductor) sensor are widely used in imaging apparatuses such as a video camera anda digital camera, component inspection apparatuses in the field of FA (Factory Automation), optical measurement apparatuses such as an electronic endoscope in the field of ME (Medical Electronics).

In the imaging apparatuses and the optical measurement apparatuses employing the solid-state imaging devices, in order to improve a dynamic range, various methods of imaging images using photoelectric conversion elements (light-receiving elements such as photodiode) having different sensitivities and combining signal charges and electric signals obtained by the imaging have been proposed.

For example, in U.S. application Ser. No. 09/326,422, U.S. application Ser. No. 09/511,469, and S. K. Nayar and T. Mitsunaga, “High Dynamic Range Imaging: Spatially Varying pixel Exposures”, Proc. of Computer Vision and Pattern Recognition 2000, Vol. 1, pp. 472-479, June, 2000, mechanisms for applying a device for varying sensitivity of each light-receiving element corresponding to one pixel of an output image to imaging devices having a normal dynamic range, imaging a subject, and applying predetermined image processing to an obtained image signal to generate an image signal with a wide dynamic range have been proposed.

The device for varying sensitivity of each light-receiving element is realized by changing light transmittance and an aperture ratio for each light-receiving element or using an electronic shutter function to form patterns of spatial sensitivity. One of techniques for improving a dynamic range without deteriorating resolution using these spatial sensitivity patterns is a technique called an SVE (Spatially Varying Exposure) system.

In the SVE system, each of light-receiving elements has only one kind of sensitivity. Therefore, each of pixels of an imaged image can acquire only information in a dynamic range inherent in an imaging device. However, it is possible to create an image with a wide dynamic range by applying predetermined image processing to an obtained image signal and equalizing sensitivities of all the pixels. Since all the light-receiving elements are simultaneously exposed to light, it is possible to correctly image a moving subject. Moreover, since one light-receiving element corresponds to one pixel of an output image, a unit cell size is not increased.

The structure of a solid-state imaging device and a method of driving the solid-state imaging device for realizing the SVE system using a single-plate color CCD imaging device, for example, mechanisms of electronic shutter system SVE for providing exposure modes for changing exposure time of each of light-receiving elements in several patterns using an electronic shutter function have been proposed by JP-A-2002-112120, WO2002/056603, and JP-A-2004-172858.

### SUMMARY OF THE INVENTION

However, in the imaging of the SVE system employing the electronic shutter function in the past, there are operation modes for reading out, after performing exposure for predetermined time in an entire exposure period and performing first generation of signal charges, the signal charges from charge generating sections to a vertical transfer section, continuing the exposure while leaving the signal charge in the vertical transfer section, and performing generation of a signal charge in the charge generating sections (second generation of signal charges). Therefore, in a latter half of the total exposure period, i.e., during the second storage of signal charges in the charge generating sections, continuous storage of unnecessary charges due to a dark current, a blooming phenomenon, and the like occurs in the vertical transfer section because the signal charge generated in the first generation is left stored without being transferred.

For example, control timing is shown in FIG. 23 of WO2002/056603 and FIG. 9 of JP-A-2004-172858. A first charge readout pulse voltage is supplied to a first light-receiving element immediately before supply timing of a charge sweep-out pulse voltage in an entire exposure period. A second charge readout pulse voltage is supplied to the first light-receiving element immediately before the end of the entire exposure period. As a result, a stored charge amount of the first light-receiving element at the supply timing of the first charge readout pulse voltage and the supply timing of the-second charge readout pulse voltage are read out from the first light-receiving element to a vertical transfer section.

At this point, transfer of a charge by the vertical transfer section is stopped during the entire exposure period. The charge amounts read out twice are added up in the vertical transfer section and transferred from the vertical transfer section as data of the same frame after the end of the entire exposure period. In other words, after the first charge readout pulse voltage is supplied, the exposure is continued while the charge transfer is stopped.

In the latter half of the entire exposure period after the first readout, respective signal charges for high-sensitivity pixel signals and a low-sensitivity pixel signal read out to the vertical transfer section in the first time are left retained in the vertical transfer section. Therefore, the unnecessary charges caused by the dark current, the blooming phenomenon, and the like are continuously superimposed on the respective signal charges read out to the vertical transfer section in the first time. As a result, noise due to the unnecessary charges such as a dark current component occurs in both the high-sensitivity pixel signal and the low-sensitivity pixel signal, S/N falls, the blooming phenomenon is emphasized, and an extremely indistinct image is formed.

Therefore, it is desirable to provide a mechanism for solving the problem of unnecessary charge superimposition caused by leaving a signal charge read out to charge transfer sections stored without transferring the signal charges.

According to an embodiment of the present invention, there is provided an imaging device as an example of a semiconductor device including charge generating sections arranged in a matrix shape that generate signal charges corresponding to an electromagnetic wave incident thereon, a first charge transfer section that transfers the signal charges generated by the charge generating sections in one direction in order, and a second charge transfer section that transfers the signal charges transferred from the first charge transfer section in a direction different from one direction in order.

“One direction” and “the other direction” are relative to each other. A column direction or a vertical direction in which scanning speed is generally low is equivalent to one direction and a row direction or a horizontal direction in which scanning speed is generally high is equivalent to the other direction. However, for example, when a drawing is rotated 90 degrees, a relation among the four directions changes and a relation between rows and columns or vertical and horizontal is inverted. Therefore, “one direction” and “the other direction” are not absolute. For example, when the first charge transfer section is arranged in the column direction, the second charge transfer section is arranged in the row direction. When the second charge transfer section is arranged in the column direction, the first charge transfer section is arranged in the row direction. In the following description, one direction is representatively described as the column direction or the vertical direction and the other direction is representatively described as the row direction or the horizontal direction.

In a mechanism adopted the embodiment, a signal charge corresponding to a high-sensitivity pixel signal and a signal charge corresponding to a low-sensitivity pixel signal are acquired independently from each other by setting charge storage time for acquiring the high-sensitivity pixel signal and charge storage time for acquiring the low-sensitivity pixel signal different from each other, i.e., setting total charge storage times for storing signal charges used for output signals different from each other.

As driving control timing by a driving control unit according to the embodiment, the driving control unit performs control such that, first, at predetermined timing during an exposure period, i.e., final timing in a former half of an entire storage period for storing signal charges in the charge generating sections, signal charges generated by at least the charge generating section for low-sensitivity pixel signals of the charge generating section for high-sensitivity pixel signals and the charge generating section for low-sensitivity pixel signals are read out to the charge transfer sections.

The driving control unit performs control such that, after predetermined timing in the entire exposure period, i.e., after first readout, incidence of an electromagnetic wave is continued, and after predetermined timing in the entire exposure period, signal charges generated by at least the charge generating section for high-sensitivity pixel signals of the charge generating section for high-sensitivity pixel signals and the charge generating section for low-sensitivity pixel signals are read out to the charge transfer sections and the read out signal charges are transferred by the charge transfer sections.

It is possible to realize SVE imaging by using high-sensitivity pixel signals and low-sensitivity pixel signals acquired in this way. An image processing unit can perform combination processing for expanding a dynamic range by generating an output image by properly using high-sensitivity pixel signals and low-sensitivity pixel signals.

According to the embodiment, concerning at least one of the signal charges for the high-sensitivity pixel signals and the signal charges for low-sensitivity pixels signals, the signal charges read out from the charge generating sections are prevented from being retained in the charge transfer sections as much as possible. As a specific mechanism for the combination processing for expanding a dynamic range by generating an output image by properly using the acquired high-sensitivity pixel signals and low-sensitivity pixel signals, it is possible to adopt various mechanisms described in, for example, WO2002/056603 and JP-A-2004-172858.

In the combination processing for expanding a dynamic range by generating an output image by properly using the acquired high-sensitivity pixel signals and low-sensitivity pixel signals, pixel signals acquired by pixels of respective sensitivities are compared with predetermined threshold levels (a threshold θl corresponding to a noise level on a small signal side and a threshold θh corresponding to a saturation level on a large signal side). Effectiveness judgment for judging whether the pixel signals acquired by the pixels of respective sensitivities are between the threshold θl and the threshold θh is performed. Concerning an ineffective pixel, the pixel signal acquired by which is not between the threshold θl and the threshold θh, since original intensity of the pixel is not restored, a pixel value of the ineffective pixel is interpolated by using pixel values of effective pixels near the ineffective pixel.

According to another embodiment of the present invention, there is provided an overall driving control method by a driving control unit that performs readout of signal charges for high-sensitivity pixel signals and low-sensitivity pixel signals and charge transfer. The driving control method has a characteristic in, concerning at least one of the signal charges for the high-sensitivity pixel signals and low-sensitivity pixel signals, reading out every time the signal charges to the charge transfer sections and performing the charge transfer without retaining the read out signal charges in the charge transfer sections.

At driving control timing described in WO2002/056603 and JP-A-2004-172858, in the first time, when the signal charges for the high-sensitivity pixel signals and low-sensitivity pixel signals are read out to a vertical transfer section, both the signal charges are left retained in the vertical transfer section. The embodiment is different from WO2002/056603 and JP-A-2004-172858 in that, when at least one of the signal charges for the high-sensitivity pixel signals and low-sensitivity pixel signals are read out from the charge generating sections to the charge transfer sections, the signal charge is not left retained in the charge transfer sections but is immediately transferred by the charge transfer sections.

The driving control method according to the embodiment is the same as the mechanisms disclosed in WO2002/056603 and JP-A-2004-172858 in that an entire storage period for storing signal charges in the charge generating sections is divided into a former half and a latter half in order to acquire high-sensitivity pixel signals and low-sensitivity pixel signals independently from each other and the signal charges are read out dividedly twice at predetermined timing in an entire exposure period, i.e., final timing in the former half and after continuation of incidence of an electromagnetic wave after the predetermined timing in the entire exposure period. However, the driving control method according to the embodiment is substantially different from the mechanism in that, in the latter half of the entire exposure period after the first readout, while the incidence of an electromagnetic wave is continued, a charge sweep-out pulse (an electronic shutter pulse) ΦVsub is supplied to a substrate to sweep out the charges stored in the charge generating sections, and then signal charges for low-sensitivity pixel signals read out at the predetermined timing in the entire exposure period are started to be stored in the charge generating sections in low-sensitivity pixels and high-sensitivity pixels, and, thereafter, the charges stored in the charge generating sections are transferred by the charge transfer sections in a predetermined period in the latter half after the first readout of the electronic entire exposure period defined as a period until the charges stored in the charge generating sections are finally read out to the charge transfer sections. The driving control method is also different in that concerning at least one of the signal charges for the high-sensitivity pixel signals and the low-sensitivity pixel signals, every time the signal charges are read out from the charge generating sections to the charge transfer sections, charge transfer is performed without retaining the read-out signal charges in the charge transfer sections.

According to other embodiments of the present invention, further advantageous specific examples of the mechanism according to the embodiment are specified.

For example, when the signal charges for the high-sensitivity pixel signals and the low-sensitivity pixel signals are transferred by the charge transfer sections, as a mechanism for completely blocking incident light, it is advisable to provide a mechanical shutter that stops storage of signal charges in the charge generating sections. It is possible to perform charge transfer for using signal charges for an output signal in a state in which exposure is stopped by closing the mechanical shutter. In a period of the charge transfer, no light is made incident on a CCD solid-state imaging device. In principle, it is possible to completely eliminate noise caused by unnecessary charges such as a smear component due to light made incident on the CCD solid-state imaging device during that charge transfer period.

As imaging devices used in the embodiments, it is possible to use an imaging device of a so-called progressive scan system that can transfer signal charges, which are read out from all the pixel generating units to the charge transfer sections, independently from one another by the charge transfer sections and an imaging device of a so-called interline system in which charge transfer sections are arranged among arrays of charge generating sections. However, in various forms of driving control timing, modification matching mechanisms for readout and charge transfer peculiar to the respective systems are necessary while adopting a basic mechanism for the driving control timing.

The imaging device of the “interline system” only has to have the structure in which the charge transfer sections are arranged among the array of the charge generating sections. The imaging device of the “interline system” is not limited to an imaging device of the typical interline system (IL-CCD) and may be an imaging device of a frame interline transfer system including storing areas for storing signal charges for one field in a lower part of an imaging area of the interline system (FIT-CCD).

When the IL-CCD and the FIT-CCD are used, in particular, by arranging transfer electrodes also serving as readout electrodes in respective arrays, first charge generating sections that acquire signal charges corresponding to high-sensitivity pixel signals are arranged in one line (one row) and second charge generating sections that acquire signal charges for low-sensitivity signal charges are arranged in one line (one row) next to the first charge generating sections. In other words, it is desirable to use an imaging device that can form a sensitivity mosaic pattern in which sensitivity changes in every line by switching charge storage time for each row of the charge generating sections (e.g., for each horizontal line).

Consequently, if a “frame readout system” in which the driving control unit controls the first charge generating sections and the second charge generating sections, which are arranged in a row, respectively, to alternately read out charges to the charge transfer sections for each field by switching charge storage time for odd number lines and even number lines is adopted, it is possible to independently acquire images of the high-sensitivity pixel signals and images of the low-sensitivity pixel signals for each field independently from each other.

In all the forms of driving control timing, when the imaging device of the progressive scan system is used, the driving control unit can perform control such that the signal charges corresponding to the high-sensitivity pixel signals and the signal charges corresponding to the low-sensitivity pixel signals are continuously stored in the charge generating sections even after the predetermined timing in the entire exposure period and, then, after the continuation of incidence of the electromagnetic wave, the signal charges corresponding to the high-sensitivity pixel signals and the signal charges corresponding to the low-sensitivity pixel signals are transferred by the charge transfer sections independently from each other without being simultaneously mixed in the charge transfer sections.

Similarly, in all the forms of driving control timing, when the imaging device of the interline system is used, the driving control unit can perform control such that the signal charges corresponding to the high-sensitivity pixel signals are stored in the first charge generating sections and the signal charges corresponding to the low-sensitivity pixel signals are continuously stored in the second charge generating sections even after the predetermined timing, then, storage of the respective signal charges is stopped, and, thereafter, the signal charges corresponding to the high-sensitivity pixel signals and the signal charges corresponding to the low-sensitivity pixel signals are read out to the charge transfer sections in order, and the read-out signal charges are transferred by the charge transfer sections.

As timing for realizing the driving control method that is a most important characteristic of the embodiment, it is possible to adopt various forms as long as, while adopting the mechanism for reading out the signal charges to the charge transfer sections by dividing the signal charge storage period in the charge generating sections into two to acquire the signal charges for the high-sensitivity pixel signals and the low-sensitivity pixel signals, when at least one of the signal charges for the high-sensitivity pixel signals and low-sensitivity pixel signals are read out from the charge generating sections to the charge transfer sections, the read-out signal charges are immediately transferred by the charge transfer sections without being left retained in the charge transfer sections.

In these various forms, concerning at least the signal charges for the high-sensitivity pixel signals, it is more desirable to perform, every time the signal charges are read out to the charge transfer sections, charge transfer without leaving the read-out signal charges retained in the charge transfer sections.

On the other hand, concerning the signal charges for the low-sensitivity pixel signals, there may be a period in which the signal charges are retained in the charge transfer sections without performing charge transfer in a part of the latter half of the electronic entire exposure period. Naturally, concerning the signal charges for the low-sensitivity pixel signals, it is advisable to perform, every time the signal charges are read out to the charge transfer sections, charge transfer without leaving the read-out signal charges retained in the charge transfer sections. In other words, it goes without saying that, when both the signal charges for the high-sensitivity pixel signals and low-sensitivity pixel signals are read out from the charge generating sections to the charge transfer sections, the best way is to immediately transfer the read-out signal charges with the charge transfer sections without leaving the signal charges retained in the charge transfer sections.

In short, when the entire exposure period is divided into the former half and the later half and the signal charges stored in the charge generating sections are read out to the charge transfer sections dividedly twice at the predetermined timing in the entire exposure period, i.e., the final timing in the former half and an end point of the entire exposure period for acquiring high-sensitivity pixel signals or after the end point, charge transfer is performed every time the signal charges are read out. In other words, the signal charges read out to the charge transfer sections in the first time are surely transferred to the charge transfer sections without being left retained in the charge transfer sections. This is important in solving the problem of unnecessary charge superimposition that is caused because the read-out signal charges are left retaining in the charge transfer sections without being transferred. In particular, concerning the signal charges for the high-sensitivity pixel signals, when the signal charges are read out dividedly twice, it is advisable to surely perform charge transfer every time the signal charges are read out. Consequently, it is possible to prevent, at least for high-sensitivity pixel signals, the fall in S/N due to a dark current caused in the charge transfer sections.

In the mechanisms described in WO2002/056603 and JP-A-2004-172858, there is a state in which the signal charges read out from the charge generating sections for high-sensitivity pixel signals to the charge transfer sections are left retained in the charge transfer sections. Therefore, during imaging under a low-luminance environment, S/N falls in both the high-sensitivity pixel signals and the low-sensitivity pixel signals because of unnecessary charges such as a dark current component caused by leaving the signal charges read out from the charge generating sections for high-sensitivity pixel signals to the charge transfer sections retained in the charge transfer sections. The mechanism according to the embodiment is different from this mechanism.

As timing for realizing the driving control method according to the embodiment, a first form can be adopted. In the first form, only the signal charges corresponding to the low-sensitivity pixel signals are read out to the charge transfer sections at the predetermined timing in the entire exposure period, i.e., at the final timing of the former half in the entire storage period for storing signal charges in the charge generating sections. The signal charges corresponding to the low-sensitivity pixel signals transferred by the charge transfer sections after being read out to the charge transfer sections at the final timing of the former half of the entire exposure period (more specifically, the predetermined timing in the entire exposure period, the same applies in the following explanation) are directly used for an output signal.

In this case, only the signal charges for the high-sensitivity pixel signals have to be signal charges that are read out to the charge transfer sections at the end point of the entire exposure period for acquiring high-sensitivity pixel signals or after the end point and transferred to the charge transfer sections. The signal charges for the high-sensitivity pixel signals are read out and transferred only once at the end point of the entire exposure period for acquiring high-sensitivity pixel signals or after the end point. The signal charges for the low-sensitivity pixel signals are stored in the charge generating sections even in the latter half of the entire exposure period. However, it is unnecessary to read out the signal charges at the end point of the entire exposure period for acquiring high-sensitivity pixel signals or after the end point.

Concerning in which period of the latter half of the electronic entire exposure period the signal charges read out from the charge generating sections for low-sensitivity pixel signals to the charge transfer sections at the final timing of the former half of the entire exposure period should be transferred to the charge transfer sections, different timing can be set according to whether the mechanical shutter is provided.

For example, when the mechanical shutter is not provided, it is possible to adopt a first method in which the charge transfer sections transfer, in a part of the latter half of the electronic entire exposure period or the entire later half, the signal charges read out from the charge generating sections for low-sensitivity pixel signals to the charge transfer sections at the final timing of the former half of the entire exposure period. On the other hand, when the mechanical shutter is provided, charge transfer is not performed until the mechanical shutter is closed and, after the mechanical shutter is closed, the charge transfer sections transfer the signal charges read out from the charge generating section for low-sensitivity pixel signals to the charge transfer sections at the final timing of the former half of the entire exposure period. Specifically, it is possible to adopt a second method in which the charge transfer sections transfer, in a period from the closure of the mechanical shutter until the electronic entire exposure period is finished, the signal charges read out from the charge generating sections for low-sensitivity pixel signals at the final timing of the former half of the entire exposure period.

In the first method, there is the incidence of an electromagnetic wave during the charge transfer of the signal charges for the low-sensitivity pixel signals. Therefore, a smear phenomenon due to superimposition of leak charges on the signal charges can occur. On the other hand, in the second method, since the charge transfer sections can transfer the signal charges for the low-sensitivity pixel signals in a state in which the mechanical shutters are closed, it is possible to prevent the problem due to unnecessary charges such as the smear phenomenon.

As timing for realizing the driving control method according to the embodiment, a second form can be adopted. In the first form, the signal charges corresponding to the low-sensitivity pixel signals are read out to the charge transfer sections at the predetermined timing in the entire exposure period, after the predetermined timing in the entire exposure period, i.e., the latter half of the entire exposure period, while the read-out signal charges are transferred by the charge transfer sections, the signal charges corresponding to the low-sensitivity pixel signals and high-sensitivity pixel signals are stored in the respective charge generating sections, at the end point of the entire storage period for acquiring high-sensitivity pixel signals or after the end point, the signal charges generated by the charge generating sections for high-sensitivity pixel signals and low-sensitivity pixel signals are read out to the charge transfer sections simultaneously or in predetermined order, and the signal charges read out to the charge transfer sections are transferred by the charge transfer sections.

In this case, the signal charges for the high-sensitivity pixel signals are read out and transferred only once at the end point of the entire exposure period for acquiring high-sensitivity pixel signals or after the end point. On the other hand, concerning a low-sensitivity pixel signal side, the signal charges transferred by the charge transfer sections in the latter half of the electronic entire exposure period after being read out to the charge transfer sections at the final timing of the former half of the entire exposure period are not used as an output signal and are swept out. The signal charges transferred by the charge transfer sections after being read out to the charge transfer sections at the end point of the entire exposure period for acquiring high-sensitivity pixel signals or after the end point are used for an output signal. An operation for sweeping out, in the latter half of the electronic entire exposure period, the signal charges read out at the final timing of the former half of the entire exposure period is an operation for not only sweeping out signal charges not actually used but also sweeping out unnecessary charges such as a smear component that can be superimposed on the signal charges.

When the signal charges read out at the final timing of the former half of the entire exposure period and not actually used are transferred by the charge transfer sections in the latter half of the electronic entire exposure period, the signal charges only have to be transferred until signal charges actually used are read out. As long as the signal charges are transferred until signal charges actually used are read out, a point when the signal charges not actually used are transferred is arbitrary. However, in order to reduce unnecessary charges such as a smear component, which can be superimposed on the signal charges actually used, as much as possible, time from the end of the transfer of the signal charges, which are read out at the final timing of the former half of the entire exposure period and not actually used, by the charge transfer sections until the signal charges actually used are read out is preferably as short as possible.

For example, when the mechanical shutter is not provided, it is possible to adopt the first method in which the charge transfer sections transfer the signal charges of a part of the latter half of the electronic entire exposure period or the entire latter half. On the other hand, when the mechanical shutter is provided, it is possible to adopt the second method in which the charge transfer sections transfer the signal charges in a period from the closure of the mechanical shutter until the electronic entire exposure period is finished (actually, a period from the closure of the mechanical shutter until the signal charges actually used are read out). In both the methods, the signal charges actually used are read out and the read-out signal charges are transferred by the charge transfer sections only after the signal charges read out at the final timing of the former half of the entire exposure period and not actually used are transferred by the charge transfer sections. Therefore, the problem due to unnecessary charges such as a smear component can be controlled by both the methods.

In both the methods, in order to surely sweep out unnecessary charges such as a smear component and, then, read out the signal charges actually used, it is advisable to continue charge transfer until the signal charges actually used are read out and stop the charge transfer immediately before reading out the signal charges actually used.

In the latter half of the electronic entire exposure period, during a period from the start of charge transfer of the signal charges read out at the final timing of the former half of the entire exposure period and not actually used until the charge transfer is stopped, charge transfer for all horizontal lines is completed. Otherwise, the signal charges read out at the final timing of the former half of the entire exposure period and not actually used and unnecessary charges such as a smear component remain in lines in which signal charges are not completely transferred. In order to reduce time in which the signal charges are stored by the charge generating sections in the latter half of the entire exposure period, sweep-out of the signal charges read out at the final timing of the former half of the entire exposure period and not actually used and unnecessary signal charges generated in the charge transfer sections is performed at speed higher than transfer speed of the signal charges actually used.

As timing for realizing the driving control method according to the embodiment, it is possible to adopt a third form. In the third form, the signal charges for the high-sensitivity pixel signals are read out to the charge transfer sections and the signal charges for the low-sensitivity pixel signals are read out to the charge transfer sections at the predetermined timing in the entire exposure period and, in the latter half of the entire exposure period, while the read-out signal charges are transferred by the charge transfer sections, the signal charges for the low-sensitivity pixel signals and high-sensitivity pixel signals are stored in the charge generating sections, respectively, and at the end point of the entire exposure period for acquiring high-sensitivity pixel signals or after the endpoint, at least the signal charges generated by the charge generating sections for high-sensitivity pixel signals are read out to the charge transfer sections and the read-out signal charges are transferred by the charge transfer sections.

In short, when the entire exposure period is divided into the former half and the latter half for acquisition of low-sensitivity pixel signals, the signal charges for the high-sensitivity pixel signals stored in the charge generating sections are read out every time using the divided entire exposure period and the read-out signal charges are transferred by the charge transfer sections.

In this case, as in the first form, the low-sensitivity pixel signals read out at the end timing of the former half of the entire exposure period may be used for an output signal. Alternatively, as in the second form, the low-sensitivity pixel signals may be read out at the end point of the entire exposure period and after the end point and used for an output signal.

When the signal charges read out at the final timing of the former half of the entire exposure period are transferred by the charge transfer section in the latter half of the electronic entire exposure period, the signal charges only have to be transferred until the signal charges generated by the charge generating sections in the latter half of the entire exposure period are read out. As long as the signal charges are transferred until the signal charges generated by the charge generating sections in the latter half of the entire exposure period are read out, a point when the signal charges are transferred is arbitrary. Charge transfer for all the horizontal lines is completed during a period in which the charge transfer is started at a predetermined point in the latter half of the electronic entire exposure period until the charge transfer is stopped.

In the second and the third forms, when the signal charges for the high-sensitivity pixel signals and low-sensitivity pixel signals are read out at the end point of the entire exposure period and after the end point and the read-out charge signals are used for an output signal, in the CCD solid-state imaging device of the all-pixel readout system, both the signal charges for the high-sensitivity pixel signals and low-sensitivity pixel signals can be simultaneously read out and collectively transferred by the charge transfer sections.

On the other hand, when the IL-CCD and the FIT-CCD are used, by applying frame readout, it is necessary to read out one of the signal charges for the high-sensitivity pixel signals and low-sensitivity pixel signals earlier and, after completing the transfer of the signal charges read out earlier with the charge transfer sections, read out the other signal charges and, then, start transfer of the read-out signal charges by the charge transfer sections. However, it is arbitrary to decide which of the signal charges are reach out earlier and transferred by the charge transfer sections.

According to the embodiments of the present invention, the entire exposure period is divided into the former half and the latter half and signal charges stored by the charge generating sections are read out dividedly twice to acquire signal charges corresponding to the high-sensitivity pixel signals and signal charges corresponding to the low-sensitivity pixel signals independently from each other. When at least one of the signal charges for the high-sensitivity pixel signals and the signal charges for the low-sensitivity pixel signals are read out from the charge generating sections to the charge transfer sections, the signal charges are driven to be transferred without being retained in the charge transfer sections.

Consequently, concerning at least one of the high-sensitivity pixel signals and the low-sensitivity pixel signals, a phenomenon in which unnecessary charges such as a dark current component due to non-transfer of charges are superimposed on the signal charges read out from the charge generating sections to the charge transfer sections does not occur. Since the read-out signal charges are not left retained in the charge transfer sections, it is possible to reduce the dark current, reduce dot defects, and reduce a level of the defects.

### BRIEF DESCRIPTION OF THE DRAWINGS

FIG. 1 is a schematic diagram showing a digital still camera as an imaging apparatus according to an embodiment of the present invention;

FIG. 2 is a schematic diagram of a solid-state imaging apparatus in a first example of the structure including an IL-CCD and a driving control unit;

FIG. 3 is a schematic diagram of a solid-state imaging apparatus in a second example of the structure including an FIT-CCD and the driving control unit;

FIG. 4 is a schematic diagram of a solid-state imaging apparatus in a third example of the structure including a PS-CCD and the driving control unit;

FIG. 5 is a diagram showing a color/sensitivity mosaic pattern P1 that assumes a first characteristic;

FIG. 6 is a diagram showing a color/sensitivity mosaic patter P2 that assumes a second characteristic;

FIG. 7 is a diagram showing a color/sensitivity mosaic pattern P4 that assumes a fourth characteristic;

FIGS. 8A to 8F are diagrams for explaining driving control according to a first embodiment of the present invention for electronically realizing a sensitivity mosaic pattern while controlling generation of a dark current in a vertical transfer section;

FIGS. 9A to 9F are diagrams showing a modification to a driving control method according to the first embodiment;

FIGS. 10A to 10G are diagrams for explaining driving control according to a second embodiment of the present invention for electronically realizing a sensitivity mosaic pattern while controlling generation of a dark current in a vertical transfer section;

FIGS. 11A to 11G are diagrams showing a modification to a driving control method according to the second embodiment;

FIGS. 12A to 12F are diagrams for explaining driving control according to a third embodiment of the present invention for electronically realizing a sensitivity mosaic pattern while controlling generation of a dark current in a vertical transfer section;

FIGS. 13A to 13G are diagrams for explaining a modification (a first example) for a driving control method according to the third embodiment;

FIGS. 14A to 14G are diagrams for explaining a modification (a second example) for the driving control method according to the third embodiment;

FIGS. 15A to 15F are diagrams for explaining driving control according to a fourth embodiment of the present invention for electronically realizing a sensitivity mosaic pattern while controlling generation of a dark current in a vertical transfer section;

FIGS. 16A to 16G are diagrams for explaining a modification to a driving control method according to a fourth embodiment of the present invention;

FIGS. 17A to 17G are diagrams for explaining driving control according to a first example of a fifth embodiment of the present invention for electronically realizing a sensitivity mosaic pattern while controlling generation of a dark current in a vertical transfer section;

FIGS. 18A to 18E are diagrams for explaining driving control according to a second example of the fifth embodiment of the present invention for electronically realizing a sensitivity mosaic pattern while controlling generation of a dark current in a vertical transfer section;

FIGS. 19A to 19F are diagrams for explaining driving control according to a first example of a sixth embodiment of the present invention for electronically realizing a sensitivity mosaic pattern while controlling generation of a dark current in a vertical transfer section;

FIGS. 20A to 20F are diagrams for explaining driving control according to a second example of the sixth embodiment of the present invention for electronically realizing a sensitivity mosaic pattern while controlling generation of a dark current in a vertical transfer section;

FIGS. 21A to 21G are diagrams for explaining a modification to a driving control method according to a first example of the sixth embodiment;

FIGS. 22A to 22E are diagrams for explaining a modification to a driving control method according to a second example of the sixth embodiment;

FIGS. 23A to 23E are diagrams for explaining an overview of an SVE imaging operation in a digital still camera according to an embodiment of the present invention;

FIG. 24 is a functional block diagram that focuses on demosaic processing in an image processing unit;

FIG. 25 is a diagram showing an example of the structure of a luminance-image generating unit;

FIG. 26 is a graph (No. 1) for explaining a combined sensitivity compensation lookup table used by an estimating unit;

FIG. 27 is a graph (No. 2) for explaining the combined sensitivity compensation lookup table used by the estimating unit;

FIG. 28 is a graph (No. 3) for explaining the combined sensitivity compensation lookup table used by the estimating unit; and

FIG. 29 is a diagram showing an example of the structure of a single-color-image creating unit that creates an output image R.

### DESCRIPTION OF THE PREFERRED EMBODIMENTS

Embodiments of the present invention will be hereinafter explained in detail with reference to the accompanying drawings.

Overall Structure of a Digital Still Camera

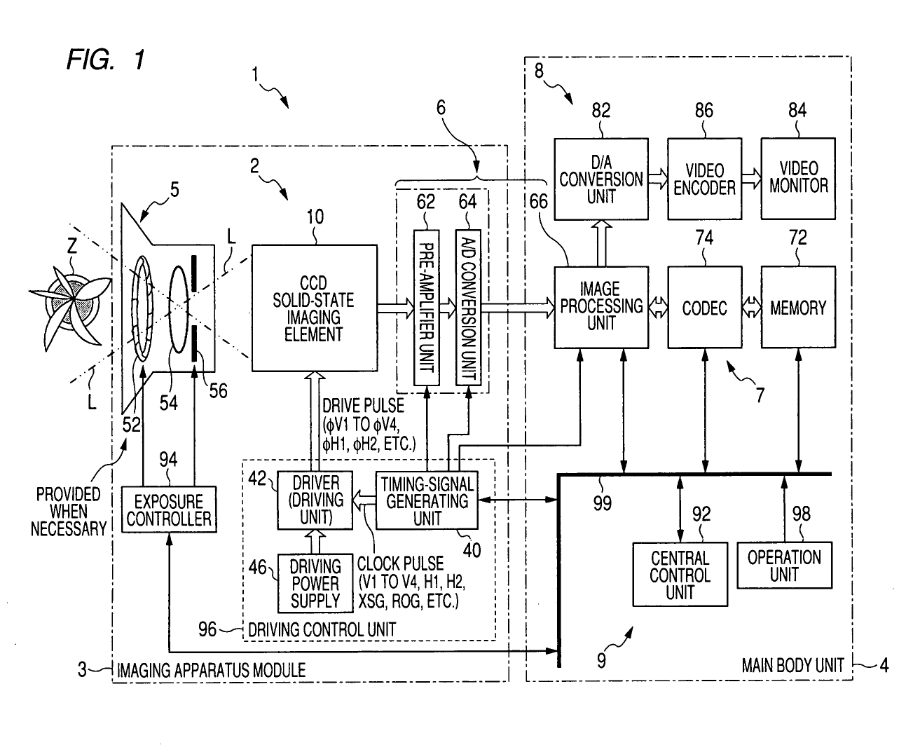

FIG. 1 is a schematic diagram showing a digital still camera 1 as an imaging apparatus (a camera system) according to an embodiment of the present invention. The digital still camera 1 is applied as a camera that can image a color image during a still image imaging operation.

The imaging apparatus shown in FIG. 1 is configured as the digital still camera 1 including an imaging apparatus module 3 that has a CCD solid-state imaging device 10, an optical system 5, a preamplifier unit 62 and an A/D conversion unit 64 as a part of a signal processing system 6, an exposure controller 94, and a driving control unit 96 as an example of a driving device that controls to drive the CCD solid-state imaging device 10 and a main body unit 4 that generates a video signal on the basis of an imaging signal obtained by the imaging apparatus module 3 and outputs an image on a monitor or stores the image in a predetermined storage medium.

The driving control unit 96 in the imaging apparatus module 3 includes a timing-signal generating unit 40 that generates various pulse signals for driving the CCD solid-state imaging device 10, a driver (a driving unit) 42 that receives the pulse signals from the timing-signal generating unit 40 and converts the pulse signals into drive pulses for driving the CCD solid-state imaging device 10, and a driving power supply 46 that supplies power to the CCD solid-state imaging device 10 and the driver (the driving unit) 42.

The solid-state imaging apparatus 2 includes the CCD solid-state imaging device 10 and the driving control unit 96 in the imaging apparatus module 3. The solid-state imaging apparatus 2 is desirably provided as a solid-state imaging apparatus in which the CCD solid-state imaging device 10 and the driving control unit 96 are arranged on one circuit board.

A processing system of the digital still camera 1 roughly includes the optical system 5, the signal processing system 6, a recording system 7, a display system 8, and a control system 9. It goes without saying that the imaging apparatus module 3 and the main body unit 4 are housed in a now-shown armor case to finish an actual product (an end product).

The optical system 5 includes a mechanical shutter 52 having a function of stopping storage of signal charges in sensor sections (charge generating sections) of the CCD solid-state imaging device 10, a lens 54 that condenses an optical image of a subject, and an aperture stop 56 that adjusts a light amount of the optical image.

Light L from a subject Z is transmitted through the mechanical shutter 52 and the lens 54, adjusted by the aperture stop 56, and made incident on the CCD solid-state imaging device 10 with moderate brightness. At this point, the lens 54 adjusts a focus position such that a video formed by the light L from the subject Z is focused on the CCD solid-state imaging device 10.

The signal processing system 6 includes a preamplifier unit 62 having a modulation amplifier that amplifies an analog imaging signal from the CCD solid-state imaging device 10, a CDS (Correlated Double Sampling) circuit that reduces noise by sampling the amplified imaging signal, and the like, an A/D (Analog/Digital) conversion unit 64 that converts an analog signal outputted by the preamplifier unit 62 into a digital signal, and an image processing unit 66 including a DSP (Digital Signal Processor) that applies predetermined image processing to the digital signal inputted from the A/D conversion unit 64.

The recording system 7 includes a memory (a recording medium) 72 such as a flash memory that stores an image signal and a CODEC (Code/Decode or Compression/Decompression) 74 that encodes an image signal processed by the image processing unit 66, records the image signal in the memory 72, reads out and decodes the image signal, and supplies the image signal to the image processing unit 66.

The display system 8 includes a D/A (Digital/Analog) conversion unit 82 that analogizes the image signal processed by the image processing unit 66, a video monitor 84 including liquid crystal (LCD; Liquid Crystal Display) that functions as a finder by displaying an image corresponding to an inputted video signal, and a video encoder 86 that encodes the analogized image signal into a video signal of a format matching a video monitor 84 at a post stage.

The control unit 9 includes a central control unit 92 including a CPU (Central Processing Unit) that controls a not-shown drive (driving device) to read out a control program stored in a magnetic disk, an optical disk, a magneto-optical disk, or a semiconductor memory, and controls the entire digital still camera 1 on the basis of the read-out control program, a command inputted by a user, and the like.

The control system 9 includes an exposure controller 94 that controls the mechanical shutter 52 and the aperture stop 56 such that brightness of an image transmitted to the image processing unit 66 keeps moderate brightness, a driving control unit 96 including a timing-signal generating unit (a timing generator; TG) 40 that controls operation timing of respective functional units from the CCD solid-state imaging device 10 to the image processing unit 66, and an operation unit 98 with which the user inputs shutter timing and other commands. The central control unit 92 controls the image processing unit 66, the CODEC 74, the memory 72, the exposure controller 94, and the timing-signal generating unit 40 connected to a bus 99 of the digital still camera 1.

The video monitor 84 also plays a role of a finder of the digital still camera 1. When the user depresses a shutter button included in the operation unit 98, the central control unit 92 captures an image signal immediately after the shutter button is depressed into the timing-signal generating unit 40. Thereafter, the central control unit 92 controls the signal processing system 6 such that the image signal is not overwritten on a not-shown image memory of the image processing unit 66. Image data written in the image memory of the image processing unit 66 is encoded by the CODEC 74 and recorded in the memory 72. The capturing of one image data is completed according to the operations of the digital still camera 1 described above.

The digital still camera 1 includes an automatic control device for auto-focus (AF), auto-white balance (AWB), automatic exposure (AE), and the like. The automatic control devices processes control for auto-focus (AF) , auto-white balance (AWB), automatic exposure (AE), and the like using an output signal obtained from the CCD solid-state imaging device 10. For example, a control value of the exposure controller 94 is set such that brightness of an image transmitted to the image processing unit 66 keeps moderate brightness. The exposure controller 94 controls the aperture stop 56 in accordance with the control value. Specifically, the central control unit 92 acquires an appropriate number of samples of luminance values from the image stored in the image processing unit 66 and sets a control value of the aperture stop 56 such that an average of the luminance values fits in an appropriate range of luminance set in advance.

The timing-signal generating unit 40 is controlled by the central control unit 92, generates timing pulses necessary for operations of the CCD solid-state imaging device 10, the preamplifier unit 62, the A/D conversion unit 64, and the image processing unit 66, and supplies the timing pulses to the respective units. The operation unit 98 is operated when the user operates the digital still camera 1.

In the example shown in the figure, the preamplifier unit 62 and the A/D conversion unit 64 of the signal processing system 6 are built in the imaging apparatus module 3. However, the preamplifier unit 62 and the A/D conversion unit 64 can also be provided in the main body unit 4. The D/A conversion unit 82 can also be provided in the image processing unit 66.

The timing-signal generating unit 40 is built in the imaging apparatus module 3. However, the timing-signal generating unit 40 can also be provided in the main body unit 4. The timing-signal generating unit 40 and the driver (the driving unit) 42 are separately provided. However, the timing-signal generating unit 40 and the driver 42 may be integrated (a timing generator incorporating a driver). Consequently, it is possible to realize a more compact (smaller) digital still camera 1.

The timing-signal generating unit 40 and the driver (the driving unit) 42 may be configured as circuits with separate discrete members. However, the timing-signal generating unit 40 and the driver (the driving unit) 42 are preferably provided as an IC (Integrated Circuit) formed as a circuit on one semiconductor substrate. Consequently, this not only makes it possible to reduce a size of the digital still camera 1 but also makes it easy to treat the members and makes it possible to realize both the members at low cost. Moreover, it is easy to manufacture the digital still camera 1.

When the timing-signal generating unit 40 and the driver (the driving unit) 42 closely related to the CCD solid-state imaging device 10 are integrated by being mounted on a substrate common to the CCD solid-state imaging device 10 or integrated in the imaging apparatus module 3, it is easy to treat and manage the members. Since these members are integrated as a module, it is easy to manufacture (an end product) of the digital still camera 1. The imaging apparatus module 3 may include only the optical system 5.

In the structure shown in FIG. 1, an overview of the digital still camera 1 is shown. The digital still camera 1 does not always need to include all the components shown in the figure. In particular, the mechanical shutter 52 is not always necessary in all embodiments in which various kinds of driving control timing are described and only has to be provided when necessary. It is explained in the respective embodiments whether the mechanical shutter 52 is necessary.

Overview of the CCD solid-state imaging device and peripheral units; Application to an IL-CCD

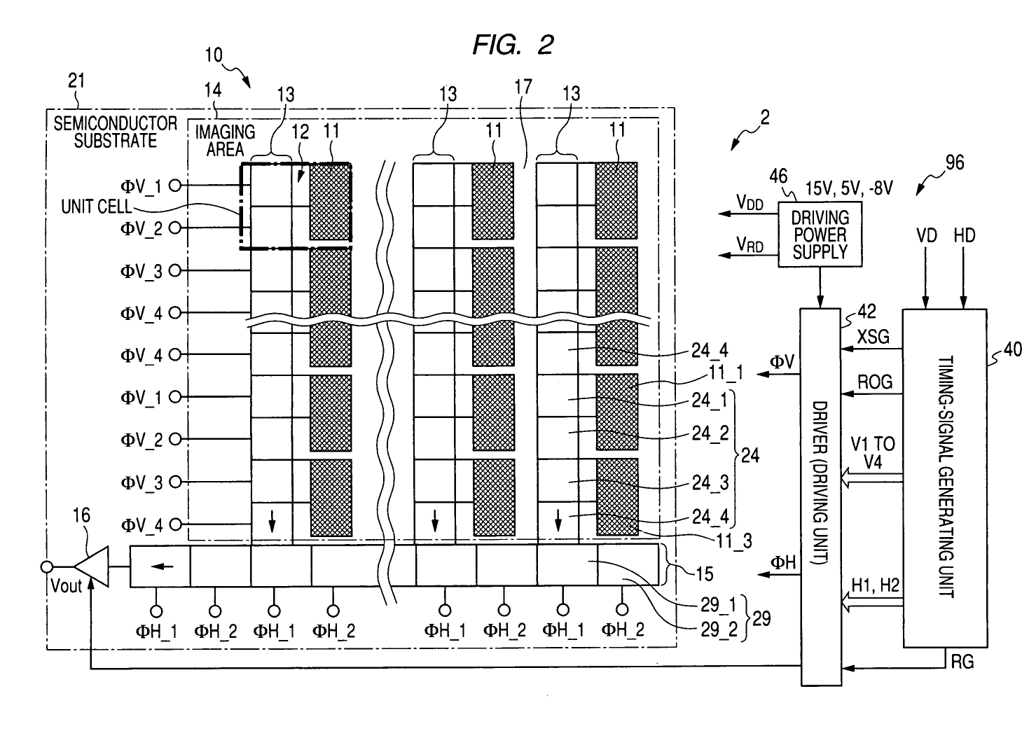

FIG. 2 is a schematic diagram of a solid-state imaging apparatus 2 in a first example of the structure including the CCD solid-state imaging device 10 and the driving control unit 96 that drives the CCD solid-state imaging device 10 according to this embodiment. In this example of the structure, the CCD solid-state imaging device (IL-CCD) 10 of an interline system in which vertical charge transfer sections are arranged among arrays (an array in a vertical direction) of sensor sections is driven in four phases.

In FIG. 2, a power supply voltage VDD and a reset drain voltage VRD are applied to the CCD solid-state imaging device 10 from the driving power supply 46. A predetermined voltage is supplied to the driver (the driving unit) 42.

In the CCD solid-state imaging device 10 forming the solid-state imaging apparatus 2, a large number of sensor sections (photosensitive units; photocells) including photodiodes as an example of light-receiving elements are arranged in a two-dimensional matrix shape in a vertical (column) direction and a horizontal (row) direction in association with pixels (unit cells) on the semiconductor substrate 21. These sensor sections 11 detect incident light made incident from light-receiving surfaces, acquire signal charges of a charge amount corresponding to a light amount (intensity) of the incident light (in general, referred to as photoelectric conversion), and stores the acquired signal charges in the sensor sections 11.

In the CCD solid-state imaging device 10, vertical CCDs (V register sections, vertical-charge transfer sections) 13, in which plural vertical transfer electrodes 24 corresponding to N-phase driving for each of vertical columns of the sensor sections 11 are provided, are arranged. In this example, to cope with four-phase driving, four vertical transfer electrodes 24 (references _1, _2, _3, and _4 are affixed thereto, respectively) per two unit cells are arranged on the vertical CCDs 13, which are an example of the charge transfer sections.

For example, on the vertical CCDs 13 (on the light-receiving surface side), four kinds of vertical transfer electrodes 24 are arranged in the vertical direction in predetermined order to form openings in the light-receiving surfaces of the sensor sections 11 such that the vertical transfer electrodes 24 are common to the vertical CCDs 13 in the same vertical position in the respective columns. The vertical transfer electrodes 24 are arranged to extend in the horizontal direction, i.e., traverse in the horizontal direction while forming openings on the light-receiving side of the sensor sections 11.

In the four kinds of vertical transfer electrodes 24, two vertical transfer electrodes 24 corresponds to one sensor section 11. The vertical transfer electrodes 24 drive to transfer signal charges in the vertical direction with four kinds of vertical transfer pulses ΦV_1, ΦV_2, ΦV_3, and ΦV_4 supplied from the driver (the driving unit) 42 of the driving control unit 96. In other words, with two sensor sections 11 adjacent to each other in the vertical direction as a pair, the vertical transfer pulses ΦV_1, ΦV_2, ΦV_3, and ΦV_4 are applied to the four vertical transfer electrodes 24, respectively, from the driver (the driving unit) 42 of the driving control unit 96.

In the CCD solid-state imaging device 10, a line of a horizontal CCD (an H register, a horizontal-charge transfer section) 15 extending in a left to right direction in the figure is provided adjacent to respective transfer destination side ends of the plural vertical CCDs 13, i.e., the vertical CCDs 13 in the last row. The horizontal CCD 15 is driven by, for example, horizontal transfer pulses ΦH1 and ΦH2 based on horizontal transfer clocks H1 and H2 in two phases and transfers signal charges for one line transferred from the plural vertical CCDs 13 in the horizontal direction in order in a horizontal scanning direction after a horizontal blanking period. Therefore, plural (two) horizontal transfer electrodes 29 (29-1 and 29-2) corresponding to two-phase driving are provided.

In the example shown in the figure, the four vertical transfer electrodes 24 are provided in association with a pair (one packet) of the vertical CCDs 13 specified by four electrodes in the vertical direction. Among the vertical transfer electrodes 24, the vertical transfer electrode 24 located at the top in the vertical direction corresponds to the vertical transfer electrode 24_1 to which the vertical transfer pulse ΦV_1 is applied. The vertical transfer pulse ΦV_2 is applied to the vertical transfer electrode 24_2 at the preceding state (further on the horizontal CCD 15 side). The vertical transfer pulse ΦV_3 is applied to the vertical transfer electrode 24_3 at the further preceding stage (further on the horizontal CCD 15 side). The vertical transfer pulse ΦV_4 is applied to the vertical transfer electrode 24_4 on the most horizontal CCD 15 side. The sensor section 11 located at the top in the vertical direction corresponds to the vertical transfer electrode 24_1 to which the vertical transfer pulse ΦV_1 is applied and the vertical transfer electrode 24_2 to which the vertical transfer pulse ΦV_2 is applied. The sensor section 11 at the preceding stage (further on the horizontal CCD 15 side) corresponds to the vertical transfer electrode 24_3 to which the vertical transfer pulse ΦV_3 is applied and the vertical transfer electrode 24_4 to which the vertical transfer pulse ΦV_4 is applied.

A transfer direction of the vertical CCDs 13 is a vertical (column) direction in the figure. The vertical CCDs 13 are provided in this direction. The plural vertical transfer electrodes 24 are arranged in a direction (a horizontal direction, a row direction) orthogonal to this direction. Readout gate sections 12 are interposed between the vertical CCDs 13 and the sensor sections 11, respectively. On the readout gate section 12 of each of the pixels, one of the vertical transfer electrodes 24_1 and 24_3, which corresponds to the readout gate section 12, among the four vertical transfer electrodes 24_1 to 24_4 is provided to also serve as a readout electrode. Channel stop sections (CSs) 17 are provided in boundary portions of the respective unit cells. An imaging area 14 includes the sensor sections 11 and the plural vertical CCDs 13 that are provided in each of the vertical columns of the sensor sections 11 and vertically transfer signal charges read out from the respective sensor sections 11 via the readout gate sections 12, the readout gate sections 12, the channel stop sections (CSs) 17, and the like.

When a drive pulse ΦROG corresponding to a readout pulse ROG is applied to the readout gate sections 12, signal charges stored in the sensor sections 11 are read out to the vertical CCDs 13. The readout of the signal charges from the sensor sections 11 to the vertical CCDs 13 is also specifically referred to as field shift.

The vertical CCDs 13 are driven by the vertical transfer pulses ΦV1 to ΦV4 based on the vertical transfer clocks V1 to V4 in four phases and simultaneously transfer the read-out signal charges by an amount equivalent to one scanning line (one line) at a time in the vertical direction toward the horizontal CCD 15 side in a part of the horizontal blanking period. The vertical transfer of signal charges line by line to the horizontal CCD 15 side through the vertical CCDs 13 is specifically referred to as line shift.

A charge-voltage converting unit 16 of, for example, the floating diffusion amplifier (FDA) structure is provided at an end in a transfer destination of the horizontal CCD 15. The charge-voltage converting unit 16 converts signal charges horizontally transferred by the horizontal CCD 15 into voltage signals in order and outputs the voltage signals. The voltage signals are led out as a CCD output (VOUT) corresponding to an incident amount of light from a subject. The CCD solid-state imaging device 10 of the interline transfer system includes the components described above.

The solid-state imaging apparatus 2 also includes a timing-signal generating unit 40 that generates various pulse signals (two values at an “L” level and an “H” level) for driving the CCD solid-state imaging device 10 and a driver (a driving unit) 42 that changes the various pulses supplied from the timing-signal generating unit 40 to a drive pulse of a predetermined level and supplies the drive pulse to the CCD solid-state imaging device 10.

For example, the timing-signal generating unit 40 generates, on the basis of a horizontal synchronizing signal (HD) and a vertical synchronizing signal (VD), a readout pulse ROG for reading out signal charges stored in the sensor sections 11 of the CCD solid-state imaging device 10, vertical transfer clocks V1 to Vn (n indicates the number of phases during driving; e.g., during four-phase driving, V4) for driving the read-out signal charges to be transferred in the vertical direction and passing the signal charges to the horizontal CCD 15, horizontal transfer clocks H1 and H2 for driving the signal charges passed from the vertical CCD 13 to be transferred in the horizontal direction and passing the signal charges to the charge-voltage converting unit 16, a reset pulse RG, and the like and supplies the pulses and the clocks to the driver (the driving unit) 42. When the CCD solid-state imaging device 10 corresponds to an electronic shutter, the timing-signal generating unit 40 also supplies an electronic shutter pulse XSG to the driver (the driving unit) 42.

The driver (the driving unit) 42 converts the various clock pulses supplied from the timing-signal generating unit 40 into voltage signals (drive pulses) of a predetermined level or into other signals and supplies the voltage signals or the signals to the CCD solid-state imaging device 10. For example, the vertical transfer clocks V1 to V4 in four phases generated by the timing-signal generating unit 40 are converted into drive pulses ΦV1 to ΦV4 via the driver (the driving unit) 42 and applied to predetermined vertical transfer electrodes (24_1 to 24_4) corresponding thereto in the CCD solid-sate imaging device 10.

The readout pulse ROG is combined with the vertical transfer clock V1 and V3 via the driver (the driving unit) 42 to be converted into drive pulses ΦV1 and ΦV3 of a three-value level including a readout voltage and applied to the vertical transfer electrodes 24_1 and 24_3.

Similarly, the horizontal transfer clocks H1 and H2 in two phases are converted into drive pulses ΦH1 and ΦH2 via the driver (the driving unit) 42 and applied to predetermined horizontal transfer electrodes 29_1 and 29_2 corresponding thereto in the CCD solid-state imaging device 10.

As described above, the driver (the driving unit) 42 combines the readout pulse ROG with V1 and V3 among the vertical transfer clocks V1 to V4 in four phases to convert the readout pulse ROG into the vertical transfer pulses ΦV1 and ΦV3 of the three-value level and supplies the vertical transfer pulses ΦV1 and ΦV3 to the CCD solid-state imaging device 10. In other words, the vertical transfer pulses ΦV1 and ΦV3 are used for not only the original vertical transfer operation but also readout of signal charges.

A series of operations of the CCD solid-state imaging device 10 having such structure are generally explained below. First, the timing-signal generating unit 40 generates various pulse signals such as the transfer clocks V1 to V4 for vertical transfer and the readout pulse ROG. These pulse signals are converted into drive pulses of a predetermined voltage level by the driver (the driving unit) 42 and, then, inputted to a predetermined terminal of the CCD solid-state imaging device 10.

The readout pulse ROG generated from the timing-signal generating unit 40 is applied to one of the vertical transfer electrodes 24_1 and 24_3, which corresponds to the readout pulse ROG, also serving as a readout electrode among the four vertical transfer electrodes 24_1 to 24_4 of the readout gate section 12 and a potential of the readout gate section 12 under the readout electrode deepens. Then, the signal charges stored in each of the sensor sections 11 are read out to the vertical CCDs 13 through the readout gate section 12. When the vertical CCDs 13 are driven on the basis of the vertical transfer pulses ΦV1 to ΦV4 in four phases, the signal charges are transferred to the horizontal CCD 15 in order.

The horizontal CCD 15 horizontally transfers, on the basis of the horizontal transfer pulses ΦH1 and ΦH2 in two phases, which are obtained by converting the horizontal transfer clocks H1 and H2 generated from the timing-signal generating unit 40 into a predetermined voltage level with the driver (the driving unit) 42, signal charges equivalent to one line horizontally transferred from each of the plural vertical CCDs 13 to the charge-voltage converting unit 16 side in order.

The charge-voltage converting unit 16 stores the signal charges transferred from the horizontal CCD 15 in order in a not-shown floating diffusion. The charge-voltage converting unit 16 converts the stored signal charges into a signal voltage and outputs the signal voltage as an imaging signal (a CCD output signal) VOUT via, for example, a not-shown output circuit of a source follower structure under the control by the reset pulse RG generated from the timing-signal generating unit 40.

In the CCD solid-state imaging device 10, signal charges detected in the imaging area 14, in which the sensor sections 11 are two-dimensionally arranged vertically and horizontally, are vertically transferred to the horizontal CCD 15 through the vertical CCDs 13 provided in association with the vertical columns of the respective sensor sections 11. Thereafter, the signal charges are transferred in the horizontal direction by the horizontal CCD 15 on the basis of the horizontal transfer pulses ΦH1 and ΦH2 in two phases. The signal charges from the horizontal CCD 15 are converted into a signal voltage corresponding to the signal charges by the charge-voltage converting unit 16 and outputted. These operations are repeated.

Overview of the CCD Solid-State Imaging Device and Peripheral Units; Application to an FIT-CCD

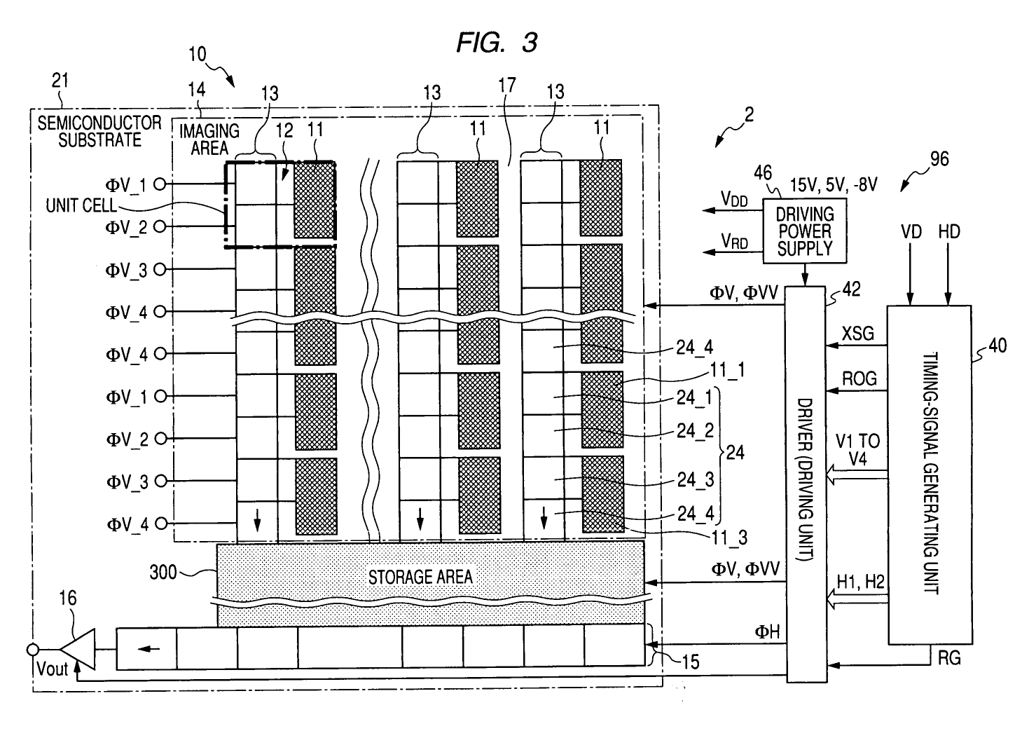

FIG. 3 is a schematic diagram of a solid-state imaging apparatus 2 in a second example of the structure including the CCD solid-state imaging device 10 and the driving control unit 96 that drives the CCD solid-state imaging device 10.

In the first example of the structure, the IL-CCD of the interline transfer system is used as the CCD solid-state imaging device 10. However, even when an FIT-CCD of a frame interline transfer system including a light-shielded storage area 300 for storing signal charges for one field below the IL-CCD is used as the CCD solid-state imaging device 10, readout of signal charges from the sensor sections 11 to the vertical CCDs 13 and a line shift operation through the vertical CCDs 13 are substantially the same as that in the IL-CCD. Among driving controls according to embodiments described later related to readout and vertical transfer (line shift) of signal charges, those applied to the IL-CCD can be applied to the FIT-CCD as well generally in the same manner.

In the FIT-CCD, signal charges read out to the vertical CCDs 13 in the vertical blanking period are transferred to the storage area 300 by using a high-speed vertical transfer pulse ΦVV. Thereafter, a line shift operation for feeding the signal charges into the horizontal CCD 15 by one horizontal line at a time from the storage area 300 is performed in the horizontal blanking period by using a vertical transfer pulse ΦV of speed same as that of the vertical transfer pulse ΦV in the first example of the structure.

Overview of the CCD Solid-State Imaging Device and Peripheral Units; Application of a PS-CCD

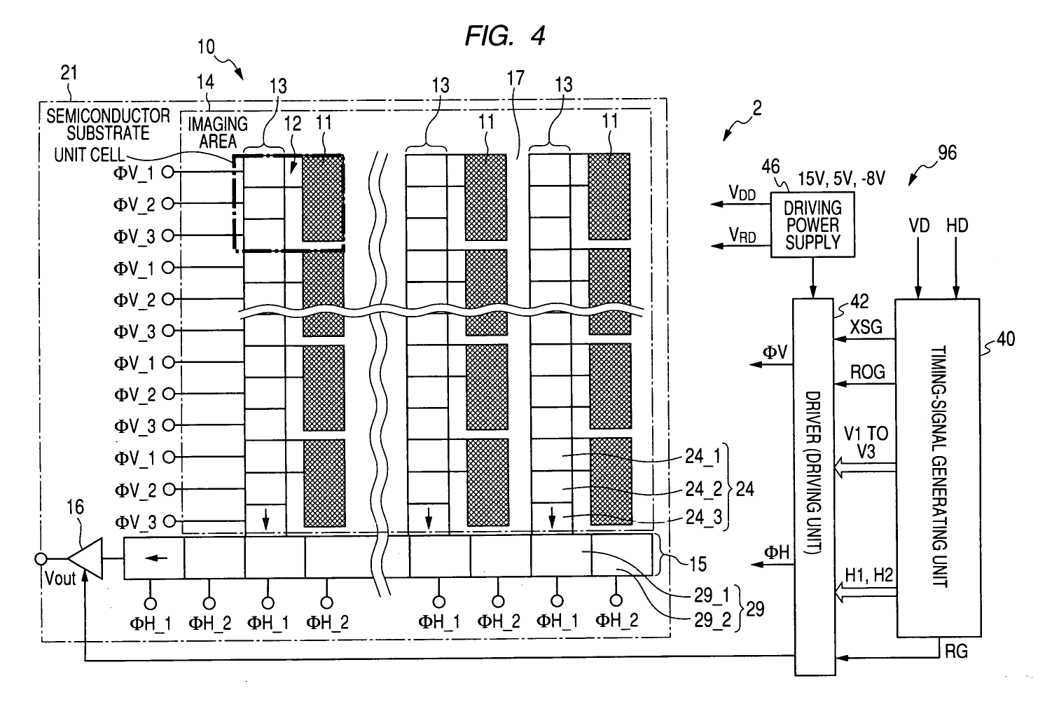

FIG. 4 is a schematic diagram of the solid-state imaging apparatus 2 in a third example of the structure including the CCD solid-state imaging device 10 and the driving control unit 96 that drives the CCD solid-state imaging device 10. In the third example of the structure, the CCD solid-state imaging device 10 (a PS-CCD) of a progressive scan (PS) system is used as the CCD solid-state imaging device 10.

As the pixel structure of the CCD solid-state imaging device 10 of the progressive scan system, a CCD solid-state imaging device of three-layer electrode and three-phase driving is proposed in, for example, “½ inch 330 thousand pixel square lattice progressive scan system CCD imaging device” Technical Report of Institute of Television Engineers of Japan, Information Input, Information Display, November 1994, p 7 to 12 (Reference Document 1). The CCD solid-state imaging device of the progressive scan system disclosed in Reference Document 1 has the structure in which a transfer electrode in a third layer also serving as a readout electrode extends in the horizontal direction in an effective pixel area. However, when the three-layer structure is formed, it is necessary to introduce an advanced refining technique for arranging three transfer electrodes in respective pixels through a three-layer polysilicon process and there is a disadvantage that cost increases.

An overview of the structure of the solid-state imaging apparatus 2 employing the CCD solid-state imaging device 10 of the progressive scan system is explained with focus placed on differences from the CCD solid-state imaging device 10 of the interline system shown in FIG. 2.

In the CCD solid-state imaging device 10 of the progressive scan system, vertical CCDs (V register sections, vertical charge transfer sections) 13 in which three vertical transfer electrodes 24 (references _1, _2, and _3 are affixed thereto, respectively) corresponding to three-phase driving are provided for each of vertical columns of the sensor sections 11 are arranged. In the CCD solid-state imaging device 10 of the interline system, the four vertical transfer electrodes 24 per two unit cells are arranged on the vertical CCDs 13, which are an example of the charge transfer sections. The CCD solid-state imaging device 10 of the progressive scan system is different from the CCD solid-state imaging device 10 of the interline system in that the three vertical transfer electrodes 24 per one unit cell are arranged on the vertical CCDs 13.

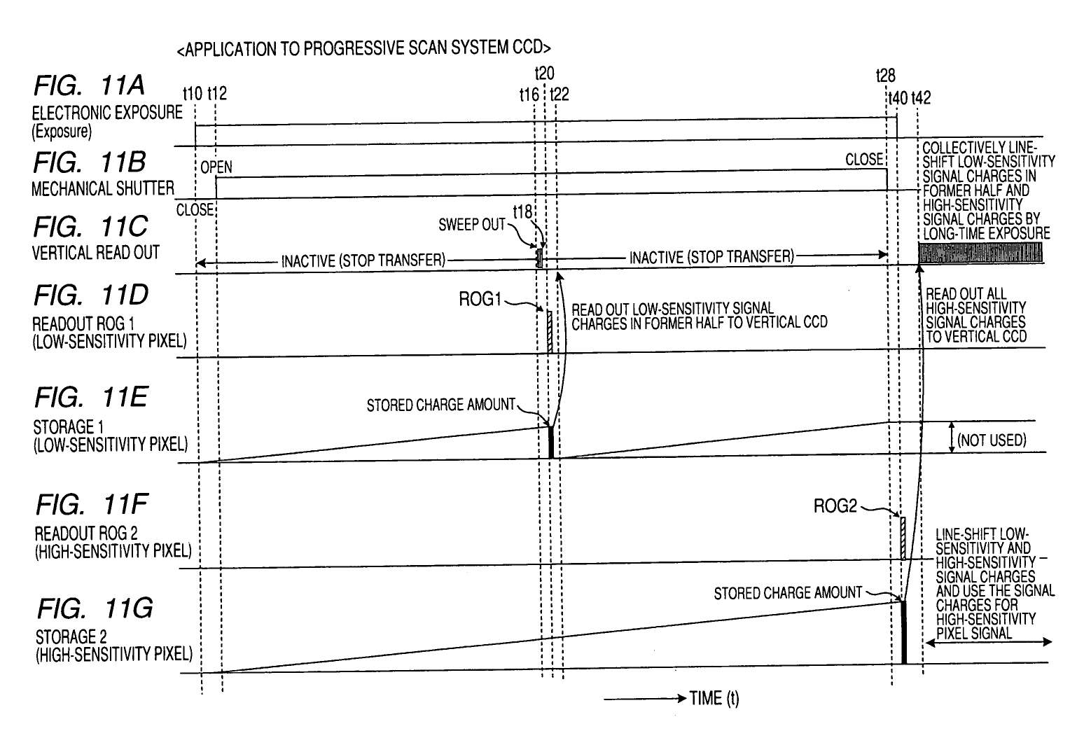

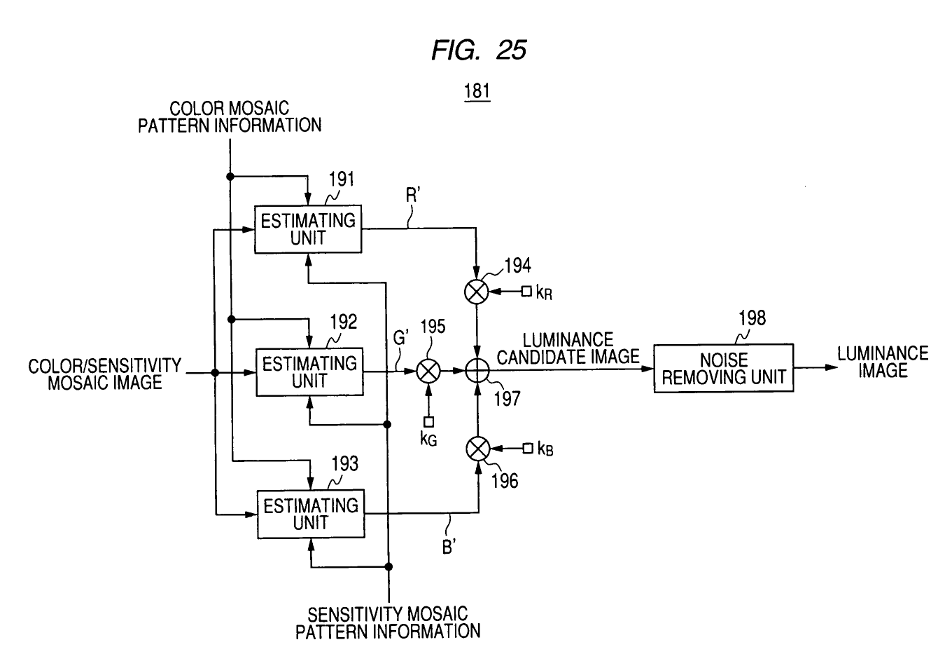

In order to realize an arbitrary sensitivity mosaic pattern using the electronic shutter function, the electrode arrangement structure of the vertical transfer electrodes 24 is further contrived. As an example, a mechanism shown in FIGS. 25 to 32 of WO2002/056603 is adopted. Alternatively, a mechanism shown in FIGS. 11 to 14 of JP-A-2004-172858 is adopted. Specific mechanisms of these kinds of electrode arrangement structure are not explained here.

Mosaic Pattern Array

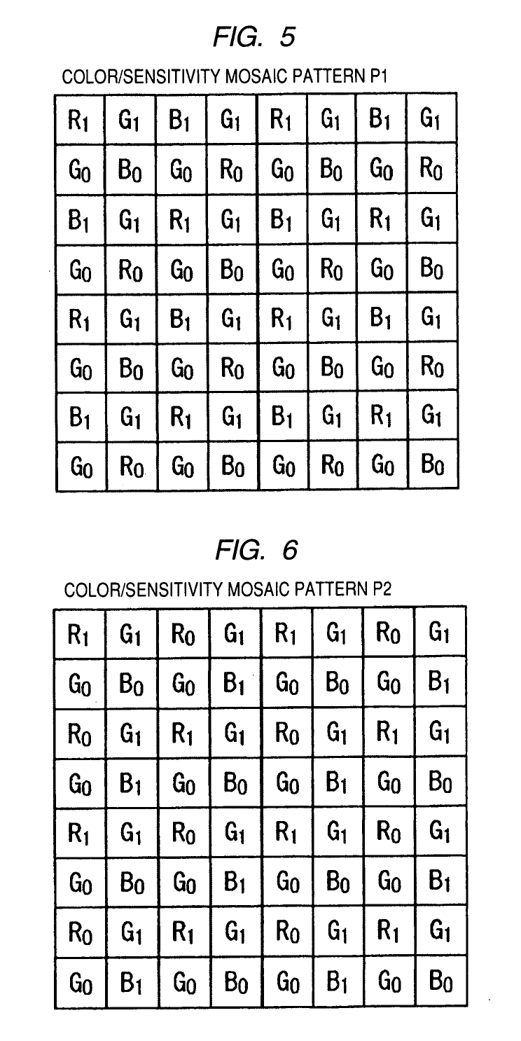

FIGS. 5 to 7 are diagrams for explaining the basic structure of array patterns of color components and sensitivity of pixels forming color/sensitivity mosaic images (hereinafter referred to as color/sensitivity mosaic patterns). As combinations of colors forming the color/sensitivity mosaic patterns, besides combinations of three colors including R (red), G (green), and B (blue), there are combinations of four colors including Y (yellow), M (magenta), C (cyan), and G (green).

In FIGS. 5 to 7, each of squares corresponds to one pixel, an alphabet indicates a color of the pixel, and a number as a suffix of the alphabet indicates a stage of sensitivity of the pixel. For example, a pixel represented as G1 indicates that a color is G (green) and sensitivity is S1. A larger number of sensitivity indicates higher sensitivity.

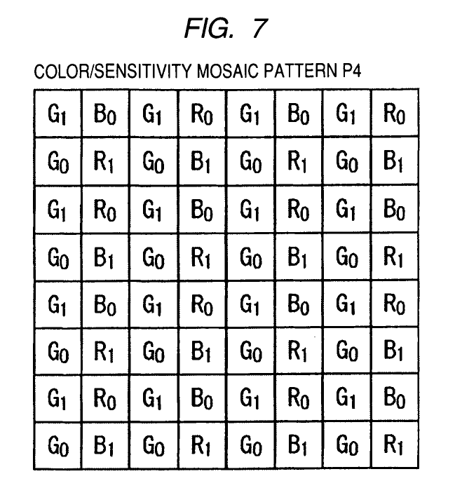

Basics of the color/sensitivity mosaic patterns can be classified by first to fourth characteristics described below. FIG. 5 is a diagram showing a color/sensitivity mosaic patterns P1 that assumes the first characteristic. FIG. 6 is a diagram showing a color/sensitivity mosaic pattern P2 that assumes the second characteristic. FIG. 7 is a diagram showing a color/sensitivity mosaic pattern P4 that assumes the fourth characteristic.

The first characteristic is that, when attention is paid to pixels having identical color and sensitivity, the pixels are arranged in a lattice shape and, when attention is paid to pixels having an identical color regardless of sensitivity, the pixels are arranged in a lattice shape.

For example, in the color/sensitivity mosaic pattern P1 shown in FIG. 5, when attention is paid to pixels having the color R regardless of sensitivity, as it is evident from a state in which the figure is rotated 45 degrees clockwise, the pixels are arranged in a lattice shape at intervals of 2̂1/2 (“̂” indicates square) in the horizontal direction and at intervals of 2̂3/2 in the vertical direction. When attention is paid to pixels having the color B regardless of sensitivity, the pixels are arranged in the same manner. When attention is paid to pixels having the color G regardless of sensitivity, the pixels are arranged in a lattice shape at intervals of 2̂1/2 in the horizontal-direction and the vertical direction.

In particular, in the color/sensitivity mosaic pattern P1 shown in FIG. 5, all odd number lines are lines of high-sensitivity pixels and all even number lines are lines of low-sensitivity pixels. If signal charges of the odd number lines and the even number lines are alternately read out to the vertical CCDs 13 independently from each other for each of fields, there is an advantage that it is possible to read out high-sensitivity pixel signals and low-sensitivity pixel signals independent from each other for each of the fields.

The second characteristic is that a color-sensitivity mosaic pattern has the first characteristic and three kinds of colors are used and arranged in a Bayer array. For example, in the color/sensitivity mosaic pattern P2 shown in FIG. 6, when attention is paid to pixels having the color G regardless of sensitivity, the pixels are arranged in a checkered pattern at intervals of one pixel. When attention is paid to pixels having the color R regardless of sensitivity, the pixels are arranged at intervals of one line. When attention is paid to pixels having the color B regardless of sensitivity, the pixels are also arranged at intervals of one line. Therefore, it can be said that the pattern P2 is a Bayer array when attention is paid to only the colors of the pixels.

The third characteristic is that, when attention is paid to pixels having identical color and sensitivity, the pixels are arranged in a lattice shape, when attention is paid to pixels having identical sensitivity regardless of colors, the pixels are arranged in a lattice shape, and, when attention is paid to an arbitrary pixel, all colors included in the color/sensitivity mosaic pattern are included in colors of five pixels in total including the pixel and four pixels around the pixel. The fourth characteristic is that a color/sensitivity mosaic pattern has the third characteristic and, when attention is paid to pixels having identical sensitivity, the pixels are arranged in a Bayer array.

For example, in the color/sensitivity mosaic pattern P4 shown in FIG. 7, when attention is paid to only pixels having sensitivity S0, as it is evident in a state in which the figure is tilted 45 degrees, the pixels are arranged in a Bayer array at intervals of 2̂1/2. When attention is paid to only pixels having sensitivity S1, the pixels are arranged in a Bayer array at intervals of 2̂1/2.

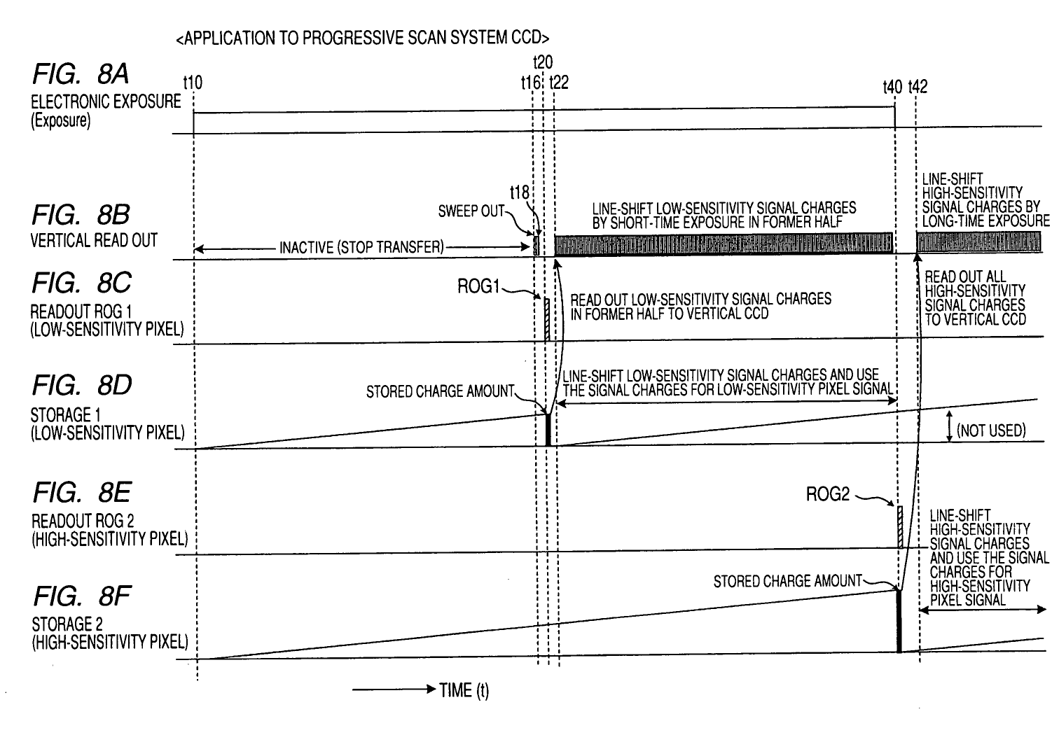

The color/sensitivity mosaic patterns P1, P2, and P4 having the first, second, and fourth characteristics are only examples of color/sensitivity mosaic patterns. It is possible to adopt various patterns (arrays) as shown in FIGS. 8 to 18 of WO2002/056603.

In the CCD solid-state imaging device 10, a color mosaic pattern of a color/sensitivity mosaic pattern is realized by arranging an on-chip color filter, which transmits only light of different colors for each of pixels, on an upper surface of the light-receiving elements (the sensor sections 11) of the CCD solid-state imaging device 10.

On the other hand, concerning a sensitivity mosaic pattern for obtaining high-sensitivity pixel signals and low-sensitivity pixel signals of the color/sensitivity mosaic pattern, in this embodiment, the acquisition of high-sensitivity pixel signals and low-sensitivity pixel signals according to control of exposure time using a difference in time for reading out signal charges from the charge generating sections to the vertical transfer sections, i.e., by using a difference in exposure time. In particular, this embodiment has a significant characteristic in performing control to solve the problem of a dark current that is caused because signal charges read out to the vertical transfer sections are retained without being transferred.

As an exposure control method for solving the problem, it is possible to adopt various forms according to which of the IL-CCD (or the FIT-CCD) and the CCD solid-state imaging device of the progressive scan system the CCD solid-state imaging device 10 in use is and according to whether the CCD solid-state imaging device 10 includes the mechanical shutter 52. The exposure control method is specifically explained below.

### An Electronic Method of Forming a Sensitivity Mosaic Pattern: First Embodiment

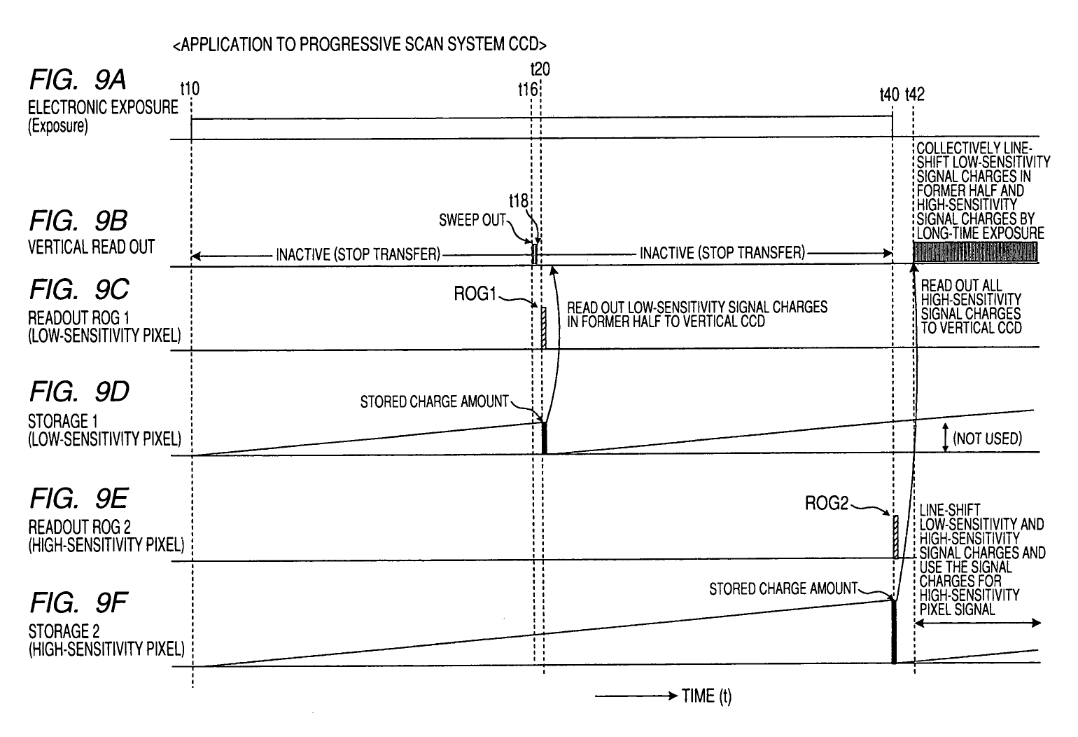

FIGS. 8A to 8F are diagrams for explaining driving control according to a first embodiment of the present invention for electronically realizing a sensitivity mosaic pattern while controlling generation of a dark current in the vertical CCDs 13. FIGS. 9A to 9F are diagram showing a modification to the driving control method according to the first embodiment. It is assumed that intensity of light received during an exposure operation does not change. The same holds true in other embodiments described later.

In the driving control methods according to the first embodiment and the modification of the first embodiment, the CCD solid-state imaging device of the progressive scan system shown in FIG. 4 is adopted as the CCD solid-sate imaging device 10 and the mechanical shutter 52 shown in FIG. 1 is not used. An applicable sensitivity mosaic pattern may be any one of the color/sensitivity mosaic patterns P1, P2, and P4 having the first, second, and fourth characteristics shown in FIGS. 5 to 7.

FIG. 8A and FIG. 9A show an electronic entire exposure period {i.e., a period from a point when a charge sweep-out pulse (an electronic shutter pulse) is supplied to a substrate to sweep out charges stored in the sensor sections 11 until a point when, after storage of signal charges in the sensor sections 11 is started, charges stored in the sensor sections 11 are finally read out to the vertical CCD 13}. A predetermined wavelength component of a visible light band (depending on a color component of the on-chip color filter) is made incident on the sensor sections 11 in an exposure period, photoelectric conversion is performed in the sensor sections 11, and signal charges are stored in the sensor sections 11. FIG. 8B and FIG. 9B show timing when a control voltage for instructing charge transfer is given to the vertical transfer electrodes 24.

FIG. 8C and FIG. 9C show timing of a pulse voltage for instructing sensor sections 11l for low-sensitivity pixel signals, to which short-time exposure is applied, to read out charges. FIG. 8D and FIG. 9D show a change in a charge amount stored in the sensor sections 11l for low-sensitivity pixel signals in response to the short-time exposure and the charge readout pulse voltage given.

FIG. 8E and FIG. 9E show timing of a pulse voltage for instructing sensor sections 11h for high-sensitivity pixel signals, to which long-time exposure is applied, to read out charges. FIG. 8F and FIG. 9F show a change in a charge amount stored in the sensor sections 11h for high-sensitivity pixel signals in response to the long-time exposure and the charge readout pulse voltage given.

Although not shown in the figure, a charge sweep-out pulse (an electronic shutter pulse) ΦVsub is also supplied in common to the sensor sections 11h for high-sensitivity pixel signals and the sensor sections 11l for low-sensitivity pixel signals of the CCD solid-state imaging device 10. The charge sweep-out pulse ΦVsub is supplied to sweep out (reset) charges from the respective sensor sections 11 in a predetermined period other than an electronic exposure period.

As the driving control methods according to the first embodiment and the modification to the first embodiment, it is possible to adopt a third method of, after reading out signal charges acquired in the sensor sections 11l for low-sensitivity pixel signals by the short-time exposure are read out to the vertical CCDs 13, further continuing storage of signal charges in the sensor sections 11h for high-sensitivity pixel signals and the sensor sections 11l for low-sensitivity pixel signals, after predetermined time, reading out signal charges acquired in the sensor sections 11h for high-sensitivity pixel signals by the long-time exposure to the vertical CCDs 13, and immediately transferring the read-out signal charges with the vertical CCDs 13.

In order to acquire the low-sensitivity pixel signals, an entire exposure period is divided into a former half and a latter half, signal charges are read out from at least the sensor sections 11l for low-sensitivity pixel signals to the vertical CCDs 13 in a boundary between the former half and the latter half of the entire exposure period, exposure is continued in the latter half of the entire exposure period, signal charges generated by the sensor sections 11h for high-sensitivity pixel signals are read out to the vertical CCDs 13 at final timing of the electronic entire exposure period, and the signal charges read out to the vertical CCDs 13 are transferred through the vertical CCDs 13. In this case, the driving control method is characterized in that, at least concerning the signal charges for the high-sensitivity pixel signals, every time the signal charges are read out to the vertical CCDs 13, charge transfer is performed without retaining the read-out signal charges in the vertical CCDs 13.

In a comparison with a fourth embodiment and a modification to the fourth embodiment, a first example of a fifth embodiment, and a second example of the fifth embodiment described later, the driving control method is characterized by acquiring the signal charges for the low-sensitivity pixel signals with short exposure and storage time in the former half of the entire exposure period. In a comparison with a first example of a sixth embodiment and a modification to the first example of the sixth embodiment and a second example of the sixth embodiment and a modification to the second example of the sixth embodiment described later, the driving control method has a characteristic in acquiring the signal charges for the high-sensitivity pixel signals with long exposure and storage time at a time at the end of the electronic entire exposure period.

A charge readout pulse voltage (readout ROG1) is supplied to the vertical transfer electrodes 24 (also serving as readout electrodes) corresponding to the sensor sections 11l for low-sensitivity pixel signals while exposure is continued at predetermined timing in the electronic entire exposure period (t10 to t40). In this way, signal charges acquired in the sensor sections 11l for low-sensitivity pixel signals by the short-time exposure are read out to the vertical CCDs 13 (t20).

Thereafter, storage of signal charges in the sensor sections 11h for high-sensitivity pixel signals and the sensor sections 11l for low-sensitivity pixel signals is further continued. At final timing t40 in the electronic entire exposure period (t10 to t40) after predetermined time, i.e., at the point t40 when electronic exposure is completed, a charge readout pulse voltage (readout ROG2) is supplied to the vertical transfer electrodes 24 (also serving as readout electrodes) corresponding to the sensor sections 11h for high-sensitivity pixel signals. In this way, signal charges acquired in the sensor sections 11h for high-sensitivity pixel signals by the long-time exposure are read out to the vertical CCD 13. The electronic exposure is completed at the point t40 when the signal charges are read out to the vertical CCD 13.

The driving control method according to the first embodiment shown in FIGS. 8A to 8F has a characteristic in adopting the first method of, in a part of a period (t20 to t40) or the entire period in which storage of signal charges is continued in the sensor sections 11h for high-sensitivity pixel signals and the sensor sections 11l for low-sensitivity pixel signals after t20 when the signal charges acquired in the sensor sections 11l for low-sensitivity pixel signals in the former half of the entire exposure period are read out to the vertical CCDs 13, line-shifting signal charges for the low-sensitivity pixel signals by the short-time exposure read out to the vertical CCDs 13 at the final timing of the former half of the entire exposure period to the horizontal CCD 15 side through the vertical CCDs 13 and using the signal charges as signal charges for the low-sensitivity pixel signals. In particular, in a comparison with a second embodiment and a modification to the second embodiment, the driving control method has a characteristic in line-shifting the signal charges for the low-sensitivity pixel signals in “a part of the latter half or the entire latter half” of the electronic entire exposure period.

Preferably, immediately before supplying the charge readout pulse voltage (the readout ROG1) to the vertical transfer electrodes 24 (also serving as readout electrodes) corresponding to the sensor sections 11l for low-sensitivity pixel signals (t16 to t18) in order to read out signal charges from the sensor sections 11l for low-sensitivity pixel signals to the vertical CCDs 13, it is advisable to sweep out charges due to a smear component, a dark current component, and the like generated in the vertical CCDs 13 during the exposure period (during signal charge storage in the sensor sections 11l for low-sensitivity pixel signals) to the outside of the CCD solid-state imaging device 10.

For that purpose, it is advisable to, for example, idly transfer the vertical CCDs 13 at high speed. Unlike line-shift of normal signal charges, since the charges are not used for an output signal, it is unnecessary to much worry about transfer efficiency and the like of the vertical CCDs 13. Therefore, the user does not have to much worry about the fall in amplitude, distortion of a waveform, and the like of a driving pulse for driving the vertical CCDs 13 and such high-speed transfer is possible. The signal charges are read out from the sensor sections 11l for low-sensitivity pixel signals to the vertical CCD 13 after a smear component, a dark current component, and the like generated in the vertical CCDs 13 during a short-time exposure period (during signal charge storage in the sensor sections 11l for low-sensitivity pixel signals) are swept out to the outside of the CCD solid-state imaging device 10. Therefore, smear is low, a dark current is low, and the problem of blooming can also be controlled. A dark current generated in the vertical CCDs 13 during a short-time exposure period (during signal charge storage in the sensor sections 11l for low-sensitivity pixel signals) does not change to a white dot (a dot defect).

In the case of the driving control method according to the first embodiment, it is necessary to complete a line-shift operation for all lines of low-sensitivity signal charges (signal charges for the low-sensitivity pixel signals) acquired by short-time exposure before timing t40 when high-sensitivity signal charges (signal charges for the high-sensitivity pixel signals) are read out from the sensor sections 11h for high-sensitivity pixel signals to the vertical CCDs 13.

For that purpose, it is possible to adopt a fourth method of starting a line-shift operation for signal charges by long-time exposure after a line-shift operation at normal speed for all lines of signal charges by short-time exposure. In this case, readout of signal charges by long-time exposure may not be able to be performed until line-shift operation for all lines of low-sensitivity signal charges (signal charges for the low-sensitivity pixel signals) acquired by short-time exposure is completed. As a result, time in the latter half of the entire exposure period in which storage of signal charges is continued in the sensor sections 11h for high-sensitivity pixel signals and the sensor sections 11l for low-sensitivity pixel signals after t20 when the signal charges acquired in the sensor sections 11l for low-sensitivity pixel signals are read out to the vertical CCDs 13 in the former half of the entire exposure period may not be able to be set shorter than time necessary for completing the line-shift operation at the normal speed for all the lines of the signal charges by the short-time exposure. Time until acquisition of all signals increases. Driving control timing shown in FIGS. 8A to 8F indicates the fourth method.

On the other hand, it is intended to reduce the time in the latter half of the entire exposure period in which storage of signal charges is continued in the sensor sections 11h for high-sensitivity pixel signals and the sensor sections 11l for low-sensitivity pixel signals after t20 when the signal charges acquired in the sensor sections 11l for low-sensitivity pixel signals are read out to the vertical CCDs 13 in the former half of the entire exposure period. In this case, it is also possible to adopt a fifth method of, by line-shifting, at speed higher than the normal speed, signal charges for all lines by short-time exposure read out from the sensor sections 11l for low-sensitivity pixel signals to the vertical CCDs 13 earlier, completing the line-shift operation for all the lines of the signal charges by the short-time exposure by the time when signal charges by long-time exposure are read out from the sensor sections 11h for high-sensitivity pixel signals to the vertical CCDs 13.

In order to line-shifting, at speed higher than the normal speed, the signal charges for all the lines by the short-time exposure read out from the sensor sections 11l for low-sensitivity pixel signals to the vertical CCDs 13 earlier, for example, it is possible to use a method of driving the horizontal CCD 15 at speed higher than usual.

It is also possible to use a method of arranging plural horizontal CCDs 15 and performing line-shift (vertical transfer) of plural lines in, for example, every horizontal blanking period.

It is also possible to reduce, by using the FIT-CCD as the CCD solid-state imaging device 10 and transferring signal charges read out to the vertical CCDs 13 in the vertical blanking period from the vertical CCDs 13 to the storage area 300 at high speed using the high-speed vertical transfer pulse ΦVV, the time in the latter half of the entire exposure period in which storage of signal charges is continued in the sensor sections 11h for high-sensitivity pixel signals and the sensor sections 11l for low-sensitivity pixel signals after t20 when the signal charges acquired in the sensor sections 11l for low-sensitivity pixel signals are read out to the vertical CCDs 13 in the former half of the entire exposure period.

In the first embodiment, the signal charges read out from the sensor sections 11l for low-sensitivity pixel signals to the vertical CCDs 13 at final timing t20 in the former half of the entire exposure period in the sensor sections 11l for low-sensitivity pixel signals are actually used low-sensitivity pixel signals. Therefore, a ratio Sratio of sensitivity of high-sensitivity pixels SHigh and sensitivity of low-sensitivity pixels Slow (=SHigh/Slow) is (t40−t10)/(t20−t10). It is possible to adjust the sensitivity ratio Sratio if the readout point t20 when the signal charges acquired in the sensor sections 11l for low-sensitivity pixel signals in the former half of the entire exposure period in the sensor sections 11l for low-sensitivity pixels are read out from the sensor sections 11l for low-sensitivity pixel signals to the vertical CCDs 13 is adjusted.

When such a driving control method according to the first embodiment is adopted, after performing exposure (short-time exposure) in predetermined time in the electronic entire exposure period (t10 to t40) and performing generation of signal charges in the sensor section 11l of low-sensitivity pixel signals, the signal charges are readout from the sensor sections 11l for low-sensitivity pixel signals to the vertical CCDs 13. Immediately after this, the signal charges are line-shifted (vertically transferred) to the horizontal CCD 15 side. Therefore, the exposure is not continued while the signal charges are stored in the vertical CCDs 123. Since the read-out signal charges for the low-sensitivity pixel signals are not stored in the vertical CCDs 13 and stopped from being transferred, the low-sensitivity pixel signals are low in a dark current. A dark current generated in the vertical CCDs 13 when the signal charges by the short-time exposure read out from the sensor sections 11l for low-sensitivity pixel signals to the vertical CCDs 13 are not vertically transferred are not generated. Therefore, a white dot (a dot defect) is not caused.

Since the signal charges read out from the sensor sections 11l for low-sensitivity pixel signals to the vertical CCDs 13 in the exposure period in the latter half of the electronic entire exposure period for acquisition of high-sensitivity pixel signals are line-shifted to the horizontal CCD 15 side, the signal charges read out from the sensor sections 11l for low-sensitivity pixel signals to the vertical CCDs 13 are not left stored in the vertical CCDS 13. Therefore, in the latter half of the electronic entire exposure period, the phenomenon in which charges of a dark current component, which is caused because the signal charges by the short-time exposure read out from the sensor sections 11l for low-sensitivity pixel signals to the vertical CCDs 13 are not vertically transferred, are superimposed on the signal charges by the short-time exposure does not occur.

Since the line-shift operation is immediately started for the signal charges read out from the sensor sections 11h for high-sensitivity pixel signals at the final timing t40 of the electronic entire exposure period (t42), signal charges for the high-sensitivity pixel signals acquired by long-time exposure are not stored in the vertical CCDs 13 either. Therefore, the high-sensitivity pixel signals are also low in a dark current. A dark current generated in the vertical CCDs 13 when the signal charges by the long-time exposure read out from the sensor sections 11h for high-sensitivity pixel signals to the vertical CCDs 13 are not vertically transferred are suppressed. Therefore, a white dot (a dot defect) is suppressed to be caused.

In the driving control method according to the first embodiment, both the signal charges by the short-time exposure and the signal charges by the long-time exposure read out from the sensor sections 11 are not stored in the vertical CCDs 13 and stopped from being transferred. Therefore, the effect of reduction in a dark current and a level and the number of white dots is extremely high.

In addition, a dark current generated in the vertical CCDs 13 does not change to a white dot (a dot defect).

However, in the driving control method according to the first embodiment, the signal charges by the short-time exposure are line-shifted to be transferred to the horizontal CCD 15 side and used as an output signal while the signal charges by the long-time exposure are stored in the sensor sections 11h for high-sensitivity pixel signals. Therefore, even if the mechanical shutter 52 is used as well, a vertical streak (i.e., a smear phenomenon) due to leakage of incident light to the vertical CCDs 13 in a high luminance portion can occur in the low-sensitivity pixel signals.

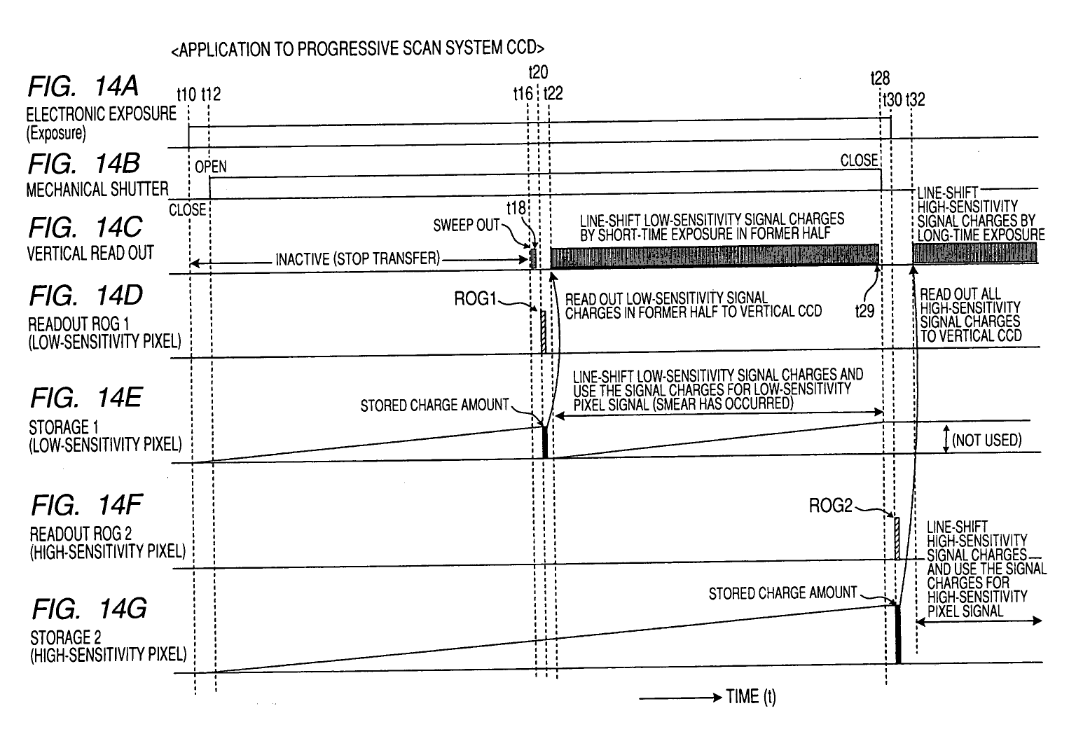

On the other hand, for the high-sensitivity pixel signals, it is unnecessary to continue exposure in the line-shift period (from t42 onward) for using signal charges for an output signal. Therefore, if the mechanical shutter 52 is used as well, line-shift can be performed in a state in which exposure is stopped. During the line-shift, no light is made incident on the CCD solid-state imaging device 10. In principle, it is possible to completely eliminate noise due to unnecessary charges such as a smear component caused by light made incident on the CCD solid-state imaging device 10 during the line-shift period (see FIGS. 14A to 14G referred to later).

### Modification to the First Embodiment

Concerning the driving control timing, it is also conceivable to carry out only the third method without carrying out the first method of line-shifting the signal charges for the low-sensitivity pixel signals, which are read out from the sensor sections 11l for low-sensitivity pixel signals to the vertical CCDs 13 earlier at the predetermined in the entire exposure period, to the horizontal CCD 15 for low-sensitivity pixel signals in “a part of the latter half or the entire latter half” of the electronic entire exposure period.

In this case, immediately after the final timing of the electronic entire exposure period, charge transfer of the signal charges for the low-sensitivity pixel signals read out earlier is started (t42). Since the CCD solid-state imaging device of the progressive scan system is used, as in FIGS. 9A to 9F showing a driving control method according to a modification to the first embodiment, signal charges are read out from the sensor sections 11h for high-sensitivity pixel signals to the vertical CCDs 13. The read-out signal charges for the high-sensitivity pixel signals are collectively line-shifted together with the signal charges for the low-sensitivity pixel signals read out earlier at the point t20 in the boundary between the former half and the latter half of the entire exposure period.

When such a driving control method according to the modification to the first embodiment is adopted, immediately after electronic exposure is completed by reading out the signal charges from the sensor sections 11h for high-sensitivity pixel signals to the vertical CCDs 13, the signal charges for the high-sensitivity pixel signals by the long-time exposure are read out to the vertical CCDs 13 and a line-shift operation for the signal charges is instantaneously started (t42). Therefore, at least the signal charges for the high-sensitivity pixel signals acquired by the long-time exposure are not left stored in the vertical CCDs 13. Consequently, the signal charges are low in a dark current and a dark current generated in the vertical CCDs 13 when the signal charges for the high-sensitivity pixel signals acquired by the long-time exposure are left stored in the vertical CCDs 13 are not generated. Therefore, a white dot (a dot defect) is not caused.

At the timing described in WO2002/056603 and JP-A-2004-172858, there is a period in which both the signal charges for the high-sensitivity pixel signals and low-sensitivity pixel signals read out to the vertical transfer sections are left stored in the vertical transfer sections (a period after the first readout). On the other hand, in the modification to the first embodiment, concerning at least the signal charges for the high-sensitivity pixel signals, when the signal charges are read out from the sensor sections 11h for high-sensitivity pixel signals to the vertical CCDs 13, the signal charges are not left retained in the vertical CCDs 13 and line-shift is instantaneously started. Therefore, the modification is different from the mechanisms disclosed in WO2002/056603 and JP-A-2004-172858 in that S/N of at least the high-sensitivity pixel signals can be further improved.

It is desirable to surely transfer the read-out signal charges for the high-sensitivity pixel signals without being retained in the charge transfer sections while allowing the read-out signal charges for the low-sensitivity pixel signals to be retained in the charge transfer sections. A reason for this is described below.

When combination processing by SVE for expanding a dynamic range is performed by properly using the acquired high-sensitivity pixel signals and low-sensitivity pixel signals, effectiveness judgment for judging whether the respective sensitivity pixel signals exceed a threshold and a pixel value of an ineffective pixel is interpolated by using pixel values of effective pixels near the pixel. Therefore, on a low-luminance side on which the high-sensitivity pixel signals have gradation and the low-sensitivity pixel signals tend to be buried in noise, there are a larger number of ineffective pixels when the low-sensitivity pixel signals are used. The number of pixels subjected to interpolation processing by using high-sensitivity pixel values increases.

Therefore, interpolation processing is applied to signal charges read out from the charge generating sections to the charge transfer sections to prevent the signal charges from being affected by the problem of the fall in S/N due to unnecessary charges such as a dark current and a dot defect caused by leaving the signal charges retained in the charge transfer sections. For this purpose, it is desirable to surely transfer, every time signal charges for the high-sensitivity pixel signals, with which the number of effective pixels increases, is read out from the charge generating sections, the signal charges to the charge transfer sections without retaining the signal charges in the charge transfer sections.

### Electronic Method of Forming a Sensitivity Mosaic Pattern; Second Embodiment

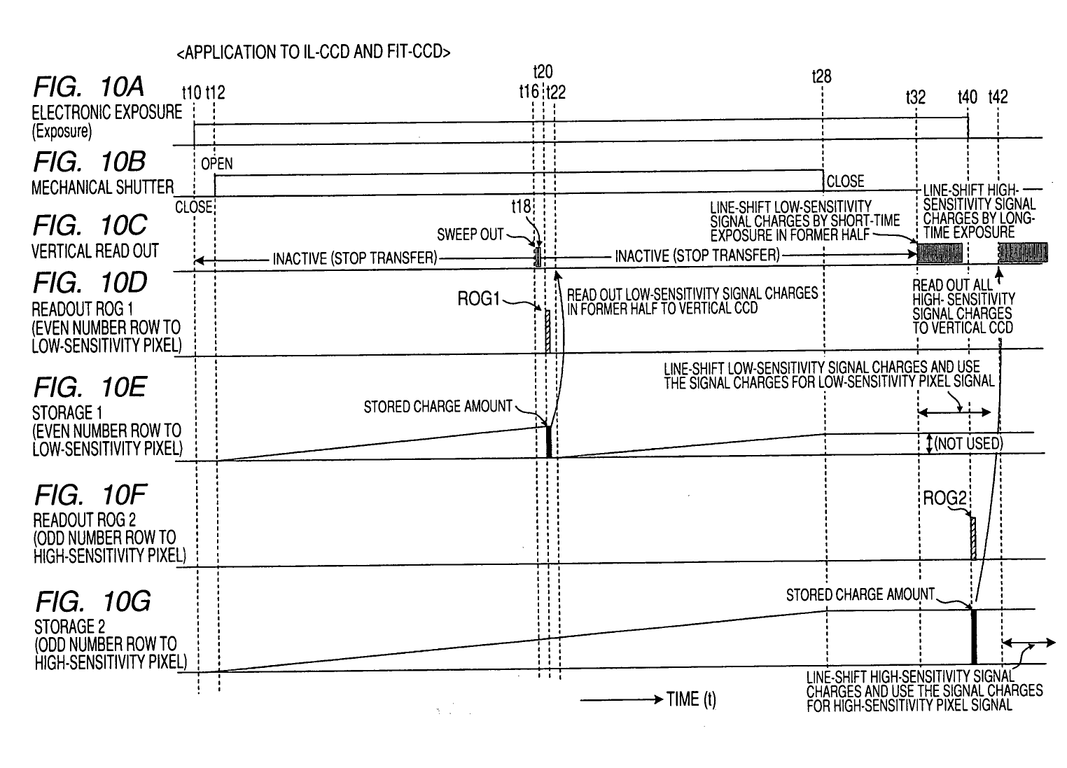

FIGS. 10A to 10G are diagrams for explaining driving control according to a second embodiment of the present invention for electronically realizing a sensitivity mosaic pattern while controlling generation of a dark current in the vertical CCDs 13. FIGS. 11A to 11G are diagrams showing a modification to a driving control method according to the second embodiment.

In a comparison with a fourth embodiment and a modification to the fourth embodiment, a first example of a fifth embodiment, and a second example of the fifth embodiment described later, the driving control methods according to the second embodiment and the modification to the second embodiment have a characteristic in performing signal charges for the low-sensitivity pixel signals with short exposure and storage time are acquired in a former half of an entire exposure period. The driving control methods also have a characteristic in using the mechanical shutter 52.

In the driving control method according to the second embodiment, the IL-CCD shown in FIG. 2 or the FIT-CCD shown in FIG. 3 in which the vertical transfer electrodes 24 also serving as readout electrodes are arranged for each of horizontal lines (for each of arrays) is adopted as the CCD solid-state imaging device 10 and the mechanical shutter 52 shown in FIG. 1 is used.

Basically, a so-called frame readout system is used. This is a system for using the mechanical shutter 52 to control incidence of visible light on the sensor sections 11 and control storage of signal charges in the sensor sections 11 and alternately reading out signal charges in odd number lines and even number lines to the vertical CCDs 13 for each of fields to transfer signal charges of respective pixels to the vertical CCDs 13 independently from each other.

In this case, the timing-signal generating unit 40 controls opening and closing of the mechanical shutter 52 in order to control incidence of visible light on the sensor sections 11. The timing-signal generating unit 40 also controls storage of signal charges in sensor sections 11o in odd number lines and sensor sections 11e in even number lines, read out of signal charges from the sensor sections 11 by even/odd number line to the vertical CCDs 13, and line-shift of the signal charges by even/odd number line read out to the vertical CCDs 13 by even/odd number line.

In the driving control methods according to the second embodiment and the modification to the second embodiment, charge storage time is controlled by even/odd number line. Therefore, an applicable sensitivity mosaic pattern is the color/sensitivity mosaic pattern P1 having the first characteristic shown in FIG. 5. In the color/sensitivity mosaic pattern P1, all odd number lines area lines of high-sensitivity pixels and all even number lines are lines of low-sensitivity pixels. In order to realize a sensitivity mosaic pattern in which sensitivity changes in each of horizontal lines, the timing-signal generating unit 40 only has to perform control to supply different readout pulses ROG1 and ROG2 for each of the horizontal lines, read out respective signal charges to the vertical CCDs 13 independently from each other, and transfer the signal charges read out to the vertical CCDs 13 to the horizontal CCD 15 side independently from each other through the vertical CCDs 13.

FIG. 10A and FIG. 11A show an electronic exposure period of the CCD solid-state imaging device 10. FIG. 10B and FIG. 11B show timing of a pulse voltage for instructing opening and closing of the mechanical shutter 52. A predetermined wavelength component of a visible light band (depending on a color component of the on-chip color filter) is made incident on the sensor sections 11 in an entire exposure period during which the mechanical shutter 52 is opened (i.e., a period in which light as an example of an electromagnetic wave can be made incident on the sensor sections 11), photoelectric conversion is performed in the sensor sections 11, and signal charges are stored in the sensor sections 11. FIG. 10C and FIG. 11C show timing when a control voltage for instructing charge transfer is given to the vertical transfer electrodes 24.

FIG. 10D and FIG. 11D show timing of a pulse voltage for instructing the sensor sections 11 in lines, to which short-time exposure is applied, among the odd number lines and the even number lines to read out charges. FIG. 10E and FIG. 11E show a change in a charge amount stored in the sensor sections 11 in response to the short-time exposure and the given charge readout pulse voltage.

FIG. 10F and FIG. 11F show timing of a pulse voltage for instructing the sensor sections 11 in lines, to which long-time exposure is applied, among the odd number lines and the even number lines to read out charges. FIG. 10G and FIG. 11G show a change in a charge amount stored in the sensor sections 11 in response to the long-time exposure and the given charge readout pulse voltage.

The driving control methods according to the second embodiment and the modification to the second embodiment have a characteristic in, after reading out signal charges acquired in the sensor sections 11l for low-sensitivity pixel signals by the short-time exposure in the former half of the entire exposure period to the vertical CCDs 13, not line-shifting the read-out signal charges for the low-sensitivity pixel signals after this readout in the first time, continuing storage of signal charges in the sensor sections 11h for high-sensitivity pixel signals and the sensor sections 11l for low-sensitivity pixel signals, reading out the signal charges generated by the sensor sections 11h for high-sensitivity pixel signals to the vertical CCDs 13 after the mechanical shutter 52 is closed, transferring the read-out signal charges to the vertical CCDs 13, and transferring the signal charges for the low-sensitivity pixel signals read out to the vertical CCDs 13 earlier through the vertical CCDs 13.

In the driving control method according to the second embodiment, the mechanical shutter 52 is closed when a predetermined entire exposure period ends and, after the mechanical shutter 52 is closed, the signal charges by the short-time exposure read out to the vertical CCDs 13 earlier are line-shifted through the vertical CCDs 13 and read out to the horizontal CCD 15 side. Thereafter, the signal charges acquired in the sensor sections 11h for high-sensitivity pixel signals by the long-time exposure are read out to the vertical CCDs 13 and line-shifted through the vertical CCDs 13.

First, by setting different control timing for the respective sensor sections 11o and 11e in the odd number lines and the even number lines, a stored charge amount read out from the sensor sections 11o in the odd number lines and a stored charge amount read out from the sensor sections 11e in the even number lines during the same exposure period (during storage of signal charges in the sensor sections 11) are set to be different.

When the color/sensitivity mosaic pattern P1 that assumes the first characteristic shown in FIG. 5 is used as the color/sensitivity mosaic pattern in the CCD solid-state imaging device 10, the odd number lines have a high-sensitivity pattern of two sensitivity patterns S0 and S1 and the even number lines have a low-sensitivity pattern of the two sensitivity patterns S0 and S1.

Therefore, FIG. 10D shows timing of a pulse voltage ROG1 for instructing the sensor sections 11l for low-sensitivity pixel signals, which have the low-sensitivity pattern of the two sensitivity patterns S0 and S1, to read out charges. FIG. 10E shows a change in a charge amount stored in the sensor sections 11l for low-sensitivity pixel signals in response to the instruction for opening the mechanical shutter 52 and the given charge readout pulse voltage ROG1.

FIG. 10F shows timing of a pulse voltage ROG2 for instructing the sensor sections 11h for high-sensitivity pixel signals, which have the high-sensitivity pattern of the two sensitivity patterns S0 and S1, to read out charges. FIG. 10G show a change in a charge amount stored in the sensor sections 11h for high-sensitivity pixel signals in response to the instruction for opening the mechanical shutter 52 and the given charge readout pulse voltage ROG2.

In this case, as it is seen from a comparison of FIG. 10E and FIG. 10G, when an identical image is imaged in identical exposure time (an opening period of the mechanical shutter 52; t12 to t28), a stored signal charge amount after the mechanical shutter 52 is closed is larger in the sensor sections 11h for high-sensitivity pixel signals shown in FIG. 10G than in the sensor sections 11l for low-sensitivity pixel signals shown in FIG. 10E. Therefore, the sensor sections 11h for high-sensitivity pixel signals have higher sensitivity. It goes without saying that it is possible to adjust an entire exposure amount by adjusting the opening period (t12 to t28) of the mechanical shutter 52.

As described above, high-sensitivity pixels and low-sensitivity pixels are arranged without being mixed in the respective sensor sections 11 in the odd number lines and the even number lines. Then, it is possible to set a stored charge amount read out from the sensor sections 11o in the odd number lines and a stored charge amount read out from the sensor sections 11e in the even number lines during the same exposure period (a period of storage of signal charges in the sensor sections 11), i.e., sensitivity different by setting different control timing for the sensor sections 11 in the respective lines.

The driving control unit 96 opens the mechanical shutter 52 in the predetermined period (t12 to t28) in the electronic entire exposure period (t10 to t40) to control the light L from the subject Z to be transmitted through the mechanical shutter 52 and the lens 54, adjusted by the aperture stop 56, and made incident on the CCD solid-state imaging device 10 at moderate brightness. Storage of signal charges in the sensor sections 11 is performed in a period in which the mechanical shutter 52 is opened. The driving control unit 96 closes the mechanical shutter 52 at the point t28 after the predetermined period elapses to stop storage of signal charges in the sensor sections 11.

As a charge transfer voltage, in periods other than a period t10 to t32, a waveform voltage for causing the sensor sections 11h for high-sensitivity pixel signals and the sensor sections 11l for low-sensitivity pixel signals to transfer charges to the vertical CCDs 13 (V registers) in common is supplied when necessary. However, in the period t10 to t32, the charge transfer voltage is not supplied to the vertical transfer electrodes 24 to stop the transfer of charges through the vertical CCDs 13.

In the second embodiment, a charge readout pulse voltage is supplied to the respective sensor sections 11 in the odd number lines and the even number lines at different timing. For example, the charge readout pulse voltage (readout ROG1) is supplied to the vertical transfer electrodes 24 (also serving as readout electrodes) corresponding to the sensor sections 11l for low-sensitivity pixel signals while exposure is continued at predetermined timing in the entire exposure period (t12 to t28). The signal charges acquired in the sensor sections 11l for low-sensitivity pixel signals by the short-time exposure are read out to the vertical CCDs 13 (t20).

Preferably, immediately before supplying the charge readout pulse voltage (readout ROG1) to the sensor sections 11e in the even number lines (t16 to t18), charges due to a dark current and the like generated in the vertical CCDs 13 in the exposure period (a period of storage of signal charges in the sensor sections 11l for low-sensitivity pixel signals) are swept out to the outside of the CCD solid-state imaging device 10. This is the same in the first embodiment and the modification to the first embodiment.

Thereafter, storage of signal charges in the sensor sections 11h for high-sensitivity pixel signals and the sensor sections 11l for low-sensitivity pixel signals is continued and, at the final timing of the electronic exposure period (t10 to t40) after predetermined time, the charge readout pulse voltage (readout ROG2) is supplied to the vertical transfer electrodes 24 (also serving as readout electrodes) corresponding to the sensor sections 11h for high-sensitivity pixel signals. The signal charges acquired in the sensor sections 11h for high-sensitivity pixel signals by the long-time exposure are read out to the vertical CCDs 13 (t40).

After the point t28 when the mechanical shutter 52 is closed, the signal charges by the short-time exposure read out to the vertical CCDs 13 are line-shifted through the vertical CCDs 13 and read out to the horizontal CCD 15 side. As a result, an image signal representing an image for one field including only low-sensitivity pixels in the even number lines is outputted from the charge-voltage converting unit 16. Thereafter, the signal charges acquired in the sensor sections 11h for high-sensitivity pixel signals by the long-time exposure are readout to the vertical CCDs 13 and line-shifted. As a result, an image signal representing an image for one field including only high-sensitivity pixels in the odd number lines is outputted from the charge-voltage converting unit 16.

The image for one field including only the high-sensitivity pixels in the odd number lines and the image for one field including only the low-sensitivity pixels in the even number lines can be acquired independently from each other. If the image for one field including only the high-sensitivity pixels in the odd number lines is combined with the image for one field including only the low-sensitivity pixels in the even number lines outputted earlier, a sensitivity mosaic image for one frame including the pixels in all the lines is obtained.

In the second embodiment, in the IL-CCD or the FIT-CCD, the mechanical shutter 52 is opened to simultaneously start exposure and storage in the respective sensor sections 11 in the odd number lines and the even number lines. After the predetermined time elapses, the signal charges are read out from the sensor sections 11 in one of the odd number lines and the even number lines to the vertical CCDs 13 while the mechanical shutter 52 is kept opened. After the predetermined time further elapses, when the mechanical shutter 52 is closed and the entire exposure period is completed, the signal charges are read out from the sensor sections 11 in the other of the odd number lines and the even number lines to the vertical CCDs 13. The respective read-out signal charges are transferred through the vertical CCDs 13 independently from each other. Since the signal charges in the odd number lines and the even number lines are alternately read out to the vertical CCDs 13 for each of the fields independently from each other and the read-out signal charges are transferred to the horizontal CCD 15 side through the vertical CCDs 13, it is possible to acquire signals of high-sensitivity pixels and signals of low-sensitivity pixels independently from each other. It goes without saying that, since an exposure and storage period is shorter in lines from which signal charges are read out from the sensor sections 11 to the vertical CCDs 13 earlier, pixels in the lines are low-sensitivity pixels.

In the second embodiment, as in the first embodiment, the signal charges read out from the sensor sections 11l for low-sensitivity pixel signals to the vertical CCDs 13 at the final timing t20 in the former half of the entire exposure period in the sensor sections 11l for low-sensitivity pixel signals are actually used as an output signal for low-sensitivity pixel signals. However, since the mechanical shutter 52 is used, light is actually made incident on the sensor sections 11h for high-sensitivity pixel signals and the sensor sections 11l for low-sensitivity pixel signals only at the period t12 to t28 when the mechanical shutter 52 is opened rather than the electronic exposure period t10 to t40. Therefore, a ratio Sratio of sensitivity of high-sensitivity pixels SHigh and sensitivity of low-sensitivity pixels Slow (=SHigh/Slow) is (t28−t12)/(t20−t12). It is possible to adjust the sensitivity ratio Sratio if the readout point t20 when the signal charges acquired in the sensor sections 11l for low-sensitivity pixel signals in the former half of the entire exposure period in the sensor sections 11l for low-sensitivity pixels are read out from the sensor sections 11l for low-sensitivity pixel signals to the vertical CCDs 13 is adjusted.

By using the mechanical shutter 52 as well, it is possible to realize SVE imaging even with the CCD solid-state imaging device of the interline transfer system or the frame interline transfer system other than the CCD solid-state imaging device of the progressive scan system. It is possible to refine a pixel size. Manufacturing cost for the CCD solid-state imaging device of the interline transfer system or the frame interline transfer system is low compared with that for the CCD solid-state imaging device of the progressive scan system. Therefore, it is possible to realize SVE imaging while reducing system cost. Further, since the mechanical shutter 52 is used, it is possible to enjoy an effect that smear does not occur in principle.

In the CCD solid-state imaging device of the progressive scan system, the number of saturated electrons is small compared with the imaging device of the interline system. On the other hand, it is possible to perform SVE imaging using, instead of the CCD solid-state imaging device of the progressive scan system, the imaging device of the interline system that is a general-purpose system with which manufacturing cost is low and the number of saturated signal electrons is larger than that in the progressive scan system in the same pixel size. In the interline system, there is also an advantage that refining of a pixel size is possible.

In the case of the driving control method according to the second embodiment, it is necessary to complete a line-shift operation for the signal charges acquired by the short-time exposure, i.e., all the lines of the sensor sections 11e in the even number lines including only the sensor sections 11l for low-sensitivity pixel signals before the timing t40 when high-sensitivity signal charges (signal charges for the high-sensitivity pixel signals) are read out from the sensor sections 11o in the odd number lines including only the sensor sections 11h for high-sensitivity pixel signals to the vertical CCDs 13.

For that purpose, it is possible to adopt the fourth method of completing a line-shift operation at normal speed for all lines of signal charges by short-time exposure and, then, starting a line-shift operation for signal charges by long-time exposure. In this case, readout of the signal charges by the long-time exposure may not be able to be performed until the line-shift operation for all the lines of the low-sensitivity signal charges (the signal charges for the low-sensitivity pixel signals) acquired by the short-time exposure. As a result, time until acquisition of all signals increases. Driving control timing shown in FIGS. 10A to 10G indicates the fourth method.

On the other hand, in order to reduce the time until acquisition of all signals, it is also possible to adopt a method of line-shifting signal charges for all lines by short-time exposure and long-time exposure at speed higher than the normal speed.

In order to line-shifting the signal charges for all the lines by the short-time exposure and the long-time exposure at the speed higher than the normal speed, it is possible to adopt a method of driving the horizontal CCD 15 at speed higher than usual or arranging the plural horizontal CCDs 15 and performing a line-shift operation for plural lines for, for example, each horizontal blanking period.

When such a driving method according to the second embodiment is adopted, the line-shift operation for the signal charges for the high-sensitivity pixel signals by the long-time exposure is started immediately after the electronic exposure is completed by reading out the signal charges from the sensor sections 11h for high-sensitivity pixel signals to the vertical CCDs 13 (t34). Therefore, at least the signal charges for the high-sensitivity pixel signals acquired by the long-time exposure are not left stored in the vertical CCDs 13. Consequently, the signal charges are low in a dark current and a dark current generated in the vertical CCDs 13 when the signal charges for the high-sensitivity pixel signals acquired by the long-time exposure are left stored in the vertical CCDs 13 are not generated. Therefore, a white dot (a dot defect) is not caused.

By using the mechanical shutter 52 as well, in a line-shift period in which the signal charges are transferred through the vertical CCDs 13 in the imaging area 14 (after the point t28 when the mechanical shutter 52 is closed), line-shift is performed in a state in which exposure is stopped. Therefore, while the line-shift is performed, no light is made incident on the CCD solid-state imaging device 10. In principle, it is possible to completely eliminate, for both the high-sensitivity pixel signals and the low-sensitivity pixel signals, noise caused by unnecessary charges such as a smear component due to light made incident on the CCD solid-state imaging device 10 during the light-shift period.

By using the mechanical shutter 52, since it is possible to realize SVE imaging using the IL-CCD or the FIT-CCD, it is possible to divert the CCD solid-state imaging device for the general digital still camera. Therefore, it is possible to use a CCD solid-state imaging device with a smaller pixel size and realize an increase in pixels at low cost.

By using the mechanical shutter 52 as well, it is possible to realize SVE imaging even with the IL-CCD or the FIT-CCD other than the CCD solid-state imaging device of the progressive scan system. It is possible to refine a pixel size. Manufacturing cost for the IL-CCD or the FIT-CCD is low compared with that for the CCD solid-state imaging device of the progressive scan system. Therefore, it is possible to realize SVE imaging while reducing system cost.

### Modification to the Second Embodiment

In the second embodiment, the IL-CCD or the FIT-CCD is adopted as the CCD solid-state imaging device 10. However, as shown in FIGS. 11A to 11G, it is also possible to use a CCD solid-state imaging device of the progressive scan system and using the mechanical shutter 52 and drive the CCD solid-state imaging device and the mechanical shutter 52 at the driving control timing according to the second embodiment.

In this case, as in the second embodiment, charge transfer of signal charges for the low-sensitivity pixel signals read out earlier is started after the mechanical shutter 52 is closed. Since the CCD solid-state imaging device of the progressive scan system is used, as in the modification to the first embodiment, after the mechanical shutter 52 is closed (t28), the signal charges are read out from the sensor section 11h for high-sensitivity pixel signals to the vertical CCDs 13 (t40). The read-out signal charges for the high-sensitivity pixel signals are collectively line-shifted together with the signal charges for the low-sensitivity pixel signals read out earlier at the point t20 that is the boundary between the former-half and the latter half of the entire exposure period (t42).

When such a driving control method according to a modification to the second embodiment is adopted, immediately after the electronic exposure is completed by reading out the signal charges from the sensor sections 11h for high-sensitivity pixel signals to the vertical CCDs 13, the signal charges for the high-sensitivity pixel signals by the long-time exposure are read out to the vertical CCDs 13 and the line-shift operation is instantaneously started (t42). Therefore, at least the signal charges for the high-sensitivity pixel signals acquired by the long-time exposure are not left stored in the vertical CCDs 13. Consequently, the signal charges are low in a dark current and a dark current generated in the vertical CCDs 13 when the signal charges for the high-sensitivity pixel signals acquired by the long-time exposure are left stored in the vertical CCDs 13 are not generated. Therefore, a white dot (a dot defect) is not caused.

In the second embodiment in which the IL-CCD or the FIT-CCD is adopted, since the mechanical shutter 52 is used, it is possible to enjoy an effect that smear does not occur in principle. However, an image for one field including only high-sensitivity pixels and an image for one field including only low-sensitivity pixels are outputted in order. Therefore, in order to obtain a sensitivity mosaic image for one frame including pixels of all the lines, it is necessary to combine the image for one field including only high sensitivity pixels and the image for one field including only low-sensitivity pixels.

On the other hand, in the modification to the second embodiment in which the CCD solid-state imaging device of the progressive scan system, by using the mechanical shutter 52, there is an advantage that it is possible to not only enjoy an effect that smear does not occur in principle but also obtain a sensitivity mosaic image for one frame including pixels of all lines by performing line-shift once.

### Electronic Method of Forming a Sensitivity Pattern; Third Embodiment

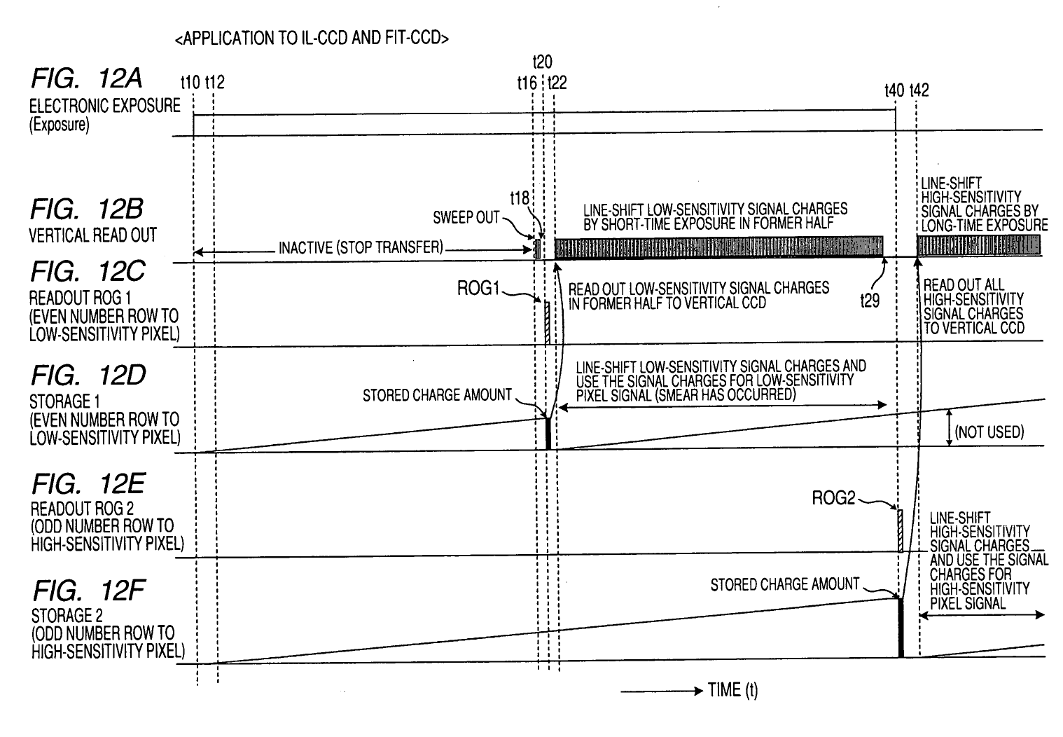

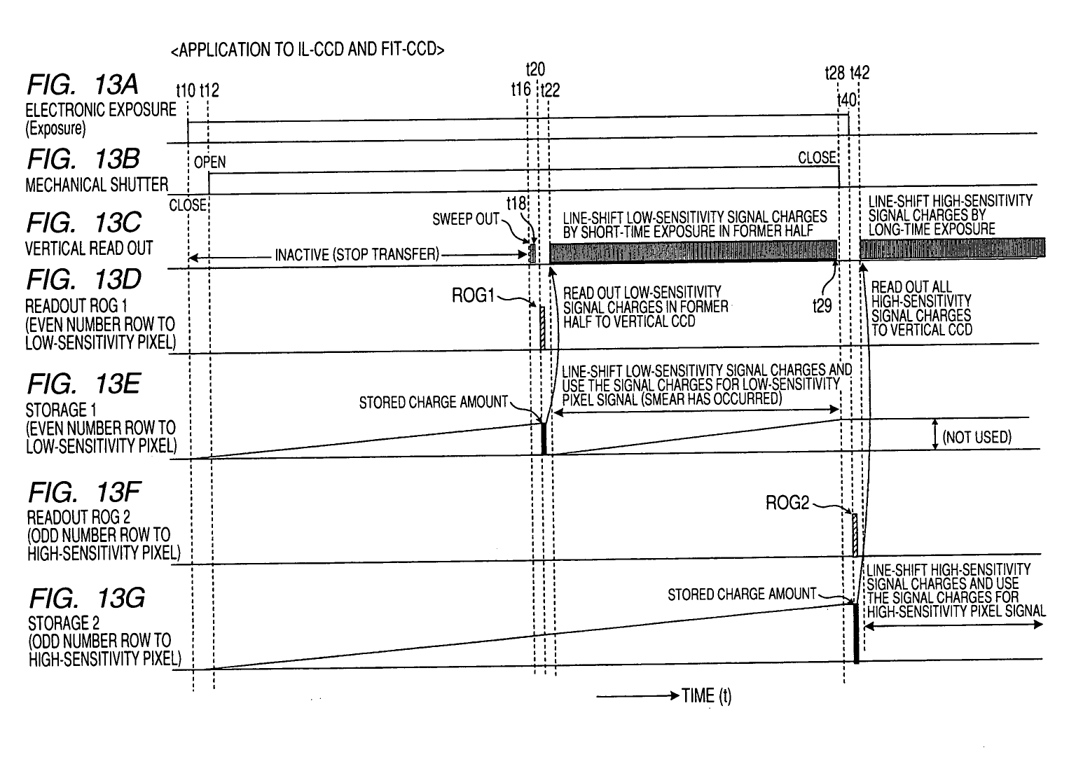

FIGS. 12A to 12F are diagrams for explaining driving control according to a third embodiment of the present invention for electronically realizing a sensitivity mosaic pattern while controlling generation of a dark current in the vertical CCDs 13. FIGS. 13A to 13G are diagrams for explaining a modification (a first example) to the driving control method according to the third embodiment. FIGS. 14A to 14G are diagrams for explaining a modification (a second example) to the driving control method according to the third embodiment.

A driving control method according to the third embodiment and the modification (the first example) to the third embodiment are modifications to the driving control methods according to the second embodiment and the modification to the second embodiment. In the third embodiment and the modification (the first example), timing of a line-shift operation for all lines by short-time exposure read out from the sensor sections 11l for low-sensitivity pixel signals to the vertical CCDs 13 earlier is different from those in the second embodiment and the modification to the second embodiment.

Basically, the driving control method according to the third embodiment and the modification (the first example) to the third embodiment has a characteristic in realizing, using the IL-CCD or the FIT-CCD, the mechanism according to the first embodiment for, after reading out signal charges acquired in the sensor sections 11l for low-sensitivity pixel signals by short-time exposure to the vertical CCDs 13, continuing storage of signal charges in the sensor sections 11h for high-sensitivity pixel signals and the sensor section 11l for low-sensitivity pixel signals while line-shifting the read-out signal charges for the low-sensitivity pixel signals and, after predetermined time, reading out signal charges acquired in the sensor sections 11h for high-sensitivity pixel signals by long-time exposure to the vertical CCDs 13.

In the third embodiment and the modification (the first example) to the third embodiment, upon reading out the signal charges by the short-time exposure to the vertical CCDs 13, the read-out signal charges are line-shifted at normal speed. In other words, while the storage of signal charges by the long-time exposure is continued in the sensor sections 11h for high-sensitivity pixel signals, after the signal charges by the short-time exposure are read out from the sensor sections 11l for low-sensitivity pixel signals to the vertical CCDs 13, the signal charges by the short-time exposure read out to the vertical CCDs 13 are line-shifted and transferred the horizontal CCD 15 side.

In this case, it is possible to use a sixth method of setting a completion point of a line-shift operation for all lines of the signal charges by the short-time exposure before the completion point t40 of the electronic exposure without using the mechanical shutter 52. Driving control timing shown in FIGS. 12A to 12F indicates the sixth method.

It is also possible to adopt a seventh method of setting a completion point of a line-shift operation for all lines of the signal charges by the short-time exposure before the point (a substantial exposure completion point) t28 when the mechanical shutter 52 is closed. Driving control timing shown in FIGS. 13A to 13G indicates the seventh method.

When line-shift for the signal charges by the short-time exposure is performed by applying the driving control methods according the third embodiment and the modification (the first example) to the third embodiment, the signal charges acquired by the short-time exposure are not left stored in the vertical CCDs 13. Consequently, the signal charges are low in a dark current and a dark current generated in the vertical CCDs 13 when the signal charges for the low-sensitivity pixel signals acquired by the short-time exposure are left stored in the vertical CCDs 13 are not generated. Therefore, a white dot (a dot defect) is not caused.

In the driving control methods according to the third embodiment and the modification (the first example) to the third embodiment, as in the driving control method according to the first embodiment, both the signal charges by the short-time exposure and the signal charges by the long-time exposure are not stored in the vertical CCDs 13 and stopped from being transferred. Therefore, the effect of reduction in a dark current and a level and the number of white dots is extremely high.

In addition, in the third embodiment and the modification (the first example) to the third embodiment, since the IL-CCD or the FIT-CCD is used, it is possible to divert the CCD solid-state imaging device for the general digital still camera. Therefore, it is possible to use a CCD solid-state imaging device with a smaller pixel size and realize an increase in pixels at low cost compared with the first embodiment and the modification to the first embodiment in which the CCD solid-state imaging device of the progressive scan system is adopted.

When the seventh method shown in FIGS. 13A to 13G is adopted, upon reading out the signal charges for the low-sensitivity pixel signals acquired in the former half of the entire exposure period, the signal charges are line-shifted. Therefore, it is possible to reduce a period from a point when the mechanical shutter 52 is closed until the point t40 when the electronic exposure period is finished compared with the second embodiment shown in FIGS. 10A to 10G. As a result, it is possible to reduce time until acquisition of all signals.

However, in the driving control method according to the third embodiment and the modification (the first example) to the third embodiment, while the signal charges are continuously stored in the sensor sections 11h for high-sensitivity pixel signals, the signal charges for the low-sensitivity pixel signals acquired in the former half of the entire exposure period are line-shifted and transferred to the horizontal CCD 15 side and the signal charges are used as an output signal. Therefore, noise due to unnecessary charges such as a smear component that conspicuously appear in the IL-CCD or the FIT-CCD can pose a problem.

On the other hand, concerning the high-sensitivity pixel signals, when the sixth method shown in FIGS. 12A to 12F is adopted, since the mechanical shutter 52 is not used, noise due to unnecessary charges such as a smear component that conspicuously appear in the IL-CCD or the FIT-CCD can pose a problem. However, when the seventh method shown in FIGS. 13A to 13G is adopted, since the mechanical shutter 52 is used as well, in the line-shift period (from t42 onward) for using the signal charges for an output signal, line-shift is performed in a state in which exposure is stopped. Therefore, during a period of the line-shift, no light is made incident on the CCD solid-state imaging device 10. In principle, it is possible to completely eliminate noise caused by unnecessary charges such as a smear component due to light made incident on the CCD solid-state imaging device 10 during the line-shift period.

In the third embodiment and the modification (the first example) to the third embodiment, the IL-CCD or the FIT-CCD is adopted as the CCD solid-state imaging device 10. However, as in a modification (a second example) to the third embodiment, it is also possible to use the CCD solid-state imaging device of the progressive scan system and the mechanical shutter 52 and drive the CCD-solid state imaging device and the mechanical shutter 52 at the driving control timing according to the third embodiment and the modification (the first example) to the third embodiment. As it is seen from a comparison with FIGS. 8A to 8F, with a basic driving control method not different from the first embodiment, since the mechanical shutter 52 is used, concerning the high-sensitivity pixel signals, it is possible to completely eliminate noise caused by unnecessary charges such as a smear component due to light made incident on the CCD solid-state imaging device 10 during the line-shift period.

### An Electronic Method of Forming a Sensitivity Mosaic Pattern; Fourth Embodiment

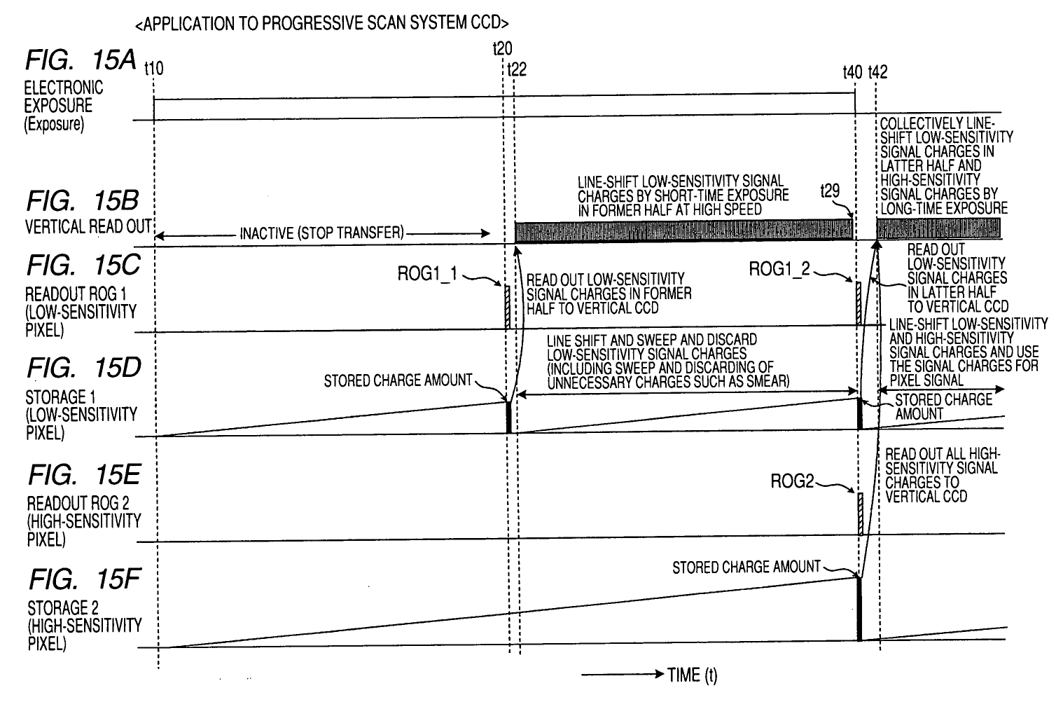

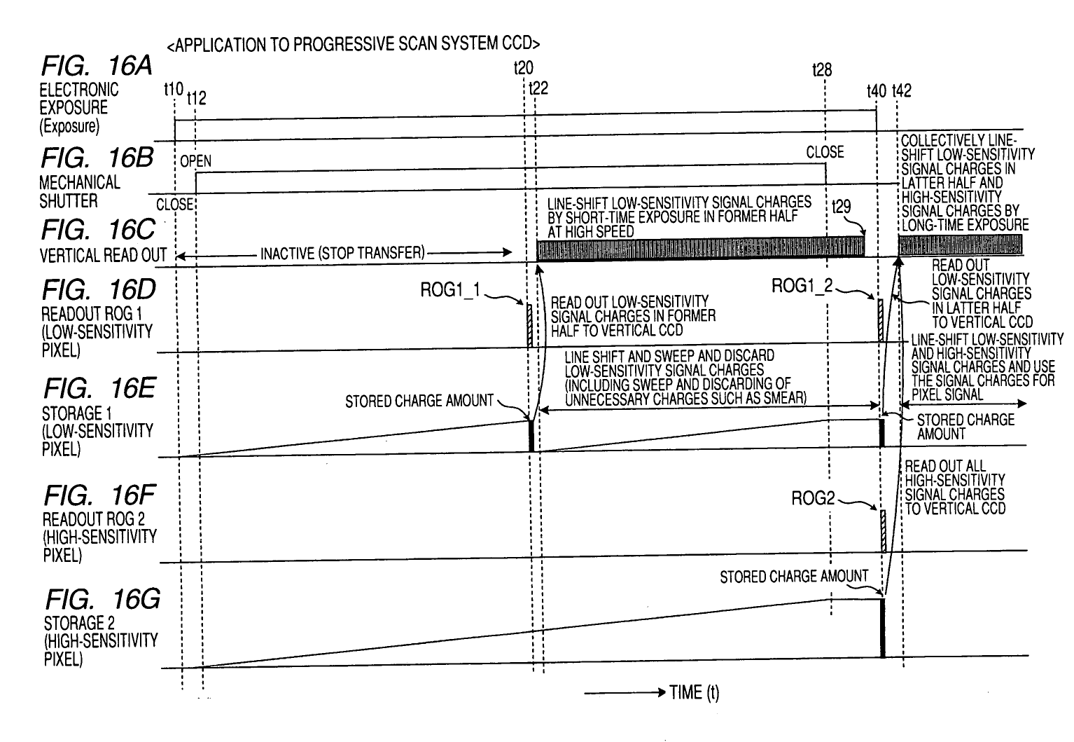

FIGS. 15A to 15F are diagrams for explaining driving control according to a fourth embodiment of the present invention for electronically realizing a sensitivity mosaic pattern while controlling generation of a dark current in the vertical CCDs 13. FIGS. 16A to 16G are diagrams for explaining a modification to a driving control method according to the fourth embodiment in which the mechanical shutter 52 is used as well.

Driving control methods according to the fourth embodiment and the modification to the fourth embodiment are modifications to the driving control methods according to the first to third embodiments and the modifications to the first to third embodiments. The driving control methods have a characteristic in performing acquisition of signal charges for the low-sensitivity pixel signals with short exposure and storage time in the latter half of the entire exposure period.

In the driving control methods according to the fourth embodiment shown in FIGS. 15A to 15F and the modification to the fourth embodiment shown in FIGS. 16A to 16G, the CCD solid-state imaging device of the progressive scan system shown in FIG. 4 is adopted. An applicable sensitivity mosaic pattern may be any one of the color and sensitivity mosaic patterns P1, P2, and P4 having the first, second, and fourth characteristics shown in FIGS. 5 to 7.

In the driving control methods according to the fourth embodiment and the modification to the fourth embodiment, signal charges acquired in the former half of the entire exposure period in the sensor sections 11l for acquiring low-sensitivity pixel signals are swept out to the outside of the CCD solid-state imaging device 10 before signal charges acquired in the latter half of the entire exposure period are read out to the vertical CCDs 13. “Swept out” means that charges line-shifted to the horizontal CCD 15 side are not used for an output signal.

The sweep-out is performed by generating a readout pulse ROG1_1 for short-time exposure signals (low-sensitivity pixel signals), reading out signal charges acquired in the former half of the entire exposure period by the sensor sections 11l for low-sensitivity pixel signals to the vertical CCDs 13 (t20), and, for example, transferring the read-out signal charges through the vertical CCDs 13 at speed higher than the normal speed. Unlike the line-shift for the normal signal charges, since the charges are not used for an output signal, it is unnecessary to much worry about transfer efficiency and the like of the vertical CCDs 13. Therefore, the user does not have to much worry about the fall in amplitude, distortion of a waveform, and the like of a driving pulse for driving the vertical CCDs 13 and such high-speed transfer is possible.

The signal charges for short-time exposure signal are read out to the vertical CCDs 13 (t20), thereafter, storage of signal charges in the sensor sections 11h for high-sensitivity pixel signals and the sensor sections 11l for low-sensitivity pixel signals is continued, and, during storage of signal charges, the signal charges for short-time exposure signals read out to the vertical CCDs 13 earlier are swept out to the outside of the vertical CCDs 13 (i.e., the CCD solid-state imaging device 10 (t22 to 29). This sweep-out operation includes sweep-out of unnecessary charges such as a smear component.

After the point t40 when the electronic entire exposure period ends, the signal charges acquired in the sensor sections 11h for high-sensitivity pixel signals and the signal charges acquired in the sensor sections 11l for low-sensitivity pixel signals are read out to the vertical CCDs 13 and line-shifted.

In the line-shift, in the driving control methods according to the fourth embodiment shown in FIGS. 15A to 15F and the modification to the fourth embodiment shown in FIGS. 16A to 16G, the CCD solid-state imaging device of the progressive scan system is used. Therefore, it is sufficient to simultaneously generate a readout pulse ROG1_2 for short-time exposure signals (low-sensitivity pixel signals) and the pulse ROG2 for long-time exposure signals (high-sensitivity pixel signals) and simultaneously read out the respective signal charges to the vertical CCDs 13 (t40). Consequently, it is possible to simultaneously line-shift the signal charges for short-time exposure signals and the signal charges for long-time exposure signals read out to the vertical CCDs 13 (from t42 onward). As a result, a sensitivity mosaic image for one frame including pixels in all the lines is obtained.

In the fourth embodiment and the modification to the fourth embodiment, the signal charges read out from the sensor sections 11l for low-sensitivity pixel signals to the vertical CCDs 13 at the final timing t40 of the electronic entire exposure period are actually used for an output signal for low-sensitivity pixel signals. Therefore, a ratio Sratio of sensitivity of high-sensitivity pixels SHigh and sensitivity of low-sensitivity pixels Slow (=SHigh/Slow) is (t40−t10)/(t40−t20). It is possible to adjust the sensitivity ratio Sratio if the readout point t20 when the signal charges acquired in the sensor sections 11l for low-sensitivity pixel signals in the former half of the entire exposure period in the sensor sections 11l for low-sensitivity pixels are read out from the sensor sections 11l for low-sensitivity pixel signals to the vertical CCDs 13 is adjusted.

As describe above, in the driving control methods according, to the fourth embodiment and the modification to the fourth embodiment, the signal charges acquired in the former half of the entire exposure and storage period in the sensor sections 11l for acquiring low-sensitivity pixel signals are swept out to the outside of the CCD solid-state imaging device 10 before the signal charges acquired in the latter half of the entire exposure and storage period are read out to the vertical CCDs 13. The signal charges for the high-sensitivity pixel signals and the signal charges for the low-sensitivity pixel signals are read out to the vertical CCDs 13 at the final timing t40 of the electronic entire exposure period and collectively line-shifted.

Consequently, as in the driving control methods according to the first and third embodiment, the modification (the first example) to the third embodiment, and the modification (the second example) to the third embodiment, concerning both the signal charges for the high-sensitivity pixel signals by the long-time exposure and the signal charges for the low-sensitivity pixel signals by the short-time exposure, read-out signal charges are not retained in the vertical CCDs 13 and stopped from being transferred. Therefore, an effect of a reduction in a dark current is extremely high. It goes without saying that, concerning both the signal charges for the high-sensitivity pixel signals by the long-time exposure and the signal charges for the low-sensitivity pixel signals by the short-time exposure, since a dark current generated in the vertical CCDs 13 when the read-out signal charges are left stored in the vertical CCDs 13 are not generated, a white dot (a dot defect) is not caused.

Even when the CCD solid-state imaging device is used as the CCD solid-state imaging device 10, as in the modification to the fourth embodiment shown in FIGS. 16A to 16G, if the mechanical shutter 52 is used as well, the signal charges for the high-sensitivity pixel signals and low-sensitivity pixel signals are read out to the vertical CCDs 13 and line-shifted in a state in which the mechanical shutter 52 is closed to stop exposure. Therefore, no light is made incident on the CCD solid-state imaging device 10 at least during the line-shift. In principle, it is possible to completely eliminate, for both the high-sensitivity pixel signals and the low-sensitivity pixel signals, noise caused by unnecessary charges such as a smear component due to light made incident on the CCD solid-state imaging device 10 during the light-shift period. The signal charges acquired in the former half of the entire exposure period in the sensor sections 11l for acquiring low-sensitivity pixel signals are swept out to the outside of the CCD solid-state imaging device 10 together with unnecessary charges such as a smear component and a dark current component generated in the vertical CCDs 13 before signal charges acquired in the latter half of the entire exposure period are read out to the vertical CCDs 13 (t22 to t29). Therefore, smear is low, a dark current is low, and a dark current generated in the vertical CCDs 13 during the electronic entire exposure period does not change to a white dot (a dot defect).

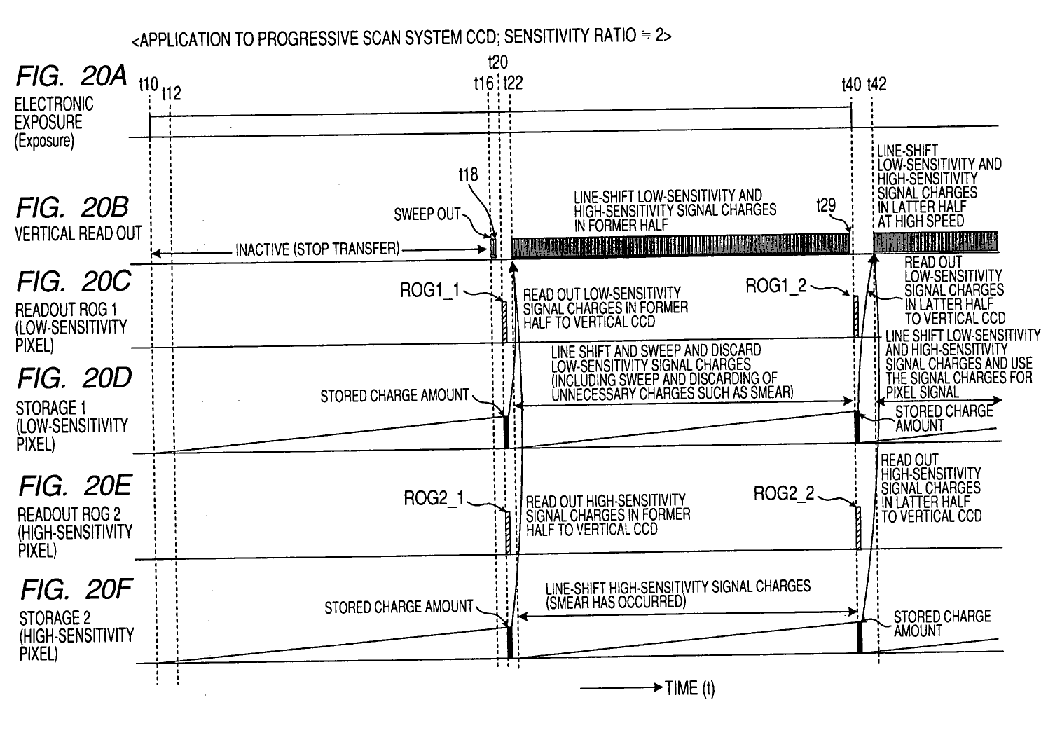

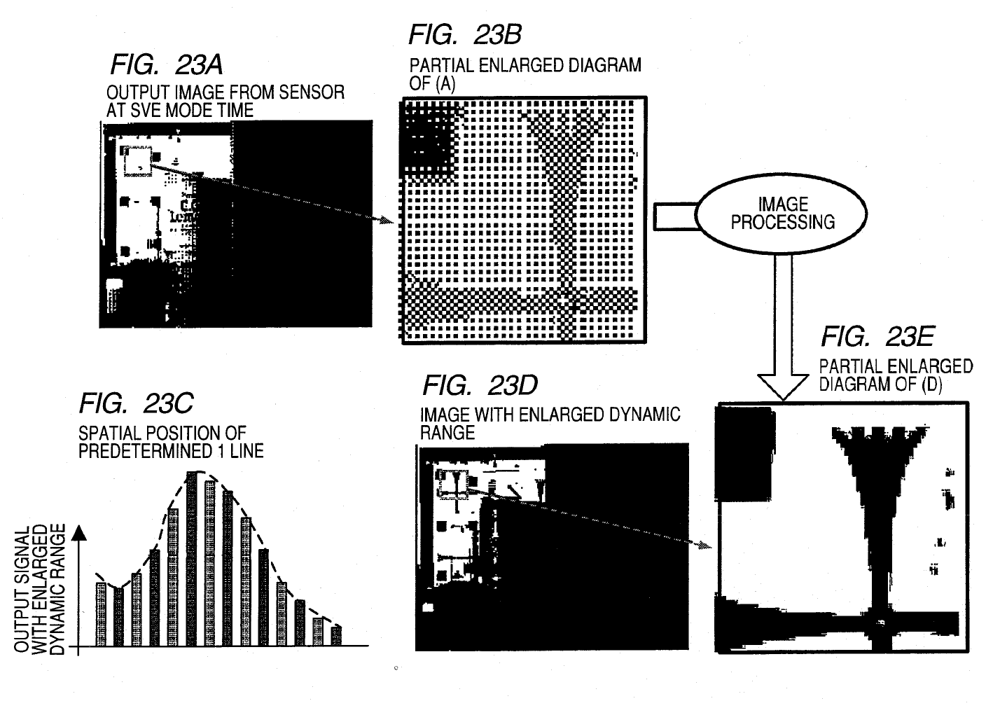

The method of sweeping out the signal charges acquired in the former half of the entire exposure and storage period in the sensor section 11l for acquiring low-sensitivity pixels signals to the outside of the CCD solid-state imaging device 10 before reading out the signal charges acquired in the latter half of the entire exposure and storage period as in the fourth embodiment and the modification to the fourth embodiment can be applied to the timing shown in FIG. 23 of WO2002/056603. The effect of a reduction in a dark current and a level and the number of white dots can be enjoyed. In this case, the high-sensitivity pixel signals are line-shifted every time the signal charges acquired in the former half and the latter half of the entire exposure period are read out. Therefore, the mechanism is the same as a mechanism according to a sixth embodiment of the present invention described later (see FIGS. 20A to 20F referred to later).

### Electronic Method of Forming a Sensitivity Mosaic Pattern; Fifth Embodiment

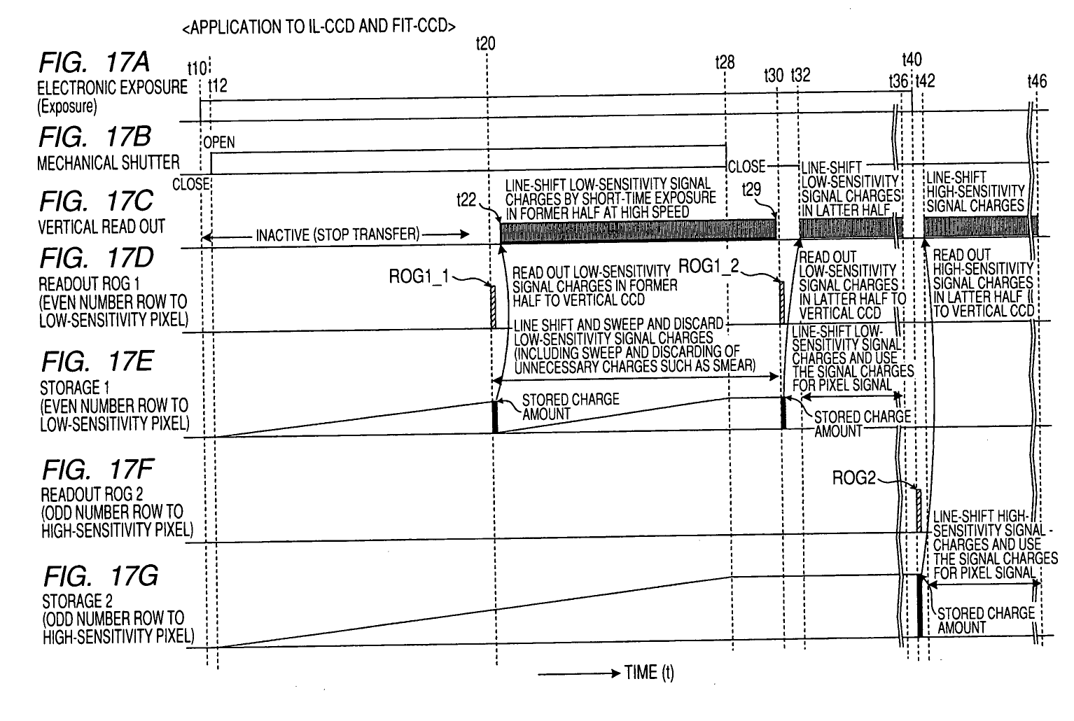

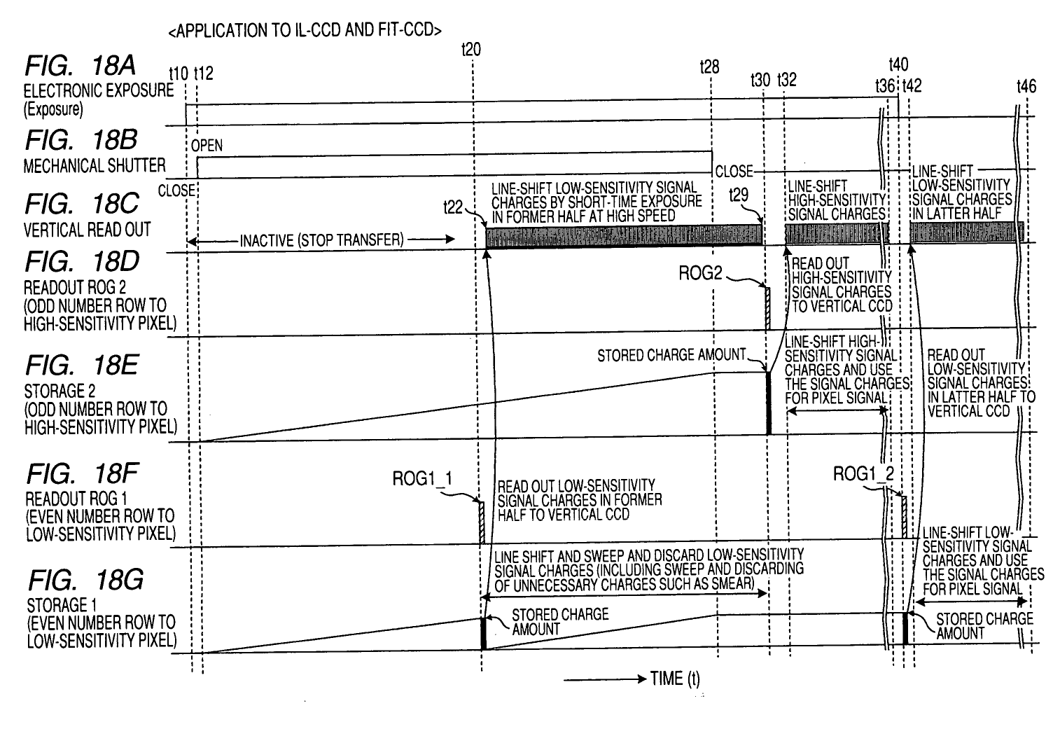

FIGS. 17A to 17G are diagrams for explaining driving control according to a first example of a fifth embodiment according to the present invention for electronically realizing a sensitivity mosaic pattern while controlling generation of a dark current in the vertical CCDs 13. FIGS. 18A to 18E are diagrams for explaining driving control according to a second example of the fifth embodiment for electronically realizing a sensitivity mosaic pattern while controlling generation of a dark current in the vertical CCDs 13.

Driving control methods according to the first example of the fifth embodiment and the second example of the fifth embodiment have a characteristic in realizing, using the IL-CCD or the FIT-CCD, the mechanism according to the fourth embodiment and the modification to the fourth embodiment for sweeping out the signal charges acquired in the former half of the entire exposure and storage period in the sensor sections 11l for acquiring low-sensitivity pixel signals to the outside of the CCD solid-state imaging device 10 before reading out the signal charges acquired in the latter half of the entire exposure and storage period to the vertical CCDs 13.

In the driving control methods according to the first example of the fifth embodiment and the second example of the fifth embodiment, the IL-CCD shown in FIG. 2 or the FIT-CCD shown in FIG. 3 is adopted as the CCD-solid state imaging device 10 and the mechanical shutter 52 shown in FIG. 1 is used. An applicable sensitivity mosaic pattern is the color and sensitivity mosaic pattern P1 having the first characteristic shown in FIG. 5.

In the driving control methods according to the first example of the fifth embodiment and the second example of the fifth embodiment, the mechanical shutter 52 is opened (t12), first, the signal charges acquired in the sensor sections 11l for short-time exposure signals (low-sensitivity pixel signals) in the former half of the entire exposure and storage period are read out to the vertical CCDs 13 (t20), thereafter, storage of signal charges in the sensor sections 11h for high-sensitivity pixel signals and the sensor sections 11l for low-sensitivity pixel signals is continued, and, during storage of signal charges, the signal charges for short-time exposure signals read out to the vertical CCDs 13 earlier are swept out to the outside of the vertical CCDs 13 (i.e., the CCD solid-state imaging device 10) (t22 to t29). This sweep-out operation includes sweep-out of unnecessary charges such as a smear component.

The mechanical shutter 52 is closed (t28). After the point when the sweep-out of the signal charges acquired in the sensor sections 11l for short-time exposure signals (low-sensitivity pixel signals) in the former half of the entire exposure and storage period, which are read out to the vertical CCDs 13 earlier in a state in which exposure is stopped, to the outside of the vertical CCDs 13 (i.e., the CCD solid-state imaging device 10) is completed, the signal charges acquired in the sensor sections 11h for long-time exposure signals (high-sensitivity pixel signals) and the signal charges acquired in the sensor sections 11l for short-time exposure signals (low-sensitivity pixel signals) are read out to the vertical CCDs 13 and line-shifted in the vertical CCDs 13 in predetermined order.

Even after the point t20 when the signal charges acquired in the sensor sections 11l for low-sensitivity pixel signals in the former half of the entire exposure and storage period in the sensor sections 11l for low-sensitivity pixel signals are read out to the vertical CCDs 13, the mechanical shutter 52 is continuously opened. While storage in the sensor sections 11h for high-sensitivity pixel signals and the sensor section 11l for low-sensitivity pixel sections is continued, the signal charges read out from the sensor sections 11l for low-sensitivity pixel signals to the vertical CCDs 13 in the first time and actually not used are swept out to the outside of the CCD solid-state imaging device 10 by line-shift. Thereafter, signal charges for long-time exposure signals read out for the first time in a state in which the mechanical shutter 52 is closed and exposure is stopped and signal charges for short-time exposure signals read out in the second time are read out from the sensor sections 11h for high-sensitivity pixel signals and the sensor sections 11l for low-sensitivity pixel signals to the vertical CCDs 13 in order in predetermined order and line-shifted in the vertical CCDs 13.

In the line-shift, in the driving control methods according to the first example of the fifth embodiment and the second example of the fifth embodiment, the IL-CCD or the FIT-CCD is used. Therefore, the respective signal charges are read out to the vertical CCDs 13 independently from each other by adopting the frame readout system and the read-out signal charges are alternately transferred through the vertical CCDs 13 independently from each other. In other words, the signal charges in the odd number lines and the even number lines are alternately read out to the vertical CCDs 13 for each of the fields independently from each other and transferred to the horizontal CCD 15 side through the vertical CCDs 13. Consequently, the high-sensitivity pixel signals and the low-sensitivity pixel signals are acquired independently from each other. If an image for one field including only pixels of lines outputted later is combined with an image for one field including pixels of lines outputted earlier, a sensitivity mosaic image for one frame including the pixels of all the lines is obtained. It can be arbitrarily set which of the signal charges for the high-sensitivity pixel signals and the signal charges for the low-sensitivity pixel signals are read out to the vertical CCDs 13 first.

For example, as in the first example of the fifth embodiment shown in FIGS. 17A to 17G, when the signal charges are read out from the sensor sections 11l for low-sensitivity pixel signals to the vertical CCDs 13 earlier and line-shifted, the mechanical shutter 52 is closed (t28) and, at predetermined timing t30 (t30: or timing immediately after the point t28 when the mechanical shutter 52 is closed), the charge readout pulse voltage (readout ROG1_2) for low-sensitivity pixel signal readout is supplied to the vertical transfer electrodes 24 (also serving as readout electrodes) corresponding to the sensor sections 11e in the even number lines having the sensor sections 11l for low-sensitivity pixel signals. In this way, the signal charges are read out from the sensor sections 11e in the even number lines (the sensor sections 11l for low-sensitivity pixel signals) to the vertical CCDs 13 at once. Thereafter, the signal charges in the even number lines are transferred (line-shifted) to the horizontal CCD 15 side through the vertical CCDs 13 in order (t32 to t36). As a result, an imaging signal representing an image for one field including only pixels in the even number lines is outputted from the charge-voltage converting unit 16. At the point t30 when the signal charges are read out from the sensor sections 11e to the vertical CCDs 13, the electronic exposure has not been completed yet.

After the point t36 when line-shift of all the signal charges read out from the sensor sections 11e in the even number lines to the vertical CCDs 13 is completed, the charge readout pulse voltage (readout ROG2) for high-sensitivity pixel signal readout is supplied to the vertical transfer electrodes 24 (also serving as readout electrodes) corresponding to the sensor sections 11o in the odd number lines having the sensor sections 11h for high-sensitivity pixel signals. In this way, the signal charges are read out from the sensor sections 11o in the odd number lines (the sensor sections 11h for high-sensitivity pixel signals) to the vertical CCDs 13 at once (t40: or immediately after t36). Thereafter, the signal charges in the odd number lines are transferred (line-shifted) to the horizontal CCD 15 side through the vertical CCDs 13 in order (t42 to t46). As a result, an imaging signal representing an image for one field including only pixels in the odd number lines is outputted from the charge-voltage converting unit 16. At the point t40 when the signal charges are read out from the sensor sections 11o to the vertical CCDs 13, the electronic exposure is completed.

It is possible to obtain the image for one field including only the pixels in the even number lines and the image for one field including only the pixels in the odd number lines independently from each other. If the image for one field including only the pixels in the odd number lines is combined with the image for one field including only the pixels in the even number lines outputted earlier, a sensitivity mosaic image for one frame including the pixels in all the lines is obtained.

Conversely, as in the second example of the fifth embodiment shown in FIGS. 18A to 18E, in order to read out the signal charges from the sensor sections 11h for high-sensitivity pixel signals to the vertical CCDs 13 earlier and line-shift the signal charges, the signal charges from the sensor sections 11o in the odd number lines may be read out to the vertical CCD 13 and vertically transferred (line-shifted) earlier.

The mechanical shutter 52, is closed (t28) and, at predetermined timing t30 (t30: or timing immediately after the point t28 when the mechanical shutter 52 is closed), the charge readout pulse voltage (readout ROG2) for high-sensitivity pixel signal readout is supplied to the vertical transfer electrodes 24 (also serving as readout electrodes) corresponding to the sensor sections 11o in the odd number lines having the sensor sections 11h for high-sensitivity pixel signals. In this way, the signal charges are read out from the sensor sections 11o in the odd number lines (the sensor sections 11h for high-sensitivity pixel signals) to the vertical CCDs 13 at once. Thereafter, the signal charges in the odd number lines are transferred (line-shifted) to the horizontal CCD 15 side through the vertical CCDs 13 in order (t32 to t36). As a result, an imaging signal representing an image for one field including only pixels in the odd number lines is outputted from the charge-voltage converting unit 16. At the point t30 when the signal charges are read out from the sensor sections 11o to the vertical CCDs 13, the electronic exposure has not been completed yet.

After the point t36 when line-shift of all the signal charges read out from the sensor sections 11o in the odd number lines to the vertical CCDs 13 is completed, the charge readout pulse voltage (readout ROG1_2) for low-sensitivity pixel signal readout is supplied to the vertical transfer electrodes 24 (also serving as readout electrodes) corresponding to the sensor sections 11e in the even number lines having the sensor sections 11l for low-sensitivity pixel signals. In this way, the signal charges are read out from the sensor sections 11e in the even number lines (the sensor sections 11l for low-sensitivity pixel signals) to the vertical CCDs 13 at once (t40: or immediately after t36). Thereafter, the signal charges in the even number lines are transferred (line-shifted) to the horizontal CCD 15 side through the vertical CCDs 13 in order (t42 to t46). As a result, an imaging signal representing an image for one field including only pixels in the even number lines is outputted from the charge-voltage converting unit 16. At the point t40 when the signal charges are read out from the sensor sections 11e to the vertical CCDs 13, the electronic exposure is completed.

It is possible to obtain the image for one field including only the pixels in the odd number lines and the image for one field including only the pixels in the even number lines independently from each other. If the image for one field including only the pixels in the even number lines is combined with the image for one field including only the pixels in the odd number lines outputted earlier, a sensitivity mosaic image for one frame including the pixels in all the lines is obtained.

However, in the sensor sections 11 from which signal charges are read out later, after exposure is stopped, in a period in which signal charges are read out from the sensor sections 11 for one of high-sensitivity pixel signals and low-sensitivity pixel signals, the sensor sections 11 continue to hold the signal charges without being exposed. Therefore, charges due to a dark current generated in the sensor sections 11 (unnecessary charges in the sensor sections 11) are continued to be stored.

Therefore, concerning signals read out later, the fall in S/N and a dynamic range and/or an increase in a level and the number of white dots (dot defects) due to a dark current generated in the sensor section 11 can pose a problem. Therefore, it is advisable to switch, according to an imaging purpose, the sensor sections 11o for high-sensitivity pixel signals and the sensor sections 11e for low-sensitivity pixel signals from which the signal charges are read out to the vertical CCDs 13 earlier.

For example, the central control unit 92 monitors a state of intensity of incidence of an electromagnetic wave on the sensor sections 11 during imaging. The exposure controller 94 acquires information on the state of intensity of incidence of the electromagnetic wave on the sensor sections 11 during imaging from the central control unit 92 and controls, using the information, the mechanical shutter 52 and the aperture stop 56 such that brightness of an image sent to the image processing unit 66 keeps moderate brightness. The timing-signal generating unit 40 acquires the information on the state of intensity of incidence of the electromagnetic wave on the sensor sections 11 during imaging from the central control unit 92 and switches, using the information, the sensor sections 11o for high-sensitivity pixel signals and the sensor sections 11e for low-sensitivity pixel signals from which the signal charges are read out to the vertical CCDs 13 earlier.

For example, during imaging in a low-luminance area in which the high-sensitivity pixel signals have gradation and the low-sensitivity pixel signals tend to be buried in noise, there are a larger number of ineffective pixels when the low-sensitivity pixel signals are used. The number of pixels subjected to interpolation processing by using high-sensitivity pixel values increases. In this case, if the signal charges are read out from the sensor sections 11h for high-sensitivity pixel signals to the vertical CCDs 13 after the signal charges are read out from the sensor sections 11l for low-sensitivity pixel signals to the vertical CCDs 13, a dark current and a white dot (a dot defect) are caused in the sensor sections 11h for high-sensitivity pixel signals from which the signal charges are read out to the vertical CCDs 13 later. Therefore, during imaging in the low-luminance region, it is advisable to read out the signal charges from the sensor sections 11h for high-sensitivity pixel signal to the vertical CCDs 13 before the signal charges are read out from the sensor sections 11l for low-sensitivity pixel signals to the vertical CCDs 13.

When the signal charges are read out from the sensor sections 11l for low-sensitivity pixel signals to the vertical CCDs 13 later, in a period in which the signal charges are read out from the sensor sections 11h for high-sensitivity pixel signals, from which the signal charges are read out to the vertical CCDs 13 earlier, to the vertical CCDs 13 and line-shifted, a dark current is generated in the sensor sections 11l for low sensitivity pixel signals, from which the signal charges are read out later. During imaging in the low-luminance area, there are a larger number of ineffective pixels when the low-sensitivity pixel signals are used. The number of pixels subjected to interpolation processing by using high-sensitivity pixel values increases. Therefore, to perform interpolation processing to prevent the signal charges from being affected by the problem of the fall in S/N and a dynamic range, an increase in a level and the number of white dots (dot defects), and the like due a dark current generated in the sensor sections 11, it is advisable to read out the signal charges from the sensor sections 11h for high-sensitivity pixel signals having a larger number of effective pixels to the vertical CCDs 13 earlier.

During imaging in the low-luminance area, by reading out the signal charges from the sensor sections 11h for high-sensitivity pixel signals to the vertical CCDs 13 earlier, it is possible to expand a dynamic range of intensity of incident light on the low-luminance side and improve S/N on the low-luminance side compared with the time when the signal charges are read out from the sensor sections 11l for low-sensitivity pixel signals to the vertical CCDs 13 earlier. It is also possible to reduce the number and a level of dot defects on the low-luminance side. Moreover, before the signal charges acquired in the latter half of the entire exposure period are read out to the vertical CCDs 13, the signal charges acquired in the former half of the entire exposure period in the sensor sections 11l for acquiring low-sensitivity pixel signals are swept out to the outside of the CCD solid-state imaging device 10 together with unnecessary charges such as a smear component and a dark current component generated in the vertical CCDs 13 (t22 to t29). Therefore, when the high-sensitivity pixel signals are used, not only unnecessary charges in the sensor sections 11 but also unnecessary charges in the vertical CCDs 13 are small. Consequently, a dynamic range of intensity of incident light on the low-luminance side and S/N on the low-luminance side are further improved, higher sensitivity and a higher dynamic range of intensity of incident light can be attained, and a dark current generated in the vertical CCDs 13 during the electronic entire exposure period does not change to a white spot (a dot defect).

In a high-luminance side and an intermediate-luminance area, it is advisable to readout the signal charges from the sensor sections 11l for low-sensitivity pixel signals to the vertical CCDs 13 earlier. Consequently, it is possible to improve S/N and reduce dot defects in the intermediate-luminance area compared with the time when the signal charges are read out from the sensor sections 11h for high-sensitivity pixel signals to the vertical CCDs 13 earlier. On the high-luminance side, although an effect is small, it is possible to expand a dynamic range of intensity of incident light a little and it is expected that, for example, S/N is improved and dot defects are reduced a little. Before the signal charges acquired in the latter half of the entire exposure period are read out to the vertical CCDs 13, the signal charges acquired in the former half of the entire exposure period in the sensor sections 11l for acquiring low-sensitivity pixel signals are swept out to the outside of the CCD solid-state imaging device 10 together with unnecessary charges such as a smear component and a dark current component generated in the vertical CCDs 13 (t22 to t29). Therefore, when the low-sensitivity pixel signals are used, not only unnecessary charges in the sensor sections 11 but also unnecessary charges in the vertical CCDs 13 are small. Consequently, it is possible to, for example, further improve S/N and reduce dot defects in the intermediate-luminance area. On the high-luminance side, although an effect is small, it is possible to expand a dynamic range of intensity of incident light a little and it is expected that, for example, S/N is improved and dot defects are reduced a little. Moreover, in both the intermediate-luminance area and the high-luminance side, a dark current generated in the vertical CCDs 13 during the electronic entire exposure period does not change to a white dot (a dot defect).

In both the first example of the fifth embodiment shown in FIGS. 17A to 17G and the second example of the fifth embodiment shown in FIGS. 18A to 18E, in periods other than the period t10 to t32, a waveform for transferring charges in common from the sensor sections 11h for high-sensitivity pixel signals and the sensor sections 11l for low-sensitivity pixel signals to the vertical CCDs 13 (the V registers) is supplied to the vertical transfer electrodes 24. However, in a latter half of the period t10 to t30, i.e., the period t22 to t29, a waveform for performing line-shift is also supplied to the vertical transfer electrodes 24. Consequently, it is possible to not only sweep out the signal charges for the low-sensitivity pixel signals read out in the first time but also a dark current component generated in the vertical CCDs 13.

This sweep-out operation sweeps out not only the dark current component but also a smear component and other unnecessary charge components. In other words, if the mechanical shutter 52 is used as well, the signal charges for the high-sensitivity pixel signals and low-sensitivity pixel signals are read out to the vertical CCDs 13 and line-shifted in a state in which the mechanical shutter 52 is closed to stop exposure. Therefore, no light is made incident on the CCD solid-state imaging device 10 at least during the line-shift. In principle, it is possible to completely eliminate, for both the high-sensitivity pixel signals and the low-sensitivity pixel signals, noise caused by unnecessary charges such as a smear component due to light made incident on the CCD solid-state imaging device 10 during the light-shift period. The signal charges acquired in the former half of the entire exposure period in the sensor sections 11l for acquiring low-sensitivity pixel signals are swept out to the outside of the CCD solid-state imaging device 10 together with unnecessary charges such as a smear component and a dark current component generated in the vertical CCDs 13 before signal charges acquired in the latter half of the entire exposure period are read out to the vertical CCDs 13 (t22 to t29). Therefore, smear is low, a dark current is low, and a dark current generated in the vertical CCDs 13 during the electronic entire exposure period does not change to a white dot (a dot defect).

As described above, in the driving control methods according to the first example of the fifth embodiment and the second example of the fifth embodiment, the IL-CCD or the FIT-CCD is used as the CCD solid-state imaging device 10. However, as in the driving control methods according to the fourth embodiment and the modification to the fourth embodiment, the signal charges acquired in the former half of the entire exposure and storage period in the sensor sections 11l for acquiring low-sensitivity pixel signals are swept out to the outside of the CCD solid-state imaging device 10 before the signal charges acquired in the latter half of the entire exposure and storage period are read out. Then, the mechanical shutter 52 is closed (t28) and, after the point t29 when sweep-out of the signal charges acquired in the sensor sections 11l for short-time exposure signals (low-sensitivity pixel signals) in the former half of the entire exposure and storage period, which are read out to the vertical CCDs 13 earlier in a state in which exposure is stopped to the outside of the vertical CCDs 13 (i.e., the CCD solid-state imaging device 10) is completed, the signal charges for the high-sensitivity pixel signals and the signal charges for the low-sensitivity pixel signals are read out to the vertical CCDs 13 in predetermined order and line shifted.

Consequently, as in the driving control methods according to the fourth embodiment and the modification to the fourth embodiment, concerning both the signal charges for the high-sensitivity pixel signals by the long-time exposure and the signal charges for the low-sensitivity pixel signals by the short-time exposure, read-out signal charges are not retained in the vertical CCDs 13 and stopped from being transferred. Therefore, an effect of a reduction in a dark current is extremely high. It goes without saying that, concerning both the signal charges for the high-sensitivity pixel signals by the long-time exposure and the signal charges for the low-sensitivity pixel signals by the short-time exposure, since a dark current generated in the vertical CCDs 13 when the read-out signal charges are left stored in the vertical CCDs 13 are not generated, a white dot (a dot defect) is not caused. Since the mechanical shutter 52 is used as well, it is possible to completely eliminate, for both the high-sensitivity pixel signals and the low-sensitivity pixel signals, noise caused by unnecessary charges such as a smear component due to light made incident on the CCD solid-state imaging device 10 during the light-shift period. The signal charges acquired in the former half of the entire exposure period in the sensor sections 11l for acquiring low-sensitivity pixel signals are swept out to the outside of the CCD solid-state imaging device 10 together with unnecessary charges such as a smear component and a dark current component generated in the vertical CCDs 13 before signal charges acquired in the latter half of the entire exposure period are read out to the vertical CCDs 13 (t22 to t29). Therefore, smear is low, a dark current is low, and a dark current generated in the vertical CCDs 13 during the electronic entire exposure period does not change to a white dot (a dot defect).

The first example of the fifth embodiment and the second example of the fifth embodiment are compared with the fourth embodiment and the modification to the fourth embodiment. In the fourth embodiment and the modification to the fourth embodiment in which the CCD solid-state imaging device of the progressive scan system is adopted, the long-time exposure signals (the high-sensitivity pixel signals) and the short-time exposure signals (the low-sensitivity pixel signals) can be simultaneously read out to the vertical CCDs 13 and line-shifted through the vertical CCDs 13. Therefore, there is an advantage that a sensitivity mosaic image for one frame including the pixels in all the lines can be obtained by performing line-shift once. On the other hand, in the first example of the fifth embodiment and the second example of the fifth embodiment in which the IL-CCD or the FIT-CCD is adopted, the long-time exposure signals (the high-sensitivity pixel signals) and the short-time exposure signals (the low-sensitivity pixel signals) have to be alternately read out to the vertical CCDs 13 by frame readout and line-shifted through the vertical CCDs 13. An image for one field including only high-sensitivity pixels and an image for one field including only low-sensitivity pixels are outputted in order. Therefore, in order to obtain a sensitivity mosaic image for one frame including the pixels in all the lines, it is necessary to combine the image for one field including only the high-sensitivity pixels and the image for one field including only the low-sensitivity pixels.

On the other hand, in the first example of the fifth embodiment and the second example of the fifth embodiment, the IL-CCD or the FIT-CCD is used rather than the CCD solid-state imaging device of the progressive scan system. Therefore, compared with the forth embodiment and the modification to the fourth embodiment in which the CCD solid-state imaging device of the progressive scan system is used, it is possible to refine a pixel size of the CCD solid-state imaging device. Further, manufacturing cost for the IL-CCD or the FIT-CCD is low compared with that for the CCD solid-state imaging device of the progressive scan system, it is possible to realize SVE imaging while reducing system cost.

### Electronic Method of Forming a Sensitivity Mosaic Pattern; Sixth Embodiment

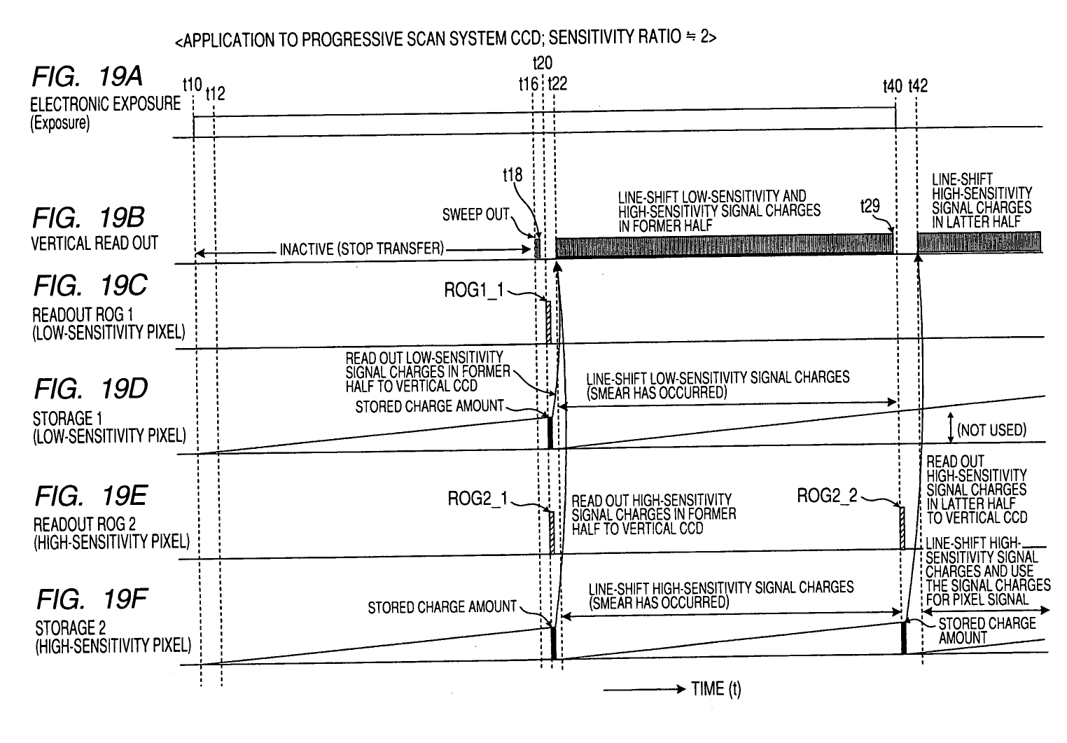

FIGS. 19A to 19F are diagrams for explaining driving control according to a first example of a sixth embodiment of the present invention for electronically realizing a sensitivity mosaic pattern while controlling generation of a dark current in the vertical CCDs 13. FIGS. 20A to 20F are diagrams for explaining driving control according to a second example of the sixth embodiment for electrically realizing a sensitivity mosaic pattern while controlling generation of a dark current in the vertical CCDs 13. Although the mechanical shutter 52 is not used in FIGS. 19A to 20F, the mechanical shutter 52 may be used as well for removing smear.

A driving control method according to the first example of the sixth embodiment is a modification to the driving control method according to the first embodiment. A driving control method according to the second example of the sixth embodiment is a modification to the driving control method according to the fourth embodiment. The driving control methods according to the first and second examples of the sixth embodiment have a characteristic in acquiring signal charges for the high-sensitivity pixel signals with long exposure and storage time dividedly twice in a former half and a latter half of an entire exposure period and individually performing readout of the signal charges for the high-sensitivity pixel signals acquired in the former half of the entire exposure period in the sensor sections 11h for high-sensitivity pixel signals and the signal charges for the high-sensitivity pixel signals acquired in the latter half of the entire exposure period in the sensor sections 11h for high-sensitivity pixel signals from the sensor sections 11h for high-sensitivity pixel signals to the vertical CCDs 13 and charge transfer of the signal charges dividedly twice.

Readout of the signal charges for the high-sensitivity pixel signals acquired in the former half of the entire exposure period in the sensor sections 11h for high-sensitivity pixel signals from the sensor sections 11h for high-sensitivity pixel signals to the vertical CCDs 13 and charge transfer of the signal charges and readout of the signal charges for the high-sensitivity pixel signals acquired in the latter half of the entire exposure period in the sensor sections 11h for high-sensitivity pixel signals from the sensor sections 11h for high-sensitivity pixel signals to the vertical CCDs 13 and charge transfer of the signal charges are performed dividedly twice. Therefore, in response to the readout and the charge transfer, the image signal processing unit 66 acquires final high-sensitivity pixel signals by adding up and combining pixel signals in identical pixel positions using the high-sensitivity pixel signals acquired in the former half of the entire exposure period in the sensor sections 11h for high-sensitivity pixel signals and the high-sensitivity pixel signals acquired in the latter half of the entire exposure period in the sensor sections 11h for high-sensitivity pixel signals.

In the timing described in WO2002/056603 and JP-A-2004-172858, when signal charges are read out to the vertical CCDs in the first time (at predetermined timing in the entire exposure period in the sensor sections for high-sensitivity pixel signals), the signal charges are left stored in the vertical CCDs without being line-shifted. Signal charges read out to the vertical CCDs in the second time (at final timing in the electronic entire exposure period in the sensor sections for high-sensitivity pixel signals) are added to the signal chares read out in the first time and the signal charges are line-shifted. On the other hand, in the first example of the sixth embodiment and the second example of the sixth embodiment, the signal charges for the high-sensitivity pixel signals acquired in the former half of the entire exposure period in the sensor sections 11h for high-sensitivity pixel signals and the signal charges for the high-sensitivity pixel signals acquired in the latter half of the entire exposure period in the sensor sections 11h for high-sensitivity pixel signals are individually read out from the sensor sections 11h for high-sensitivity pixel signals to the vertical CCDs 13 and line-shifted. Final high-sensitivity pixel signals are acquired by signal processing in the image processing unit 66 by using the high-sensitivity pixel signals acquired in the former half of the entire exposure period in the sensor sections 11h for high-sensitivity pixel signals and the high-sensitivity pixel signals acquired in the latter half of the entire exposure period in the sensor sections 11h for high-sensitivity pixel signals. The driving control method according to the first and second examples of the sixth embodiment are different from the driving control methods disclosed in WO2002/056603 and JP-A-2004-172858 in this point.

The first example of the sixth embodiment shown in FIGS. 19A to 19F is described as a modification to the first embodiment in which the signal charges for the low-sensitivity pixel signals acquired in the exposure and storage period in the former half of the entire exposure period in the sensor sections 11l for low-sensitivity pixel signals are actually used. The second example of the sixth embodiment shown in FIGS. 20A to 20F is described as a modification to the fourth embodiment in which the signal charges for the low-sensitivity pixel signals acquired in the exposure and storage period in the latter half of the entire exposure period in the sensor sections 11l for low-sensitivity pixel signals are actually used.

In the first example of the sixth embodiment and the second example of the sixth embodiment, concerning the signal charges for the high-sensitivity pixel signals, the signal charges for the high-sensitivity pixel signals are acquired dividedly twice in the former half and the latter half of the entire exposure period in the sensor sections 11h for high-sensitivity pixel signals. The signal charges for the high-sensitivity pixel signals acquired in the former half of the entire exposure period in the sensor sections 11h for high-sensitivity pixel signals are read out from the sensor sections 11h for high-sensitivity pixel signals and transferred. The signal charges for the high-sensitivity pixel signals acquired in the latter half of the entire exposure period in the sensor sections 11h for high-sensitivity pixel signals are also read out from the sensor sections 11h for high-sensitivity pixel signals to the vertical CCDs 13 and transferred. Then, the signal charges for the high-sensitivity pixel signals read out in the former half and the latter half of the entire exposure period are combined and used for an output signal. Concerning the signal charges for the low-sensitivity pixel signals, the signal charges for the low-sensitivity pixel signals acquired in the former half of the entire exposure period in the sensor sections 11l for low-sensitivity pixel signals, read out from the sensor sections 11l for low-sensitivity pixel signals to the vertical CCDs 13, and transferred may be used for an output signal. Alternatively, the signal charges for the low-sensitivity pixel signals acquired in the latter half of the entire exposure period in the sensor sections 11 for low-sensitivity pixel signals, read out from the sensor sections 11l for low-sensitivity pixel signals to the vertical CCDs 13, and transferred may be used for an output signal.

In the first example of the sixth embodiment shown in FIGS. 19A to 19F and the second example of the sixth embodiment shown in FIGS. 20A to 20F, a charge readout pulse voltage (readout ROG2_1) is supplied to the vertical transfer electrodes 24 (also serving as readout electrodes) corresponding to the sensor sections 11h for high-sensitivity pixel signals and a charge readout pulse voltage (readout ROG1_1) is supplied to the vertical transfer electrodes 24 (also serving as readout electrodes) corresponding to the sensor sections 11l for low-sensitivity pixel signals while exposure is continued at predetermined timing in the entire exposure period (t10 to t40) in the sensor sections 11h for high-sensitivity pixel signals and the sensor sections 11l for low-sensitivity pixel signals. In this way, the signal charges acquired by the sensor sections 11h for high-sensitivity pixel signals and the sensor sections 11l for low-sensitivity pixel signals are read out to the vertical CCDs 13 by exposure in the former half of the entire exposure period in the sensor sections 11h for high-sensitivity pixel signals and the sensor sections 11l for low-sensitivity pixel signals (t20).

Thereafter, the storage of signal charges in the sensor sections 11h for high-sensitivity pixel signals and the sensor sections 11l for low-sensitivity pixel signals is continued. In the first example of the sixth embodiment shown in FIGS. 19A to 19F, at the final timing of the electronic entire exposure period after the predetermined time, a charge readout pulse voltage (readout ROG2_2) is supplied to the vertical transfer electrodes 24 (also serving as readout electrodes) corresponding to the sensor sections 11h for high-sensitivity pixel signals. Signal charges acquired in the sensor sections 11h for high-sensitivity pixel signals are read out to the vertical CCDs 13 by exposure in the latter half of the entire exposure period in the sensor sections 11h for high-sensitivity pixel signals (t40). On the other hand, in the second example of the sixth embodiment shown in FIGS. 20A to 20F, the charge readout pulse voltage (readout ROG2_2) is supplied to the vertical transfer electrodes 24 (also serving as readout electrodes) corresponding to the sensor sections 11h for high-sensitivity pixel signals. The readout pulse voltage (readout ROG1_2) is supplied to the vertical transfer electrodes 24 (also serving as readout electrodes) corresponding to the sensor sections 11h for high-sensitivity pixel signals. Signal charges acquired by the sensor sections 11h for high-sensitivity pixel signals and the sensor sections 11l for low-sensitivity pixel signals are read out to the vertical CCDs 13 by exposure in the latter half of the entire exposure period in the sensor sections 11h for high-sensitivity pixel signals and the sensor sections 11l for low-sensitivity pixel signals (t40).

The first example of the six embodiment and the second example of the sixth embodiment have a characteristic in reading out the signal charges acquired in the sensor sections 11h for high-sensitivity pixel signals and the sensor sections 11l for low-sensitivity pixel signals are read out to the vertical CCDs 13 in the former half of the entire exposure period in the sensor sections 11h for high-sensitivity pixel signals and the sensor sections 11l for low-sensitivity pixel signals (t20), line-shifting the signal charges for the high-sensitivity pixel signals and the signal charges for the low-sensitivity pixel signals read out to the vertical CCDs 13, i.e., the signal charges acquired by the sensor sections 11h for high-sensitivity pixel signals and the sensor sections 11l for low-sensitivity pixel signals in the former half of the entire exposure period in the sensor sections 11h for high-sensitivity pixel signals and the sensor sections 11l for low-sensitivity pixel signals, i.e., the signal charges acquired by the sensor sections 11h for high-sensitivity pixel signals and the sensor sections 11l for low-sensitivity pixel signals in the former half of the entire exposure period in the sensor sections 11h for high-sensitivity pixel signals and the sensor sections 11l for low-sensitivity pixel signals are line-shifted to the vertical CCDs 13 (t22 to t29) and transferred to the horizontal CCD 15 side in a part of a period (t20 to t40) or the entire period in which the storage of signal charges in the sensor sections 11h for high-sensitivity pixel signals and the sensor sections 11l for low-sensitivity pixel signals in the later half of the entire exposure period in the sensor sections 11h for high-sensitivity pixel signals and the sensor sections 11l for low-sensitivity pixel signals.

In other words, the first example of the six embodiment and the second example of the sixth embodiment have a significant characteristic in, in performing the acquisition of signal charges for the high-sensitivity pixel signals with long exposure and storage time dividedly in the former half and the latter half of the entire exposure period in the sensor sections 11h for high-sensitivity pixel signals, not only performing readout of the signal charges from the sensor sections 11h for high-sensitivity pixel signals to the vertical CCDs 13 dividedly twice but also performing line-shift for transferring the signal charges acquired by the sensor sections 11h for high-sensitivity pixel signals, which are read out to the vertical CCDs 13, to the horizontal CCD 15 side divided twice.

Driving control timing according to the first example of the sixth embodiment and the second example of the sixth embodiment is similar to the timing in the past shown in FIG. 23 of WO2002/056603 in that readout of signal charges from the sensor sections to the vertical CCDs is performed dividedly twice in order to acquire high-sensitivity pixel signals. However, in the mechanism in the past shown in FIG. 23 of WO2002/056603, only read out of signal charges from one light-receiving elements for acquiring high-sensitivity pixel signals with long exposure and storage time to the vertical CCDs is performed dividedly twice. The signal charges for the high-sensitivity pixel signals read out to the vertical CCDs dividedly twice and the signal charges for the low-sensitivity pixel signals read out from the other light-receiving elements to the vertical CCDs are simultaneously transferred to the horizontal CCD side through the vertical CCDs by performing a line-shift operation once after the final timing of the electronic entire exposure and storage period. Therefore, the mechanism is different from the mechanisms according to the first example of the sixth embodiment and the second example of the sixth embodiment for performing the line-shift operation dividedly twice as well.

In the driving control methods according to the first example of the sixth embodiment and the second example of the sixth embodiment, concerning the signal charges for the high-sensitivity pixel signals by long-time exposure, since the signal charges read out from the sensor sections 11h for high-sensitivity pixel signals to the vertical CCDs 13 dividedly twice in the entire exposure and storage period are not stored in the vertical CCDs 13 and stopped from being transferred, the high-sensitivity pixel signals are low in a dark current. A dark current generated in the vertical CCDs 13 when the signal charges read out from the sensor sections 11h for high-sensitivity pixel signals to the vertical CCDs 13 are left stored in the vertical CCDs 13 are not generated. Therefore, a white dot (a dot defect) is not caused.

However, concerning the high-sensitivity pixel signals acquired in the former half of the entire exposure period in the sensor sections 11h for high-sensitivity pixel signals, the signal charges are line-shifted and transferred to the horizontal CCD 15 side in a part of the period (t20 to t40) or the entire period in which the storage of signal charges in the sensor sections 11h for high-sensitivity pixel signals and the sensor sections 11l for low-sensitivity pixel signals is continued in the latter half of the entire exposure period in the storage of signal charges in the sensor sections 11h for high-sensitivity pixel signals and the sensor sections 11l for low-sensitivity pixel signals. The signal charges are used as an output signal. Therefore, noise due to unnecessary charges such as a smear component can pose a problem.

On the other hand, concerning the low-sensitivity pixel signals, in the driving control method according to the first example of the sixth embodiment shown in FIGS. 19A to 19F, as in the driving control method according to the first embodiment, the signal charges for the low-sensitivity pixel signals read out from the sensor sections 11l for low-sensitivity pixel signals at the predetermined timing in the entire exposure period in the sensor sections 11l for low-sensitivity pixel signals are line-shifted to the horizontal CCD 15 side in a part of the period (t20 to t40) or the entire period in which the storage of signal charges in the storage of signal charges in the sensor sections 11h for high-sensitivity pixel signals and the sensor sections 11l for low-sensitivity pixel signals is continued in the latter half of the entire exposure period in the storage of signal charges in the sensor sections 11h for high-sensitivity pixel signals and the sensor sections 11l for low-sensitivity pixel signals. In this way, since the signal charges are not stored in the vertical CCDs 13 and stopped from being transferred, the low-sensitivity pixel signals are low in a dark current. A dark current generated in the vertical CCDs 13 when the signal charges for the low-sensitivity pixel signals acquired by the short-time exposure are left stored in the vertical CCDs 13 are not generated. Therefore, a white dot (a dot defect) is not caused. However, like the high-sensitivity pixel signals acquired in the former half of the entire exposure period in the sensor sections 11h for high-sensitivity pixel signals, the signal charges for the low-sensitivity pixel signals read out from the sensor sections 11l for low-sensitivity pixel signals to the vertical CCDs 13 at the predetermined timing in the entire exposure period in the sensor sections 11l for low-sensitivity pixel signals are line-shifted and transferred to the horizontal CCD 15 side in a part of the period (t20 to t40) or the entire period in which the storage of signal charges in the sensor sections 11h for high-sensitivity pixel signals and the sensor sections 11l for low-sensitivity pixel signals is continued in the latter half of the entire exposure period in the storage of signal charges in the sensor sections 11h for high-sensitivity pixel signals and the sensor sections 11l for low-sensitivity pixel signals. The signal charges are used as an output signal. Therefore, noise due to unnecessary charges such as a smear component due to light made incident on the CCD solid-state imaging device 10 during the line-shift period can pose a problem.

On the other hand in the driving control method according to the second example of the sixth embodiment shown in FIGS. 20A to 20F, concerning the low-sensitivity pixel signals, as in the fourth embodiment, acquisition of signal charges is performed in the latter half of the entire exposure period in the sensor sections 11l for low-sensitivity pixel signals. However, the signal charges acquired in the former half of the entire exposure period in the storage of signal charges in the sensor sections 11h for high-sensitivity pixel signals and the sensor sections 11l for low-sensitivity pixel signals are line-shifted before the signal charges acquired in the latter half of the entire exposure period in the storage of signal charges in the sensor sections 11h for high-sensitivity pixel signals and the sensor sections 11l for low-sensitivity pixel signals are read out to the vertical CCDs 13 (t22 to t29). This line-shift operation is also sweep-out of unnecessary charges such as a smear component and a dark current component generated in the vertical CCDs 13. Therefore, smear is low, a dark current is low, and a dark current generated in the vertical CCDs 13 during the electronic entire exposure period does not change to a white dot (a dot defect). Moreover, if the mechanical shutter 52 is used as well, the signal charges for the low-sensitivity pixel signals are read out to the vertical CCDs 13 and line-shifted in a state in which the mechanical shutter 52 is closed and exposure is stopped. Therefore, at least during a period of the line-shift, no light is made incident on the CCD solid-state imaging device 10. In principle, concerning the low-sensitivity pixel signals, it is possible to completely eliminate noise caused by unnecessary charges such as a smear component due to light made incident on the CCD solid-state imaging device 10 during the line-shift period.

The signal charges for the high-sensitivity pixel signals are acquired divided twice in the former half and the latter half of the entire exposure period. The signal charges for the high-sensitivity pixel signals acquired in the former half of the entire exposure period in the sensor sections 11h for high-sensitivity pixel signals and the signal charges for the high-sensitivity pixel signals acquired in the latter half of the entire exposure period in the sensor sections 11h for high-sensitivity signals are read out to from the sensor sections 11h for high-sensitivity pixel signals to the vertical CCDs 13 at the predetermined timing in the entire exposure period in the sensor sections 11h for high-sensitivity pixel signals and the final timing of the electronic entire exposure period, respectively. The signal charges for the high-sensitivity pixel signals read out from the sensor sections 11h for high-sensitivity pixel signals to the vertical CCDs 13 dividedly twice at the predetermined timing during the entire exposure period in the sensor sections 11h for high-sensitivity pixel signals and the final timing of the electronic entire exposure period are line-shifted every time the signal charges are read out (i.e., dividedly twice). Therefore, the signal charges for the high-sensitivity pixel signals acquired dividedly twice in the former half and the latter half of the entire exposure period in the sensor sections 11h for high-sensitivity pixel signals are read out from the sensor sections 11h for high-sensitivity pixel signals to the vertical CCDs 13 divided twice at the predetermined timing during the entire exposure period in the sensor sections 11h for high-sensitivity pixel signals and the final timing of the electronic entire exposure period. The signal charges for the high-sensitivity pixel signals read out dividedly twice are transferred through the vertical CCDs 13 independently from each other. Sensitivity of the high-sensitivity pixel signals in this case is low compared with sensitivity of the high-sensitivity pixel signals at the time when the signal charges for the high-sensitivity pixel signals acquired in the entire exposure period in the sensor sections 11h for high-sensitivity pixel signals are read out from the sensor sections 11h for high-sensitivity pixel signals to the vertical CCDs 13 and transferred only once at the final timing of the electronic entire exposure period. This is because exposure times for acquiring high-sensitivity pixel signals at the time when the signal charges for the high-sensitivity pixel signals are read out from the sensor sections 11h for high-sensitivity pixel signals to the vertical CCDs 13 and transferred dividedly twice in the former half and the latter half of the entire exposure period in the sensor sections 11h for high-sensitivity pixel signals are shorter than exposure period exposure time for acquiring high-sensitivity pixel signals at the time when the signal charges for the high-sensitivity pixel signals are read out from the sensor sections 11h for high-sensitivity pixel signals to the vertical CCDs 13 and transferred only once at the final timing of the electronic entire exposure period. However, a saturate signal charge amount of the sensor sections 11h for high-sensitivity pixel signals does not depend on the number of readout of the signal charges for the high-sensitivity pixel signals from the sensor sections 11h for high-sensitivity pixel signals to the vertical CCDs 13 and transfer of the signal charges. Therefore, when the signal charges for the high-sensitivity pixel signals acquired dividedly twice in the former half and the latter half of the entire exposure period in the sensor sections 11h for high-sensitivity pixel signals are read out dividedly twice at the predetermined timing during the entire exposure period in the sensor sections 11h for high-sensitivity pixel signals and the final timing of the electronic entire exposure period and the signal charges read out dividedly twice are transferred through the vertical CCDs 13 independently from each other, saturated signal charge amounts of the respective high-sensitivity pixel signals are equal to a saturated signal charge amount of the high-sensitivity pixel signals at the time when the signal charges for the high-sensitivity pixel signals acquired in the entire exposure period in the sensor sections 11h for high-sensitivity pixel signals are read out from the sensor sections 11h for high-sensitivity pixel signals to the vertical CCDs 13 and transferred only once at the final timing of the electronic entire exposure period. As a result, sensitivity of final high-sensitivity pixel signals acquired by the signal processing in the image processing unit 66 is equal to sensitivity of high-sensitivity pixel signals at the time when the signal charges for the high-sensitivity pixel signals are read out from the sensor sections 11h for high-sensitivity pixel signals to the vertical CCDs 13 only once at the final timing of the electronic entire exposure period. This is because a total entire exposure period is the same when the signal charges for the high-sensitivity pixel signals acquired dividedly twice in the former half and the latter half of the entire exposure period in the sensor sections 11h for high-sensitivity pixel signals are read out from the sensor sections 11h for high-sensitivity pixel signals to the vertical CCDs 13 dividedly twice at the predetermined timing during the entire exposure period in the sensor sections 11h for high-sensitivity pixel signals and the final timing of the electronic entire exposure period and the signal charges read out dividedly twice are transferred to the vertical CCDs 13 independently from each other and when the signal charges for the high-sensitivity pixel signals are read out from the sensor sections 11h for high-sensitivity pixel signals to the vertical CCDs 13 only once at the final timing of the electronic entire exposure period. A saturated signal charge amount of the final high-sensitivity pixel signals acquired by the signal processing in the image processing unit 66 is twice as large as a saturated signal charge amount of the high-sensitivity pixel signals at the time when the signal charges for the high-sensitivity pixel signals are read out from the sensor sections 11h for high-sensitivity pixel signals to the vertical CCDs 13 only once at the final timing of the electronic entire exposure period. Therefore, it is possible to expand a dynamic range of intensity of incident light of the final high-sensitivity pixel signals acquired by the signal processing in the image processing unit 66 to the high-luminance side. Consequently, when the combination processing by SVE is performed, it is possible to expand an area of intensity of incident light corresponding to an area with high resolution having gradation in both the low-sensitivity pixel signals and the high-sensitivity pixel signals to the high-luminance side.

For example, as shown in FIGS. 19A to 20F, the readout timing t20 when the signal charges are read out from the sensor sections 11h for high-sensitivity pixel signals and the sensor sections 11l for low-sensitivity pixel signals to the vertical CCDs 13 in the former half of the entire exposure period in the sensor sections 11h for high-sensitivity pixel signals and the sensor sections 11l for low-sensitivity pixel signals is set such that a ratio Sratio (=SHigh/Slow) of sensitivity SHigh of high-sensitivity pixels and sensitivity Slow of low-sensitivity pixels is about “2”. Then, for the acquisition of signal charges performed dividedly twice, it is possible to equalize an area of intensity of incident light in which the sensor sections 11h for high-sensitivity pixel signals are not saturated. Compared with the time when the signal charges for the high-sensitivity pixel signals are read out from the sensor sections 11h for high-sensitivity pixel signals to the vertical CCDs 13 and transferred only once at the final timing of the electronic entire exposure period, it is possible to expand the area of intensity of incident light in which the sensor sections 11h for high-sensitivity pixel signals are not saturated to the high-luminance side by twofold. Therefore, when the combination processing by SVE is performed, it is possible to expand an area corresponding to the area with high resolution having gradation in both the low-sensitivity pixel signals and the high-sensitivity pixel signals to the high-luminance side by twofold.

In the timing in the past described in WO2002/056603 and JP-A-2004-172858, in order to acquire the final high-sensitivity pixel signals, the signal charges for the high-sensitivity pixel signals read out from the sensor sections for high-sensitivity pixel signals to the vertical CCDs at the predetermined timing during the entire exposure period in the sensor sections for high-sensitivity pixel signals are left stored without being line-shifted to the vertical CCDs until the line-shift operation is started after the final timing of the electronic entire exposure period. In this way, the signal charges for the high-sensitivity pixel signals read out from the sensor sections for high-sensitivity pixel signals to the vertical CCDs at the final timing of the electronic entire exposure period are added to, in the vertical CCDs, the signal charges for the high-sensitivity pixel signals read out from the sensor sections for high-sensitivity pixel signals to the vertical CCDs at the predetermined timing in the entire exposure period in the sensor sections for high-sensitivity pixel signals earlier. Therefore, entire signal charges for the final high-sensitivity pixel signals are obtained by adding up, in the vertical CCDs, the signal charges for the high-sensitivity pixel signals read out from the sensor sections for high-sensitivity pixel signals to the vertical CCDs at the predetermined timing in the entire exposure period in the sensor sections for high-sensitivity pixel signals and the signal charges for the high-sensitivity pixel signals read out from the sensor sections for high-sensitivity pixel signals to the vertical CCDs at the final timing of the electronic entire exposure period. The signal charges for the final high-sensitivity pixel signals are transferred to the horizontal CCD side by performing the line-shift operation once after the end of the electronic entire exposure period. Therefore, exposure time for acquiring the final high-sensitivity pixel signals obtained by adding up, in the vertical CCD, the signal charges for the high-sensitivity pixel signals read out from the sensor sections for high-sensitivity pixel signals to the vertical CCDs at the predetermined timing in the entire exposure period in the sensor sections for high-sensitivity pixel signals and the signal charges for the high-sensitivity pixel signals read out from the sensor sections for high-sensitivity pixel signals to the vertical CCDs at the final timing of the electronic entire exposure period is equal to exposure time for acquiring the high-sensitivity pixel signals when the signal charges for the high-sensitivity pixel signals are read out from the sensor sections for high-sensitivity pixel signals to the vertical CCDs only once at the final timing of the electronic entire exposure period. Therefore, sensitivity of the final high-sensitivity pixel signals obtained by adding up, in the vertical CCD, the signal charges for the high-sensitivity pixel signals read out from the sensor sections for high-sensitivity pixel signals to the vertical CCDs at the predetermined timing in the entire exposure period in the sensor sections for high-sensitivity pixel signals and the signal charges for the high-sensitivity pixel signals read out from the sensor sections for high-sensitivity pixel signals to the vertical CCDs at the final timing of the electronic entire exposure period is equal to sensitivity of the high-sensitivity pixel signals at the time when the signal charges for the high-sensitivity pixel signals are read out from the sensor sections for high-sensitivity pixel signals to the vertical CCDs only once at the final timing of the electronic entire exposure period. A saturated signal charge amount of the sensor sections for high-sensitivity pixel signals does not depend on the number of times of readout of the signal charges for the high-sensitivity pixel signals from the sensor sections for high-sensitivity pixel signals to the vertical CCDs. Therefore, a saturated signal charge amount of the final high-sensitivity pixel signals obtained by adding up, in the vertical CCD, the signal charges for the high-sensitivity pixel signals read out from the sensor sections for high-sensitivity pixel signals to the vertical CCDs at the predetermined timing in the entire exposure period in the sensor sections for high-sensitivity pixel signals and the signal charges for the high-sensitivity pixel signals read out from the sensor sections for high-sensitivity pixel signals to the vertical CCDs at the final timing of the electronic entire exposure period is twice as large as a saturated signal charge amount of the high-sensitivity pixel signals at the time when the signal charges for the high-sensitivity pixel signals are read out from the sensor sections for high-sensitivity pixel signals to the vertical CCDs only once at the final timing of the electronic entire exposure period. Consequently, a largest signal charge amount necessary to be transferred through the vertical CCDs in adding up and transferring, in the vertical CCD, the signal charges for the high-sensitivity pixel signals read out from the sensor sections for high-sensitivity pixel signals to the vertical CCDs at the predetermined timing in the entire exposure period in the sensor sections for high-sensitivity pixel signals and the signal charges for the high-sensitivity pixel signals read out from the sensor sections for high-sensitivity pixel signals to the vertical CCDs at the final timing of the electronic entire exposure period is also twice as large as a maximum signal charge amount necessary to be transferred through the vertical CCDs when the signal charges for the high-sensitivity pixel signals are read out from the sensor sections for high-sensitivity pixel signals to the vertical CCDs only once at the final timing of the electronic entire exposure period. However, a maximum signal charge amount that can be transferred through the vertical CCDs does not depend on the number of times of readout of the signal charges for the high-sensitivity pixel signals from the sensor sections for high-sensitivity pixel signals to the vertical CCDs and is constant. The vertical CCDs are usually designed to be enough for transferring a maximum signal charge amount necessary to be transferred through the vertical CCDs when the signal charges are read out from the sensor sections to the vertical CCDs and transferred only once at the final timing of the electronic entire exposure period. Therefore, usually, when the signal charges are read out from the sensor sections for high-sensitivity pixel signals to the vertical CCDs and transferred only once at the final timing of the electronic entire exposure period, the vertical CCDs may not be able to transfer signal charges equal to or larger than the maximum signal charge amount necessary to be transferred through the vertical CCDs. As a result, in the examples in the past described in WO2002/056603 and JP-A-2004-172858, unless the width of the vertical CCDs is not increased, it is difficult to expand a dynamic range of intensity of incident light of the high-sensitivity pixel signals to the high luminance side compared with the time when the signal charges for the high-sensitivity pixel signals are read out from the sensor sections for high-sensitivity pixel signals to the vertical CCDs and transferred only once at the final timing of the electronic entire exposure period. WO2002/056603 and JP-A-2004-172858 are different from the sixth embodiment in this point.

In the driving control method according to the first example of the sixth embodiment for actually using the signal charges readout from the sensor sections 11l for low-sensitivity pixel signals to the vertical CCDs 13 at the final timing t20 in the former half of the entire exposure period as an output signal for low-sensitivity pixel signals, a ratio Sratio (=SHigh/SLow) of sensitivity SHigh of high-sensitivity pixels and sensitivity SLow of low-sensitivity pixels is (t40−t10)/(t20−t10). In the driving control method according to the second example of the sixth embodiment for actually using the signal charges read out from the sensor sections 11l for low-sensitivity pixel signals to the vertical CCDs 13 at the final timing t40 the electronic entire exposure period as an output signal for low-sensitivity pixel signals, a ratio Sratio (=SHigh/SLow) of sensitivity SHigh of high-sensitivity pixels and sensitivity SLow of low-sensitivity pixels is (t40−t10)/(t40−t20). In both the cases, the sensitivity ratio Sratio is adjusted by adjusting the readout point t20 when the signal charges acquired in the sensor sections 11h for high-sensitivity pixel signals and the sensor sections 11l for low-sensitivity pixel signals in the former half of the entire exposure period in the sensor sections 11h for high-sensitivity pixel signals and the sensor sections 11l for low-sensitivity pixel signals are read out from the sensor sections 11h for high-sensitivity pixel signals and the sensor sections 11l for low-sensitivity pixel signals to the vertical CCDs 13.

Concerning the high-sensitivity pixel signals, an expansion ratio to the high-luminance side of an area of intensity of incident light in which the sensor sections 11h for high-sensitivity pixel signals are not saturated is defined as “an expansion ratio to the high-luminance side of an area of intensity of incident light in which the sensor sections 11h for high-sensitivity pixel signals are not saturated=intensity of incident light at the time when the sensor sections 11h for high-sensitivity pixel signals are saturated/intensity of incident light at the time when the sensor sections 11h for high-sensitivity pixel signals are saturated when the signal charges are read out from the sensor sections 11h for high-sensitivity pixel signals to the vertical CCDs 13 and transferred only once at the final timing of the electronic entire exposure period”. Then, an expansion ratio Liratiof to the high-luminance side of an area of intensity of incident light in which the sensor sections 11h for high-sensitivity pixel signals are not saturated in the former half of the entire exposure period in the sensor sections 11h for high-sensitivity pixel signals and an expansion ratio Liratiob to the high-luminance side of an area of intensity of light in which the sensor sections 11h for high-sensitivity pixel signals are not saturated in the latter half of the entire exposure period in the sensor sections 11h for high-sensitivity pixel signals change according to a setting value of the sensitivity ratio Sratio. When the sensitivity ratio Sratio is “2”, Liratiof=Liratiob=2.0. However, except when the sensitivity ratio Sratio is “2”, Liratiof and Liratiob are different. As the sensitivity ratio Sratio is set higher than 2 or set lower than 2 (in a range of a number equal to or larger than 1), an expansion ratio to the high-luminance side of an area of intensity of incident light in which the sensor sections 11h for high-sensitivity pixel signals are not saturated in one of the former half and the latter half of the entire exposure period in the sensor sections 11h for high-sensitivity pixel signals is lower. An expansion ratio to the high-luminance side of a dynamic range of intensity of incident light of the final high-sensitivity pixel signals acquired by the signal processing in the image processing unit 66 depends on an expansion ratio to the high-luminance side of an area of intensity of incident light in which the sensor sections 11h for high-sensitivity pixel signals are not saturated in the former half or the latter half of the entire exposure period in the sensor sections 11h for high-luminance pixel signals in which an expansion ratio to the high-luminance side of intensity of incident light in which the sensor sections 11h for high-sensitivity pixel signals is not saturated is lower. Therefore, an effect of expansion to the high-luminance side of a dynamic range of intensity of incident light of the final high-sensitivity pixel signals acquired by the signal processing in the image processing unit 66 decreases.

For example, to set the sensitivity ratio Sratio to “4”, the readout point t20 when the signal charges acquired in the sensor sections 11h for high-sensitivity pixel signals and the sensor sections 11l for low-sensitivity pixel signals in the former half of the entire exposure period in the sensor sections 11h for high-sensitivity pixel signals and the sensor sections 11l for low-sensitivity pixel signals are read out from the sensor sections 11h for high-sensitivity pixel signals and the sensor sections 11l for low-sensitivity pixel signals to the vertical CCDs 13 is adjusted. In the driving control method according to the first example of the sixth embodiment for actually using the signal charges read out from the sensor sections 11l for low-sensitivity pixel signals to the vertical CCDs 13 as an output signal for low-sensitivity pixel signals, at the readout point t20 when the signal charges acquired in the sensor sections 11h for high-sensitivity pixel signals and the sensor sections 11l for low-sensitivity pixel signals in the former half of the entire exposure period in the sensor sections 11h for high-sensitivity pixel signals and the sensor sections 11l for low-sensitivity pixel signals are read out from the sensor sections 11h for high-sensitivity pixel signals and the sensor sections 11l for low-sensitivity pixel signals to the vertical CCDs 13, the entire exposure period in the sensor sections 11h for high-sensitivity pixel signals and the sensor sections 11l for low-sensitivity pixel signals is divided at a ratio of “1:3”. Therefore, the expansion ratio to the high-luminance side of the area of intensity of incident light in which the sensor sections 11h for high-sensitivity pixel signals are not saturated in the former half of the entire exposure period in the sensor sections 11h for the high-sensitivity pixel signals substantially is increased by fourfold. However, the expansion ratio to the high-luminance side of the area of intensity of incident light in which the sensor sections 11h for high-sensitivity pixel signals are not saturated in the latter half of the entire exposure period in the sensor sections 11h for high-sensitivity pixel signals can only be increased by 4/3-fold. Therefore, the expansion ratio to the high-luminance side of the dynamic range of intensity of incident light of the final high-sensitivity pixel signals acquired by the signal processing in the image processing section 66 can only be increased by 4/3-fold.

### Modification to the Sixth Embodiment

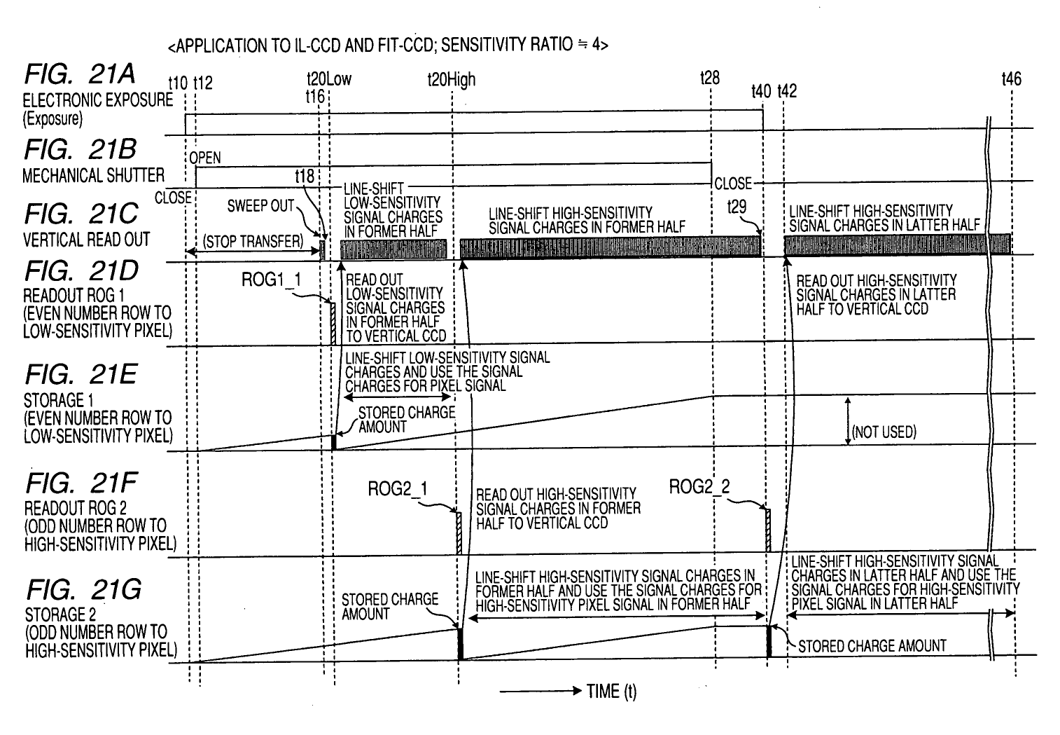

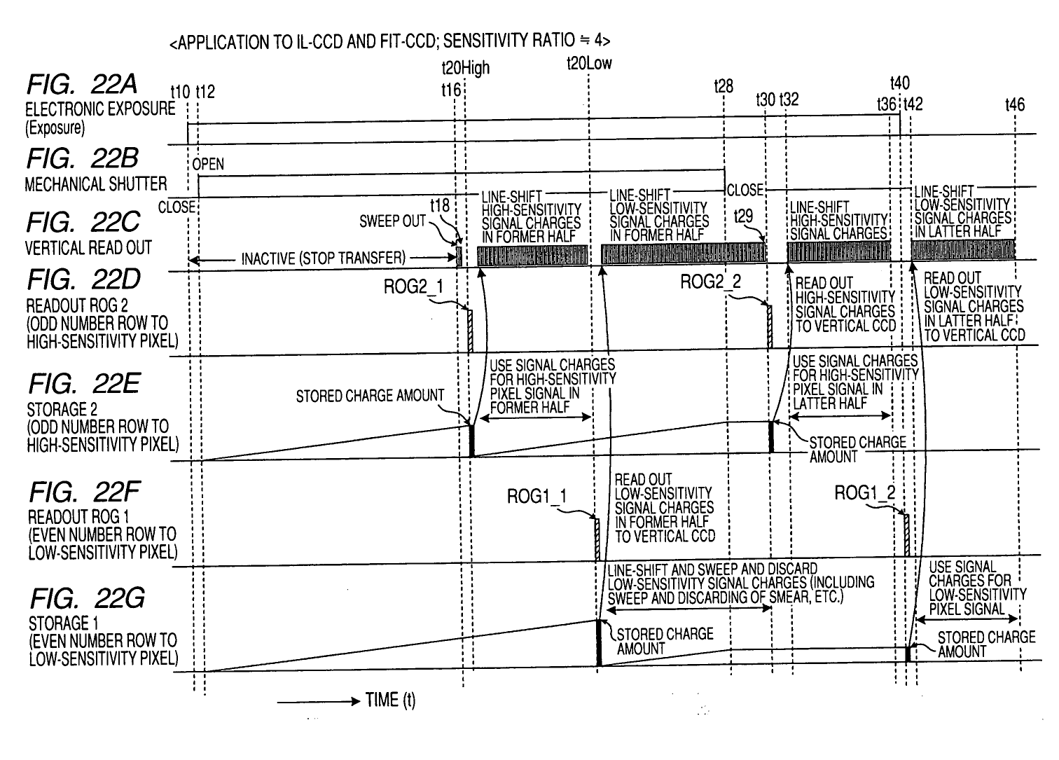

This problem can be solved by a modification to the driving control method according to the first example of the sixth embodiment shown in FIGS. 21A to 21G and a modification to the driving control method according to the second example of the sixth embodiment shown in FIGS. 22A to 22E. The modification to the driving control method according to the first example of the sixth embodiment is a modification to the driving method according to the third embodiment. The modification to the driving control method according to the second example of the sixth embodiment is a modification to the driving control method according to the second example of the fifth embodiment. In the modification to the driving control method according to the first example of the sixth embodiment and the modification to the driving control method according to the second example of the sixth embodiment, the IL-CCD or the FIT-CCD are adopted as the CCD solid-state imaging device 10 and the mechanical shutter 52 is used.

In the IL-CCD or the FIT-CCD, signal charges in the odd number lines and the even number lines are alternately read out to the vertical CCDs 13 for each of the fields independently from each other and transferred to the horizontal CCD 15 side according to the frame readout system to acquire signal charges for the high-sensitivity pixel signals and signal charges for the low-sensitivity pixel signals independently from each other. The IL-CCD or the FIT-CCD has a characteristic in, positively utilizing this point, while setting readout timing t20High when the signal charges are read out from the sensor sections 11h for high-sensitivity pixel signals to the vertical CCDs 13 in the former half of the entire exposure period in the sensor sections 11h for high-sensitivity pixel signals in the middle of the entire exposure period in the sensor sections 11h for high-sensitivity pixels signals, adjusting readout timing t20Low when the signal charges are read out from the sensor sections 11l for low-sensitivity pixel signals to the vertical CCDs 13 in the former half of the entire exposure period in the sensor sections 11l for low-sensitivity pixel signals to a setting of the sensitivity ratio Sratio.

For example, in the modification to the driving control method according to the first example of the sixth embodiment shown in FIGS. 21A to 21G, signal charges are read out from the sensor sections 11l for low-sensitivity pixel signals to the vertical CCDs 13 at the timing t20Low when the signal charges are read out from the sensor sections 11l for low-sensitivity pixel signals to the vertical CCDs 13 in the former half of the entire exposure period in the sensor section 11l for low-sensitivity pixel signals. The signal charges are actually used for an output signal for low-sensitivity pixel signals. In this case, the sensitivity ratio Sratio is set to “4”. This means that a ratio of a period (t20Low to t12) from the point t12 when the mechanical shutter 52 is opened to the readout timing t20Low when the signal charges are read out from the sensor sections 11l for low-sensitivity pixel signals to the vertical CCDs 13 in the former half of the entire exposure period in the sensor sections 11l for low-sensitivity pixel signals and an entire exposure period (t28 to t12) during which the mechanical shutter 52 is open is “4”.

On the other hand, the readout timing t20High when the signal charges are read out from the sensor sections 11h for high-sensitivity pixel signals to the vertical CCDs 13 in the former half of the entire exposure period in the sensor sections 11h for high-sensitivity pixel signals is set in the middle of the entire exposure period (t28 to t12) during which the mechanical shutter 52 is open. Since exposure and storage periods in the former half and the latter half of the entire exposure period in the sensor sections 11h for high-sensitivity pixel signals are equal, in the acquisition of signal charges performed dividedly twice, it is possible to equalize an area of intensity of incident light in which the sensor sections 11h for high-sensitivity pixel signals are not saturated.

Therefore, concerning the high-sensitivity pixel signals, in the acquisition of signal charges performed dividedly twice, it is possible to equalize, regardless of a setting state of the sensitivity ratio Sratio, an area of intensity of incident light in which the sensor sections 11h for high-sensitivity pixel signals are not saturated. Compared with the time when the signal charges are read out from the sensor sections 11h for high-sensitivity pixel signals to the vertical CCDs 13 and transferred only once at the final timing of the electronic entire exposure period, it is possible to surely expand the area of intensity of incident light in which the sensor sections 11h for high-sensitivity pixel signals are not saturated to the high-luminance side by twofold. Therefore, when the combination processing by SVE is performed, it is possible to surely expand the area of intensity of incident light corresponding to the area with high resolution having gradations in both the low-sensitivity pixel signals and the high-sensitivity pixel signals to the high-luminance side by twofold.

However, in the case of the modification to the driving control method according to the first example of the sixth embodiment, by the time when the signal charges for the high-sensitivity pixel signals are read out from the sensor sections 11h for high-sensitivity pixel signals to the vertical CCDs 13 at the intermediate point t20High of the entire exposure period, it is necessary to complete charge transfer for all the lines of the signal charges for the low-sensitivity pixel signals read out from the sensor sections 11l for low-sensitivity pixel signals to the vertical CCDs 13 at the readout point t20Low when the signal charges are read out from the sensor sections 11l for low-sensitivity pixel signals to the vertical CCDs 13 in the former half of the entire exposure period in the sensor sections 11l for low-sensitivity pixel signals.

In the modification to the driving control method according to the second example of the sixth embodiment shown in FIGS. 22A to 22E, the mechanical shutter 52 is closed (t28) and signal charges are read out from the sensor sections 11l for low-sensitivity pixel signals to the vertical CCDs 13 after the point t29 when sweep-out of the signal charges acquired in the sensor sections 11l for low-sensitivity pixel signals in the former half of the entire exposure period in the sensor sections 11l for low-sensitivity pixel signals, which are read out to the vertical CCDs 13 earlier in a state in which the exposure is stopped, to the outside of the vertical CCDs 13 (i.e., the CCD solid-state imaging device 10) is completed. The charges are actually used as an output signal for low-sensitivity pixel signals. In this case, the sensitivity Sratio is set to “4”. This means that a ratio of a period (t28 to t20Low) from the readout timing t20Low when the signal charges are read out from the sensor sections 11l for low-sensitivity pixel signals to the vertical CCDs 13 in the former half of the entire exposure period in the sensor sections 11l for low-sensitivity pixel signals to the point t28 when the mechanical shutter 52 is closed and the entire exposure period (t28 to t12) during which the mechanical shutter 52 is open is “4”.

However, in the case of the modification to the driving control method according to the second example of the sixth embodiment, by the time when the signal charges for the low-sensitivity pixel signals are read out from the sensor sections 11l for low-sensitivity pixel signals to the vertical CCDs 13 at the readout point t20Low when the signal charges are read out from the sensor sections 11l for low-sensitivity pixel signals to the vertical CCDs 13 in the former half of the entire exposure period in the sensor section 11l for low-sensitivity pixel signals, it is necessary to complete charge transfer for all the lines of the signal charges for the high-sensitivity pixel signals read out from the sensor sections 11h for high-sensitivity pixel signals to the vertical CCDs 13 in the first time at the intermediate point t20High in the entire exposure period.

As described above, according to the modification to the driving control method according to the first example of the sixth embodiment and the modification to the driving control method according to the second example of the sixth embodiment, by using the IL-CCD or the FIT-CCD to which the frame readout system is applied, while the sensitivity ratio Sratio is set larger than “2”, a first readout point when the signal charges for the high-sensitivity pixel signals are read out from the sensor sections 11h for high-sensitivity pixel signals to the vertical CCDs 13 is set to the intermediate point t20High of the entire exposure period. Therefore, concerning the high-sensitivity pixel signals, in the acquisition of signal charges performed dividedly twice, it is possible to surely expand, regardless of a setting state of the sensitivity ratio Sratio, an area of intensity of incident light in which the sensor sections 11h for high-sensitivity pixel signals are not saturated to the high-luminance side by twofold compared with the time when the signal charges are read out from the sensor sections 11h for high-sensitivity pixel signals to the vertical CCDs 13 and transferred only once at the final timing of the electronic entire exposure period.

In the modification to the driving control method according to the first example of the sixth embodiment and the modification to the driving control method according to the second example of the sixth embodiment, there are some requirements. Any one of the signal charges for the low-sensitivity pixel signals acquired in the former half of the entire exposure period in the sensor sections 11l for low-sensitivity pixel signals and the signal charges for the high-sensitivity pixel signals acquired in the former half of the entire exposure period in the sensor sections 11h for high-sensitivity pixel signals are read out later from the sensor sections 11h for high-sensitivity pixel signals or the sensor sections 11h for high-sensitivity pixel signals to the vertical CCDs 13. Before this timing, it is necessary to complete the line-shift operation for all the lines of the signal charges readout from the sensor sections 11h for high-sensitivity pixel signals or the sensor sections 11l for low-sensitivity pixel signals to the CCDs 13 earlier. Any one of the signal charges for the low-sensitivity pixel signals acquired in the former half of the entire exposure period in the sensor sections 11l for low-sensitivity pixel signals and the signal charges for the high-sensitivity pixel signals acquired in the former half of the entire exposure period in the former half of the entire exposure period in the sensor sections 11h for high-sensitivity pixel signals are read out from the sensor sections 11h for high-sensitivity pixel signals or the sensor sections 11l for low-sensitivity pixel signals to the vertical CCDs 13. Then, the other of the signal charges for the low-sensitivity pixel signals and the signal charges for the high-sensitivity pixel signals are read out from the sensor sections 11h for high-sensitivity pixel signals or the sensor sections 11l for low-sensitivity pixel signals to the vertical CCDs 13 later. A ratio of a period between these two readout times to the entire exposure period is smaller as the sensitivity ratio Sratio is closer to “2”. Therefore, as the sensitivity ratio Sratio is closer to “2”, a minimum value of an entire exposure period that can be set is larger. When the sensitivity ratio Sratio is “2”, an entire exposure period may not be able to be realized. In this regard, when the sensitivity ratio Sratio is near “2” (e.g., equal to or larger than “1.5” and equal to or smaller than “3”) , it is advisable to adopt the driving control method according to the first example of the sixth embodiment or the driving control method according to the second example of the sixth embodiment in which the CCD solid-state imaging device of the progressive scan system is used. When the sensitivity ratio Sratio is set considerably larger than “2” (e.g., equal to or larger than “4”) or when the sensitivity ratio Sratio is set considerably smaller than “2” (e.g., equal to or larger than “1” and equal to or smaller than “4/3”), it is advisable to adopt the modification to the driving control method according to the first example of the sixth embodiment or the modification to the driving control method according to the second example of the sixth embodiment in which the IL-CCD or the FIT-CCD is used.

Overview of Demosaic Processing

FIGS. 23A to 23E are diagrams for explaining an overview of an SVE imaging operation in the digital still camera 1 according to an embodiment of the present invention. The digital still camera 1 images, with the imaging operation by the optical system 5 and the CCD solid-state imaging device 10 under the driving control by the driving control unit 96, the subject Z with a different color and sensitivity for each of pixels according to a predetermined mosaic pattern and obtains a color/sensitivity mosaic image in which are colors and sensitivities are arranged in a mosaic shape.

Thereafter, the image obtained by the imaging operation is converted into an image in which respective pixels have all color components and have uniform sensitivity by the signal processing system 6 including the image processing unit 66 as a main component. In the following explanation processing of the signal processing system 6 including the image processing unit 66 as a main component for converting a color/sensitivity mosaic image into an image in which respective pixels have all color components and have uniform sensitivity is also referred to as demosaic processing.

For example, when imaging is performed in an SVE mode, an output image from a sensor is a color/sensitivity mosaic image shown in FIG. 23A. FIG. 23B is a partial enlarged view of FIG. 23A. A color/sensitivity mosaic image shown in FIG. 23A is converted into an image in which respective pixels have all color components and uniform sensitivity by image processing. In other words, it is possible to obtain an image with an expanded dynamic range shown in FIG. 23D by restoring original luminance and colors of a subject from the color/sensitivity mosaic image shown in FIG. 23A. FIG. 23C shows an output signal of predetermined one line in which a dynamic range is expanded by signal processing of SVE. FIG. 23E is a partial enlarged view of FIG. 23D.

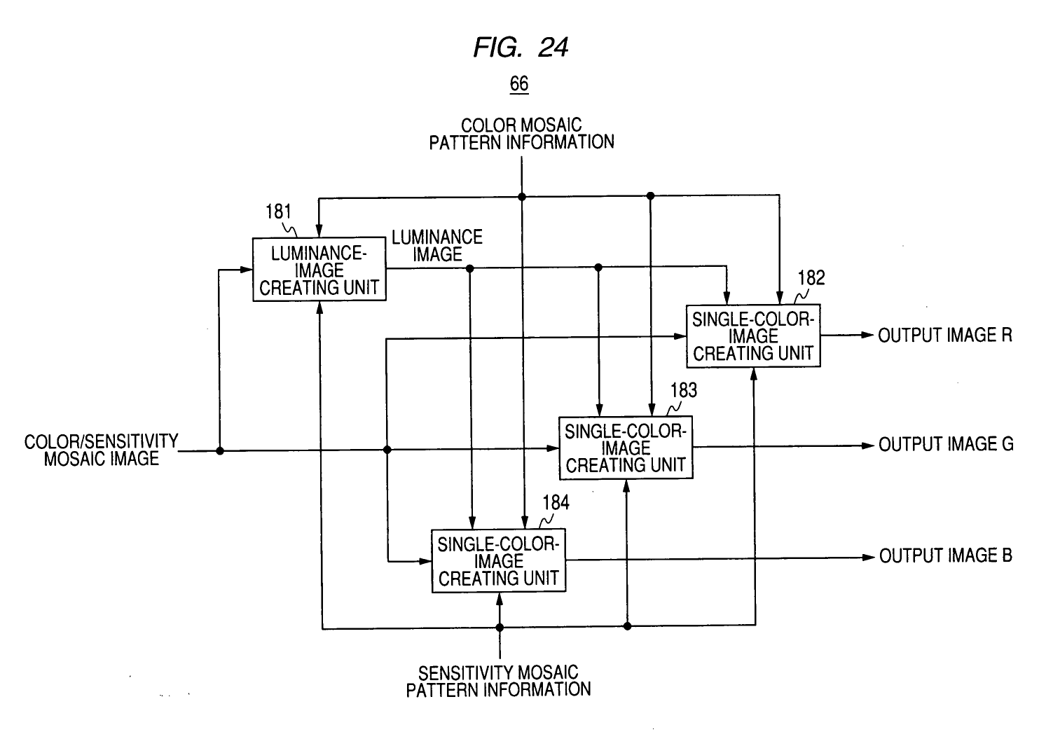

FIGS. 24 to 29 are diagrams for explaining an overview of demosaic processing in the image processing unit 66. The demosaic processing is briefly explained here. Concerning details of the demosaic processing by the image processing unit 66, please refer to, for example, WO2002/056603 and JP-A-2004-172858.

FIG. 24 is a functional block diagram that focuses on the demosaic processing in the image processing unit 66. The demosaic processing includes luminance image creation processing for creating a luminance image from a color/sensitivity mosaic image obtained by an imaging operation by the optical system 5 and the CCD solid-state imaging device 10 and single-color image processing for creating output images R, G, and B using the color/sensitivity mosaic image and the luminance image.

In an example of the structure of the image processing unit 66, the color/sensitivity mosaic image obtained by the imaging operation by the optical system 5 and the CCD solid-state imaging device 10, color mosaic pattern information indicating a color mosaic array of the color/sensitivity mosaic image, and sensitivity mosaic pattern information indicating a sensitivity mosaic array of the color/sensitivity mosaic image are supplied to a luminance-image creating unit 181 that creates a luminance image and single-color-image creating units 182 to 184 that create output images of the three primary colors R, G, and B.

The single-color-image creating unit 182 creates an output image R using a color/sensitivity mosaic image and a luminance image supplied thereto. The single-color-image creating unit 183 creates an output image G using a color/sensitivity mosaic image and a luminance image supplied thereto. The single-color-image creating unit 184 creates an output image B using a color/sensitivity mosaic image and a luminance image supplied thereto.

FIG. 25 is a diagram showing an example of the structure of the luminance-image creating unit 181. In FIG. 25, the color/sensitivity mosaic image, the color mosaic pattern information, and the sensitivity mosaic pattern information are supplied to estimating units 191 to 193 that calculate respective estimated values R′, G′, and B′ of the three primary colors R, G, and B.

The estimating unit 191 applies. R component estimation processing to the color/sensitivity mosaic image and supplies an estimated value R′ of an R component for respective pixels obtained by the R component estimation processing to a multiplier 194. The estimating unit 192 applies G component estimation processing to the color/sensitivity mosaic image and supplies an estimated value G′ of a G component for respective pixels obtained by the G component estimation processing to a multiplier 195. The estimating unit 193 applies B component estimation processing to the color/sensitivity mosaic image and supplies an estimated value B′ of a B component for respective pixels obtained by the B component estimation processing to a multiplier 196.

The multiplier 194 multiplies the estimate value R′ supplied from the estimating unit 191 with a color balance coefficient kR and outputs a product of the estimated value R′ and the color balance coefficient kR to an adder 197. The multiplier 195 multiplies the estimated value G′ supplied from the estimating unit 192 with a color balance coefficient kG and outputs a product of the estimated value G′ and the color balance coefficient kG to the adder 197. The multiplier 196 multiplies the estimated value B′ supplied from the estimating unit 193 with a color balance coefficient kB and outputs a product of the estimated value B′ and the color balance coefficient kB to the adder 197.

The adder 197 adds up the product R′*kR inputted from the multiplier 194, the product G′*kG inputted from the multiplier 195, and the product B′*kB inputted from the multiplier 196, creates a luminance candidate image having a sum of the products as a pixel value, and supplies the luminance candidate image to a noise removing unit 198.

The color balance coefficient kR, kG, and kB are values set in advance. For example, kR=0.3, kG=0.6, and kB=0.1. Basically, values of the color balance coefficients kR, kG, and kB only have to be values from which values correlated to the change in the luminance as luminance candidate values. Therefore, for example, the color balance coefficients kR, kG, and kB may be equal to one another.

The noise removing unit 198 applies noise removal processing to the luminance candidate image supplied from the adder 197 and supplies a luminance image obtained by the noise removal processing to the single-color-image creating units 182 to 184 shown in FIG. 24.

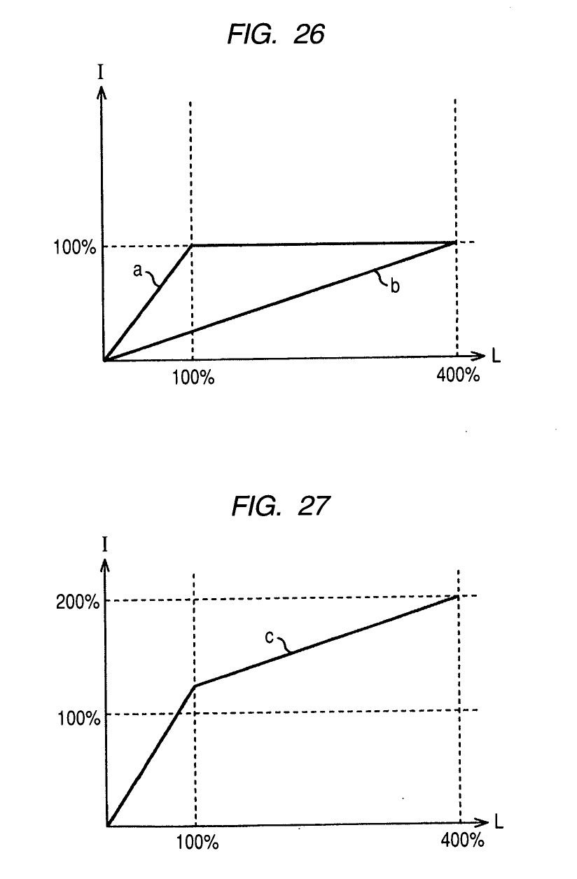

FIGS. 26 to 28 are graphs for explaining a combined sensitivity compensation lookup table used by the estimating units 191, 192, and 193. FIG. 26 shows a sensitivity characteristic curve “b” of a low-sensitivity pixel with sensitivity S0 and a sensitivity characteristic curve “a” of a high-sensitivity pixel with sensitivity S1. The abscissa indicates intensity of incident light and the ordinate indicates a pixel value. In FIG. 26, the sensitivity S1 of the high-sensitivity pixel is four times as high as the sensitivity S0 of the low-sensitivity pixel.

In the estimation processing performed by the estimating units 191, 192, and 193, a first quotient calculated from the low-sensitivity pixel with the sensitivity S0 measured with a characteristic indicated by the sensitivity characteristic curve “b” shown in FIG. 26 and a second quotient calculated from the high-sensitivity pixel with the sensitivity S1 measured with a characteristic indicated by the sensitivity characteristic curve “a” shown in FIG. 26 are added up. A sum of the first quotient and the second quotient is indicated by a sensitivity characteristic curve “c” shown in FIG. 27. Therefore, the sensitivity characteristic curve “c” shown in FIG. 27 has a sensitivity characteristic obtained by combining the sensitivity characteristic of the low-sensitivity pixel with the sensitivity S0 and the sensitivity characteristic of the high-sensitivity pixel with the sensitivity S1.

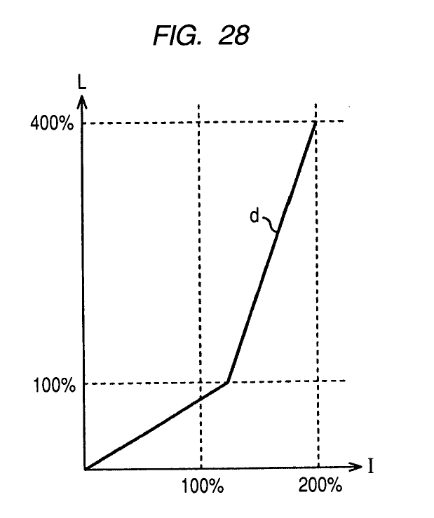

The combined sensitivity characteristic curve “c” indicates a sensitivity characteristic in a wide dynamic range extending from low luminance to high luminance. However, since the sensitivity characteristic curve “c” is a line graph as shown in FIG. 27, an original linear sensitivity characteristic is restored by using an inverse characteristic curve of the sensitivity characteristic curve “c” . Specifically, an inverse characteristic curve “d” shown in FIG. 28, which is the inverse characteristic curve of the sensitivity characteristic curve “c” shown in FIG. 27, is applied to the sum of the first quotient and the second quotient to compensate for a nonlinear characteristic. The combined sensitivity compensation lookup table is a lookup table version of the inverse characteristic curve “d” shown in FIG. 28.

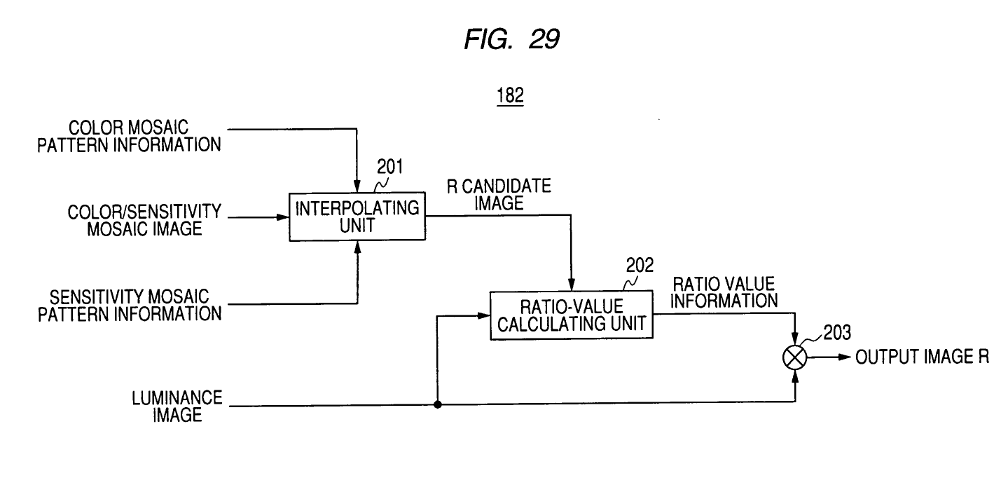

FIG. 29 is a diagram showing an example of the structure of the single-color-image creating unit 182 that creates the output image R. Examples of the structure of the single-color-image creating unit 183 that creates the output image G and the single-color-image creating unit 184 that creates the output image B are the same as the example of the structure of the single-color-image creating unit 182. Therefore, explanation of the structure of the single-color-image creating unit 183 and the single-color-image creating unit 184 is omitted.

In the single-color-image creating unit 182, the color/sensitivity mosaic image, the color mosaic pattern information, and the sensitivity mosaic pattern information are supplied to an interpolating unit 201. The luminance image is supplied to a ratio-value calculating unit 202 and a multiplier 203.

The interpolating unit 201 applies interpolation processing to the color/sensitivity mosaic image and outputs an R candidate image, in which all pixels have the pixel value of the R component, obtained by the interpolation processing to the ratio-value calculating unit 202. The ratio-value calculating unit 202 calculates a low-frequency component of an intensity ratio (hereinafter simply referred to as intensity ratio) among corresponding pixels of the R candidate image and the luminance image. The ratio-value calculating unit 202 generates ratio value information indicating the intensity ratio corresponding to the respective pixels and supplies the ratio value information to the multiplier 203.

The multiplier 203 multiplies pixel values of respective pixels of the luminance image with the ratio value information indicating the intensity ratio corresponding to the pixels and creates an output image R having a product of the pixel values and the ratio value information as a pixel value.

The present invention has been explained with reference to the embodiments. However, the technical scope of the present invention is not limited to the range described in the embodiment. Various modifications and alterations of the embodiments are possible without departing from the spirit of the present invention. Such modifications and alterations are included in the technical scope of the present invention.

The embodiments do not limit the inventions according to claims. All combinations of the characteristics explained in the embodiments are not always indispensable for means for resolution of the present invention. The embodiments include inventions at various stages. Various inventions can be extracted according to appropriate combinations of the disclosed plural elements. Even if several elements are deleted from all the elements described in the embodiments, the elements from which the several elements are deleted can be extracted as inventions.

For example, in the embodiments, the imaging of the SVE system in subjecting visible light to color separation and detecting the visible light to image a color image is explained. However, an image to be imaged is not limited to the color image and may be a monochrome image. The mechanisms according to the embodiments can also applied to imaging of the SVE system in detecting an electromagnetic wave in an arbitrary wavelength band such as an infrared ray or an ultraviolet ray to image an image in the wavelength band.

It should be understood by those skilled in the art that various modifications, combinations, sub-combinations, and alterations may occur depending on design requirements and other factors insofar as they are within the scope of the appended claims or the equivalents thereof.

What is claimed is:

1. An imaging method of acquiring, using an imaging device having arranged therein plural charge generating sections that acquire signal charges corresponding to intensity of an inputted electromagnetic wave and including a charge transfer section that transfers the signal charges acquired by the charge generating sections in a predetermined direction, a high-sensitivity pixel signal and a low-sensitivity pixel signal and creating an output image by properly using the high-sensitivity pixel signal and the low-sensitivity pixel signal to expand a dynamic range, the imaging method comprising the steps of:
reading out signal charges generated by at least the charge generating section for the low-sensitivity pixel signal to the charge transfer sections at predetermined timing in an entire exposure period defined in an entire charge storing period for acquiring at least one of the high-sensitivity pixel signal and the low-sensitivity pixel signal while performing control to acquire a signal charge corresponding to the high-sensitivity pixel signal and a signal charge corresponding to the low-sensitivity pixel signal independently from each other by setting charge storage time for acquiring the high-sensitivity pixel signal and charge storage time for acquiring the low-sensitivity pixel signal different from each other;
after the predetermined timing, continuing incidence of the electromagnetic wave and, after continuing the incidence of the electromagnetic wave, reading out a signal charge generated by at least the charge generating section for the high-sensitivity pixel signal to the charge transfer section, and transferring the signal charge read out to the charge transfer section through the charge transfer section; and
concerning at least one of the signal charges for the high-sensitivity pixel signal and the low-sensitivity pixel signal, every time the signal charge is read out to the charge transfer section, transferring the read-out signal charge without retaining the signal charge in the charge transfer section.

2. An imaging method according to claim 1, further comprising, concerning at least the signal charge for the high-sensitivity pixel signal, every time the signal charge is read to the charge transfer section, transferring the read-out signal charge without retaining the signal charge in the charge transfer section.

3. A driving device that controls to drive an imaging device having arranged therein plural charge generating sections that acquire signal charges corresponding to intensity of an inputted electromagnetic wave and including a charge transfer section that transfers the signal charges acquired by the charge generating sections in a predetermined direction,
the driving device comprising a driving control unit that reads out the signal charge generated by at least the charge generating section for a low-sensitivity pixel signal to the charge transfer section at predetermined timing in an entire exposure period, after the predetermined timing, continues incidence of the electromagnetic wave and, after continuing the incidence of the electromagnetic wave, reads out the signal charge generated by at least the charge generating section for a high-sensitivity pixel signal to the charge transfer section, transfers the signal charge read out to the charge transfer section through the charge transfer section, and, concerning at least one of the signal charges for the high-sensitivity pixel signal and the low-sensitivity pixel signal, every time the signal charge is read out to the charge transfer section, transfers the signal charge read out to the charge transfer section through the charge transfer section without retaining the read-out signal charge in the charge transfer section.

4. A driving device according to claim 3, wherein the driving control unit transfers, every time at least the signal charge for the high-sensitivity pixel signal is read out to the charge transfer section, the read-out signal charge to the charge transfer section without retaining the read-out signal in the charge transfer section.

5. An imaging apparatus including an imaging device having arranged therein plural charge generating sections that acquires signal charges corresponding to intensity of an inputted electromagnetic wave and including a charge transfer section that transfers the signal charges acquired by the charge generating sections in a predetermined direction, the imaging apparatus comprising:
a driving control unit that performs control to read out a signal charge generated by at least the charge generating section for a low-sensitivity pixel signal to the charge transfer section at predetermined timing in an entire exposure period, after the predetermined timing, continue incidence of the electromagnetic wave and, after continuing the incidence of the electromagnetic wave, read out a signal charge generated by at least the charge generating section for a high-sensitivity pixel signal to the charge transfer section, transfer the signal charge read out to the charge transfer section through the charge transfer section, and, concerning at least one of the signal charges for the high-sensitivity pixel signal and the low-sensitivity pixel signal, every time the signal charge is read out to the charge transfer section, transfer the signal charge read out to the charge transfer section through the charge transfer section without retaining the read-out signal charge in the charge transfer section; and
an image processing unit that creates an output image by properly using an acquired high-sensitivity pixel signal and an acquired low-sensitivity pixel signal to expand a dynamic range.

6. An imaging apparatus according to claim 5, wherein the driving control unit transfers, every time at least the signal charge for the high-sensitivity pixel signal is read out to the charge transfer section, the read-out signal charge to the charge transfer section without retaining the read-out signal in the charge transfer section.

7. An imaging apparatus according to claim 5, further comprising a mechanical shutter that stops storage of signal charges in the charge generating sections.

8. An imaging apparatus according to claim 5, wherein
the imaging device is an imaging device of a progressive scan system that can transfer signal charges read out from all the charge generating sections to the charge transfer section through the charge transfer section independently from one another, and
the imaging device reads out, after storing a signal charge corresponding to a high-sensitivity pixel signal or a signal charge corresponding to a low-sensitivity pixel signal in the charge generating sections, the signal charge corresponding to the high-sensitivity pixel signal and the signal charge corresponding to the low-sensitivity pixel signal to the charge transfer section and can transfer the signal charge corresponding to the high-sensitivity pixel signal and the signal charge corresponding to the low-sensitivity pixel signal in dependently from each other without mixing the signal charges in the charge transfer section.

9. An imaging apparatus according to claim 5, wherein
the imaging device is an imaging device of an interline system in which the charge transfer section is arranged between arrays of the charge generating sections and a transfer electrode that drives the charge transfer section is arranged in each line, and
the imaging device reads out, after storing a signal charge corresponding to a high-sensitivity pixel signal or a signal charge corresponding to a low-sensitivity pixel signal in the charge generating sections, the signal charge corresponding to the high-sensitivity pixel signal and the signal charge corresponding to the low-sensitivity pixel signal to the charge transfer section and can transfer the signal charge corresponding to the high-sensitivity pixel signal and the signal charge corresponding to the low-sensitivity pixel signal in order.

10. An imaging apparatus according to claim 9, wherein, in the driving control unit, a first charge generating section that acquires a signal charge corresponding to the high-sensitivity pixel signal is arranged in one line and a second charge generating section that acquires a signal charge corresponding to the low-sensitivity pixel signal is arranged in one line next to the first charge generating section.

11. An imaging apparatus according to claim 5, wherein the driving control unit performs control to read out the signal charge corresponding to the low-sensitivity pixel signal to the charge transfer section at the predetermined timing in the exposure period and, after the predetermined timing, transfer the read-out signal charge through the charge transfer section, store the signal charge corresponding to the high-sensitivity pixel signal and the signal charge corresponding to the low-sensitivity pixel signal in the charge generating sections, after continuing incidence of the electromagnetic wave, read out the signal charge generated by the charge generating section for the high-sensitivity pixel signal to the charge transfer section, and transfer the read-out signal charge through the charge transfer section.

12. An imaging apparatus according to claim 5, wherein the driving control unit performs control to read out the signal charge corresponding to the low-sensitivity pixel signal to the charge transfer section at the predetermined timing in the exposure period and, after the predetermined timing, store the signal charge corresponding to the high-sensitivity pixel signal and the signal charge corresponding to the low-sensitivity pixel signal in the charge generating sections, not transfer the read-out signal charge through the charge transfer section, after end of an entire exposure period for acquiring the high-sensitivity pixel signal, transfer the signal charge corresponding to the low-sensitivity pixel signal read out earlier through the charge transfer section, subsequently read out the signal charge generated by the charge generating section for the high-sensitivity pixel signal to the charge transfer section, and transfer the read-out signal charge through the charge transfer section.

13. An imaging apparatus according to claim 5, wherein the driving control unit performs control to read out the signal charge corresponding to the low-sensitivity pixel signal to the charge transfer section at the predetermined timing in the exposure period and, after the predetermined timing, transfer the signal charge read out to the charge transfer section through the charge transfer section, store the signal charge corresponding to the high-sensitivity pixel signal and the signal charge corresponding to the low-sensitivity pixel signal in the charge generating sections, after continuing incidence of the electromagnetic wave, read out the respective signal charges generated by the respective charge generating sections for the high-sensitivity pixel signal and the low-sensitivity pixel signal to the charge transfer section simultaneously or in predetermined order, and transfer the read-out signals through the charge transfer section.

14. An imaging apparatus according to claim 5, wherein
the driving control unit performs control to read out the signal charge for the high-sensitivity pixel signals generated by the charge generating section for the high-sensitivity pixel signal and the signal charge for the low-sensitivity pixel signal generated by the charge generating section for the low-sensitivity pixel signal to the charge transfer section at the predetermined timing in the exposure period and, after the predetermined timing, while transferring the respective signal charges read out to the charge transfer section through the charge transfer section, store the signal charge corresponding to the low-sensitivity pixel signal and the signal charge corresponding to the high-sensitivity pixel signal in the charge generating sections, after continuing incidence of the electromagnetic wave, read out the signal charge generated by the charge generating section for the high-sensitivity pixel signal to the charge transfer section, and transfer the read-out signal charge through the charge transfer section, and
the image processing unit combines a high-sensitivity pixel signal acquired in a former half of an entire exposure period based on the signal charge corresponding to the high-sensitivity pixel signal, which is read out to the charge transfer section at the predetermined timing and then transferred through the charge transfer section, and a high-sensitivity pixel signal acquired in a latter half of the entire exposure period based on the signal charge corresponding to the high-sensitivity pixel signal, which is read out to the charge transfer section after the continuous of the incidence of the electromagnetic wave and then transferred to the charge transfer section, and acquires a final high-sensitivity pixel signal.

15. An imaging apparatus according to claim 13, wherein the driving control unit performs control to transfer the signal charge corresponding to the low-sensitivity pixel signal, which is transmitted while the signal charges are stored in the charge generating sections after the predetermined timing, at transfer speed sufficient for performing sweep-out of the signal charge corresponding to the low-sensitivity pixel signal read out at the predetermined timing and an unnecessary signal charge generated in the charge transfer section.
